(19) United States
(12) Patent Application Publication
(10) Pub. No.: US 2026/0153787 A1
(43) Pub. Date: Jun. 4, 2026

(54) LENS DRIVING DEVICE, CAMERA DEVICE, AND OPTICAL DEVICE

(71) Applicant: LG INNOTEK CO., LTD., Seoul (KR)

(72) Inventors: Yun Ho NOH, Seoul (KR); Byung Wook SON, Seoul (KR); Tae Hoon KWON, Seoul (KR)

(21) Appl. No.: 19/122,946

(22) PCT Filed: Jun. 28, 2023
(86) PCT No.: PCT/KR2023/009060

§ 371 Date: Apr. 21, 2025

(30) Foreign Application Priority Data
Oct. 21, 2022 (KR) 10-2022-0136879
Oct. 24, 2022 (KR) 10-2022-0137817

(51) Int. Cl. G03B 13/36; G02B 7/09; G03B 5/02; H04N 23/53; H04N 23/54; H04N 23/57

(52) U.S. Cl. CPC G03B 13/36; G02B 7/09; G03B 5/02; H04N 23/53; H04N 23/54; H04N 23/57; G03B 2205/0015; G03B 2205/0069; G03B 2217/002

(57) ABSTRACT

The present embodiment relates to a lens driving device comprising: a fixed part; a first moving part being disposed inside the fixed part; a second moving part being disposed inside the first moving part; a first driving part for moving the first moving part in an optical axis direction; a second driving part for moving the second moving part in a direction perpendicular to the optical axis direction; a plate member being disposed between the fixed part and the first moving part; a first ball part being disposed between the plate member and the first moving part; an elastic member being disposed between the fixed part and the plate member; and a second ball part being disposed between the fixed part and the first moving part, wherein the elastic member presses the second ball part to be supported by the fixed part.

### TECHNICAL FIELD

The present embodiment relates to a lens driving device, a camera device, and an optical apparatus.

### BACKGROUND ART

A camera device is a device that photographs a picture or video of a subject and is installed in an optical apparatus such as a smartphone, a drone, a vehicle, and the like.

An auto focus function that automatically adjusts a focus according to a distance to a subject is applied to the camera device. In addition, hand shake correction function is applied to prevent a phenomenon in which focus is shaking due to a user's hand shake.

The auto focus function and hand shake correction function may be performed through electromagnetic interaction between a magnet and a coil.

However, in a conventional lens driving device, when disposing a magnet and a coil for performing an auto focus function, a magnet that does not require electrical connection is disposed in a moving part and a coil is disposed in a fixed part. In this case, there is a problem in that current consumption for performing the auto focus function increases because a magnet having a larger weight than a coil is disposed in the moving part.

In particular, in recent years, the lens diameter has increased according to the high-pixel image sensors, and accordingly, the weight of the lens is also increased, thereby increasing problems.

In addition, in the conventional lens driving device, the height of the camera device in an optical axis direction increases as a guide structure for OIS-x-axis driving and a guide structure for OIS-y-axis driving are disposed as separate layers.

Meanwhile, the auto focus function is performed as a lens moves in an optical axis direction against the image sensor, and the movement of the lens in the optical axis direction may be guided by a ball. At this time, an attractive force between the magnet and the yoke may be used to hold the ball between the fixed part and the moving part.

However, in this case, there is a problem in that a centering force exists in the optical axis direction. Furthermore, there may be a possibility for the moving part to be tilted by the contact point of the ball.

In addition, when the ball is used to guide the movement of the moving part for the hand shake compensation function, there is a problem in that the ball may be deviated from its original position due to an external impact or the like.

(Patent Literature 1) Kr 10-2015-0118005 a

### DETAILED DESCRIPTION OF THE INVENTION

### Technical Subject

The present embodiment is intended to provide a lens driving device in which current consumption for performing an autofocus function is reduced by disposing a coil that is lighter than a magnet in a moving part.

In addition, it is intended to provide a lens driving device having a minimized height in an optical axis direction by integrally forming a guide structure for OIS-x-axis driving and a guide structure for OIS-y-axis driving.

The present embodiment is intended to provide a lens driving device that presses the ball through an elastic member so that there is no centering force being generated in an optical axis direction when the ball is pressed through the yoke and the magnet.

In addition, it is intended to provide a lens driving device in which rotation and tilt of a moving unit are prevented by disposing a ball guide structure diagonally.

The present embodiment is intended to provide a lens driving device that minimizes deviation or damage of a structure for guiding the movement of a moving part for a hand shake compensation function due to an external impact or the like.

### Technical Solution

A lens driving device according to a first embodiment of the present invention comprises: a fixed part; a first moving part being disposed inside the fixed part; a second moving part being disposed inside the first moving part; a first driving part for moving the first moving part in an optical axis direction; a second driving part for moving the second moving part in a direction perpendicular to the optical axis direction; and a guide member being disposed between the first moving part and the second moving part, wherein the guide member may comprise a protruding part fixed to the second moving part and being in contact with the first moving part.

The guide member may comprise a plurality of guide members being spaced apart from each other, and the protruding part of each of the plurality of guide members may be in contact with the first moving part at one point.

The guide member may be formed of a metal member.

The protruding part of the guide member may be formed to be bent on a metal plate so that an opposite side of the protruding part may have a groove shape corresponding thereto.

The guide member may comprise a plate portion being disposed in the second moving part, the protruding part may be integrally formed with the plate port, and the protruding part may be protruded from the plate portion toward the second moving part.

The plate portion of the guide member may be integrally formed with the second moving part.

The first moving part may comprise a plate member, and the protruding part of the guide member may be in contact with the plate member.

The guide member may be formed of the same material as the plate member.

The lens driving device is a lens driving device that comprises an elastic member that presses the guide member in a direction toward the first moving part.

The lens driving device comprises: a first elastic member being coupled to the first moving part; a second elastic member being coupled to the second moving part; and a wire connecting the first elastic member and the second elastic member, wherein the protruding part of the guide member may be overlapped with the wire in a first direction perpendicular to the optical axis direction.

The protruding part of the guide member may be overlapped with the second elastic member in a second direction perpendicular to the optical axis direction.

The first direction may be the same direction as the second direction.

The first driving part comprises a first magnet being disposed in the fixed part and a first coil being disposed in the first moving part, and in a direction perpendicular to the optical axis direction, the first coil may comprise a portion being disposed between the first magnet and the protruding part of the guide member.

A lens driving device according to a first embodiment of the present invention comprises: a fixed part; a first moving part being disposed inside the fixed part; a second moving part being disposed inside the first moving part; a first driving part which moves the first moving part in an optical axis direction; a second driving part which moves the second moving part in a direction perpendicular to the optical axis direction; and a guide member being disposed between the first moving part and the second moving part, wherein the guide member may comprise a protruding part being fixed to the first moving part and in contact with the second moving part.

A lens driving device according to a first embodiment of the present invention comprises: a fixed part; a moving part being disposed inside the fixed part; a driving part that moves the moving part in a direction perpendicular to the optical axis direction; and a guide member being disposed between the fixed part and the moving part, wherein the guide member may comprise a protruding part being fixed to the moving part and in contact with the fixed part.

A camera device according to a first embodiment of the present invention may comprise: a printed circuit board; an image sensor being disposed in the printed circuit board; a lens driving device being disposed on the printed circuit board; and a lens being coupled to the lens driving device.

An optical device according to a first embodiment of the present invention may comprise: a main body; a camera device being disposed on the main body; and a display being disposed in the main body and outputting at least one of an image and a video photographed by the camera device.

A lens driving device according to a second embodiment of the present invention comprises: a fixed part; a first moving part being disposed inside the fixed part; a second moving part being disposed inside the first moving part; a first driving part which moves the first moving part in an optical axis direction; a second driving part which moves the second moving part in a direction perpendicular to the optical axis direction; a plate member being disposed between the fixed part and the first moving part; a first ball part being disposed between the plate member and the first moving part; an elastic member being disposed between the fixed part and the plate member; and a second ball part being disposed between the fixed part and the first moving part, wherein the elastic member may press the second ball portion to be supported on the fixed part.

The fixed part comprises a base, and a first protruding part and a second protruding part protruded from the base in the optical axis an direction; the first moving part comprises a first carrier and a third protruding part protruded from the first carrier in a first direction perpendicular to the optical axis direction; the first ball part is disposed between the plate and the first protruding part; and the second ball part may be disposed between the second protruding part and the third protruding part.

The first protruding part and the second protruding part may be disposed in a first corner region of the base.

A lens driving device according to a second embodiment of the present invention may comprise: a fixed part; a first moving part being disposed inside the fixed part; a second moving part being disposed inside the first moving part; a first driving part which moves the first moving part in an optical axis direction; a second driving part which moves the second moving part in a direction perpendicular to the optical axis direction; a first ball being disposed between the fixed part and the first moving part; a plate member being in contact with the first ball; and an elastic member for pressing the plate member toward the first ball.

The lens driving device may comprise a second ball being disposed between the first moving part and the second moving part.

It comprises a first ball comprising the first ball part and the second ball part, wherein the first ball may comprise a first unit ball being disposed in a first corner region of the fixed part when viewed from above and a second unit ball being disposed in a second corner region being disposed in a diagonal direction of the first corner region of the fixed part.

The second ball may comprise a third unit ball and a fourth unit ball being spaced from each other and disposed between the first unit ball and the second unit ball in the diagonal direction when viewed from above.

The first ball may comprise a ball being overlapped with the second ball in a direction perpendicular to the optical axis direction.

The first driving part may comprise a first magnet being disposed in the fixed part and a first coil being disposed on the first moving part.

The lens driving device comprises: a first substrate being disposed in the first moving part; and a second substrate connecting the fixed part and the first substrate, wherein the first coil may be disposed on the first substrate.

The second driving part comprises: a second magnet and a second coil for moving the second moving part in a first direction perpendicular to the optical axis direction; and a third magnet and a third coil for moving the second moving part in a second direction perpendicular to the optical axis direction and the first direction, wherein the second coil and the third coil may be disposed on the first substrate.

The first driving part may comprise: a substrate being disposed in the fixed part; a first coil being disposed on the substrate; and a first magnet being disposed in the first moving part.

The plate member is disposed between the first ball part and the fixed part and the elastic member is disposed between the plate member and the fixed part so that the plate member can be pressed in a direction opposite to the fixed part.

The fixed part comprises an outer wall part and a pillar part disposed inside the outer wall part, and the first ball may comprise a first unit ball being disposed between the first moving part and the pillar part of the fixed part and a second unit ball being disposed between the first moving part and the outer wall part of the fixed part.

The plate member is disposed between the first unit ball and the pillar part of the fixed part, and the elastic member may be disposed between the plate member and the pillar part of the fixed part.

The first ball part comprises a plurality of balls being disposed in the optical axis direction; the plurality of balls comprise a first uppermost ball being disposed highest and a first lowermost ball being disposed lowest; and the height of a point at which the elastic member presses the plate member may be disposed between the height of the first uppermost ball and the height of the first lowermost ball.

A camera device according to a second embodiment of the present invention may comprise: a printed circuit board; an image sensor being disposed on the printed circuit board; the lens driving device being disposed on the printed circuit board; and a lens being coupled to the lens driving device.

An optical apparatus according to a second embodiment of the present invention may comprise: a main body; the camera device being disposed in the main body; and a display being disposed on the main body and outputting at least one of a video and an image photographed by the camera device.

### Advantageous Effects

Through this embodiment, current consumption for performing the auto focus function can be reduced as the coil, which is lighter in weight than the magnet, is disposed in the moving part.

In addition, since the guide structure for OIS-x-axis driving and the guide structure for OIS-y-axis driving are integrally formed, the height of the lens driving device in an optical axis direction can be minimized.

Through this, the height at which the camera device is protruded from the smartphone can be minimized. Or, the camera device may not be protruded from the smartphone.

In addition, since the centering force in an optical axis direction being generated when the ball is pressurized through the yoke and magnet disappears, that is, since there is no force to return to the centering position, even it is minute, the consumption of current consumed in AF driving can be reduced and the accuracy of AF driving can be enhanced.

In addition, in the present embodiment, since the ball guide structure is disposed diagonally, rotation and tilt of the moving part can be prevented.

In addition, in the present embodiment, deviation or damage due to external impact or the like of the structure for guiding the movement of the moving part for the hand shake correction function can be minimized.

### BRIEF DESCRIPTION OF DRAWINGS

FIG. 1 is a conceptual diagram of a lens driving device according to a first embodiment of the present invention.

FIG. 2 is a perspective view of a lens driving device according to a first embodiment of the present invention.

FIG. 3 is a cross-sectional view viewed from A-A in FIG. 2.

FIG. 4 is a cross-sectional view viewed from B-B in FIG. 2.

FIG. 5 is an enlarged view of a partial region of FIG. 4.

FIG. 6 is a cross-sectional view viewed from C-C in FIG. 2.

FIG. 7 is a cross-sectional view viewed from D-D in FIG. 2.

FIG. 8 is a cross-sectional view of a lens driving device according to a first embodiment of the present invention cut in a direction perpendicular to an optical axis and viewed from above.

FIG. 9 is an exploded perspective view of a lens driving device according to a first embodiment of the present invention.

FIG. 10 is an exploded perspective view of a lens driving device according to a first embodiment of the present invention viewed from a direction different from that of FIG. 9.

FIG. 11 is a perspective view of a state in which a cover is omitted from a lens driving device according to a first embodiment of the present invention.

FIG. 12 is a perspective view viewed from a direction different from that of FIG. 11.

FIG. 13 is a perspective view illustrating a fixed part and related components of a lens driving device according to a first embodiment of the present invention.

FIG. 14 is a perspective view illustrating a moving part and related components of a lens driving device according to a first embodiment of the present invention.

FIG. 15 is a bottom perspective view viewed from a direction different from that of FIG. 14.

FIG. 16 is a bottom perspective view of a state in which the cover of an AF moving part in FIG. 15 is removed.

FIG. 17 is a bottom perspective view of a state in which an OIS moving part is removed in FIG. 16.

FIG. 18(a) is an enlarged view of a partial region of FIG. 17, and FIG. 18(b) is a separated view of the plate member in FIG. 18(a).

FIG. 19 is a bottom view of FIG. 17 viewed from below.

FIG. 20 is a perspective view illustrating an OIS moving part and related components of a lens driving device according to a first embodiment of the present invention.

FIG. 21(a) is an enlarged view of a partial region of FIG. 20, and FIG. 21(b) is a separated view of the guide member in FIG. 21(a).

FIG. 22 is a bottom perspective view of FIG. 20 viewed from a different direction.

FIG. 23 is a perspective view of an elastic member of the lens driving device according to a first embodiment of the present invention.

FIG. 24 is a plan view of a lens driving device according to a first embodiment of the present invention in a state where a cover is removed.

FIG. 25 is an enlarged plan view of a part of FIG. 24 in which a cover is omitted.

FIG. 26 is a cross-sectional perspective view illustrating a ball and a related structure of a lens driving device according to a first embodiment of the present invention.

FIG. 27 is a perspective view illustrating a ball and a related structure of a lens driving device according to a first embodiment of the present invention.

FIG. 28 is a perspective view illustrating a structure for accommodating a ball of a base of a lens driving device according to a first embodiment of the present invention.

FIG. 29 is a perspective view illustrating a state in which a ball, a plate member, an elastic member, and a reinforcing member are disposed in FIG. 28.

FIG. 30 is a perspective view of FIG. 29 viewed from another direction.

FIG. 31 is a perspective view illustrating a moving part and a ball of a lens driving device according to a first embodiment of the present invention.

FIG. 32 is a perspective view of FIG. 31 viewed from another direction;

FIG. 33(a) is a view comparing the heights of a ball and a pressing point in a state in which the moving part has moved upward; and FIG. 33(b) is a diagram comparing the heights of a ball and a pressing point in a state in which the moving part has moved downward.

FIG. 34 is a cross-sectional perspective view that illustrates an OIS guide member and related components of a lens driving device according to a first embodiment of the present invention.

FIG. 35 is a cross-sectional perspective view that illustrates an OIS guide member and related components of a part of a lens driving device according to a first embodiment of the present invention.

FIGS. 36 to 38 are views for explaining autofocus driving of a lens driving device according to a first embodiment of the present invention. FIG. 36 is a cross-sectional view of a moving part in an initial state in which no current is applied to an AF coil. FIG. 37 is a cross-sectional view illustrating a state in which a moving part moves upward in an optical axis direction when a forward current is applied to an AF coil. FIG. 38 is a cross-sectional view illustrating a moving part moving downward in an optical axis direction when a reverse current is applied to an AF coil.

FIGS. 39 to 41 are views for explaining hand shake compensation driving of a lens driving device according to a first embodiment of the present invention. FIG. 39 is a cross-sectional view illustrating the appearance of an OIS moving part in an initial state in which no current is applied to an OIS-x coil and an OIS-y coil. FIG. 40 is a cross-sectional view illustrating a state in which an OIS moving part moves in an x-axis direction perpendicular to an optical axis as current is applied to an OIS-x coil. FIG. 41 is a cross-sectional view illustrating a state in which a current is applied to an OIS-y coil so that an OIS moving part moves in a y-axis direction perpendicular to both the optical axis and the x-axis.

FIG. 42 is an exploded perspective view of a camera device according to a first embodiment of the present invention.

FIG. 43 is a perspective view of an optical apparatus according to a first embodiment of the present invention.

FIG. 44 is a perspective view of an optical apparatus according to a modified embodiment.

FIG. 45 is a conceptual diagram of a lens driving device according to a second embodiment of the present invention.

FIG. 46 is a perspective view of a lens driving device according to a second embodiment of the present invention.

FIG. 47 is a cross-sectional view viewed from A-A in FIG. 46.

FIG. 48 is a cross-sectional view viewed from B-B in FIG. 46.

FIG. 49 is an enlarged view of a partial region of FIG. 48.

FIG. 50 is a cross-sectional view viewed from C-C in FIG. 46.

FIG. 51 is a cross-sectional view viewed from D-D in FIG. 46.

FIG. 52 is a cross-sectional view of a lens driving device according to a second embodiment of the present invention cut in a direction perpendicular to an optical axis and viewed from above.

FIG. 53 is an exploded perspective view of a lens driving device according to a second embodiment of the present invention.

FIG. 54 is an exploded perspective view of a lens driving device according to a second embodiment of the present invention, viewed from a direction different from that of FIG. 53.

FIG. 55 is a perspective view of a lens driving device according to a second embodiment of the present invention in which a cover is omitted.

FIG. 56 is a perspective view viewed from a direction different from that in FIG. 55;

FIG. 57 is a perspective view illustrating a fixed part and related components of a lens driving device according to a second embodiment of the present invention.

FIG. 58 is a perspective view illustrating a moving part and related components of a lens driving device according to a second embodiment of the present invention.

FIG. 59 is a bottom perspective view viewed from a direction different from that in FIG. 58;

FIG. 60 is a bottom perspective view of a state in which the cover of an AF moving part in FIG. 59 is removed.

FIG. 61 is a bottom perspective view of a state in which an OIS moving part is removed in FIG. 60.

FIG. 62 is an enlarged view of a partial region of FIG. 61.

FIG. 63 is a bottom view of FIG. 61 viewed from below.

FIG. 64 is a perspective view illustrating an OIS moving part and related components of a lens driving device according to a second embodiment of the present invention.

FIG. 65 is an enlarged view of a partial region of FIG. 64.

FIG. 66 is a bottom perspective view of FIG. 64 viewed from a different direction.

FIG. 67 is a perspective view of an elastic member of a lens driving device according to a second embodiment of the present invention.

FIG. 68 is a plan view of a lens driving device according to a second embodiment of the present invention with a cover removed.

FIG. 69 is an enlarged plan view of a part of FIG. 68 in a state where a cover is omitted;

FIG. 70 is a sectional perspective view illustrating a ball and a related structure of a lens driving device according to a second embodiment of the present invention.

FIG. 71 is a perspective view illustrating a ball and a related structure of a lens driving device according to a second embodiment of the present invention.

FIG. 72 is a perspective view illustrating a ball accommodation structure of a base of a lens driving device according to a second embodiment of the present invention.

FIG. 73 is a perspective view illustrating a state in which a ball, a plate member, an elastic member, and a reinforcing member are disposed in FIG. 72.

FIG. 74 is a perspective view of FIG. 73 viewed from another direction;

FIG. 75 is a perspective view illustrating a moving part and a ball of a lens driving device according to a second embodiment of the present invention.

FIG. 76 is a perspective view of FIG. 75 viewed from another direction;

FIG. 77(a) is a view comparing the heights of a ball and a pressure point in a state in which a moving part moves upward; and FIG. 77(b) is a view comparing the heights of a ball and a pressure point in a state where a moving part moves downward.

FIG. 78 is a cross-sectional view of a lens driving device according to a modified embodiment cut in a direction perpendicular to an optical axis and viewed from above.

FIG. 79 is an exploded perspective view of some components of a lens driving device according to a modified embodiment.

FIGS. 80 to 82 are views for explaining auto focus driving of a lens driving device according to a second embodiment of the present invention. FIG. 80 is a cross-sectional view illustrating the appearance of a moving part in an initial state in which no current is applied to an AF coil. FIG. 81 is a cross-sectional view illustrating a state in which a moving part moves upward in an optical axis direction when a forward current is applied to an AF coil. FIG. 82 is a cross-sectional view illustrating how a moving part moves downward in an optical axis direction when a reverse current is applied to an AF coil.

FIGS. 83 to 85 are views for explaining hand shake compensation driving of the lens driving device according to a second embodiment of the present invention. FIG. 83 is a cross-sectional view illustrating the appearance of the OIS moving part in an initial state in which no current is applied to an OIS-x coil and an OIS-y coil. FIG. 84 is a cross-sectional view illustrating a state in which an OIS moving part moves in an x-axis direction perpendicular to an optical axis as current is applied to an OIS-x coil. FIG. 85 is a cross-sectional view illustrating a state in which a current is applied to an OIS-y coil so that an OIS moving part moves in a y-axis direction perpendicular to both the optical axis and the x-axis.

FIG. 86 is an exploded perspective view of a camera device according to a second embodiment of the present invention.

FIG. 87 is a perspective view of an optical apparatus according to a second embodiment of the present invention.

FIG. 88 is a perspective view of an optical apparatus according to a modified embodiment.

### BEST MODE

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (comprising technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may comprise the plural form unless specifically stated in the phrase, and when described as “at least one (or more than one) of A and B and C”, it may comprise one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also comprise cases of being ‘connected’, ‘coupled’, or ‘interconnected’due that another component between that other components.

In addition, when described as being formed or arranged in “on (above)” or “below (under)” of each component, “on (above)” or “below (under)” means that it comprises not only the case where the two components are directly in contact with, but also the case where one or more other components are formed or arranged between the two components. In addition, when expressed as “on (above)” or “below (under)”, the meaning of not only an upward direction but also a downward direction with respect to one component may be comprised.

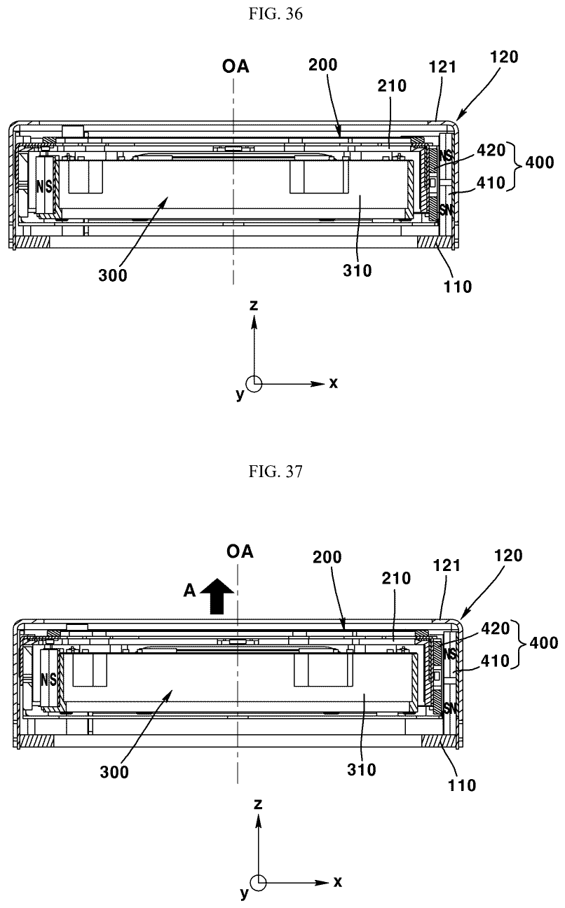

An ‘optical axis (see OA of FIG. 36) direction’ used below is defined as an optical axis direction of a lens and/or an image sensor being coupled to a lens driving device.

The ‘vertical direction’ used below may be a direction parallel to or the same direction as an optical axis direction. A vertical direction may correspond to a ‘z-axis direction’. A ‘horizontal direction’ used below may be a direction perpendicular to a vertical direction. That is, a horizontal direction may be a direction perpendicular to an optical axis. Accordingly, a horizontal direction may comprise an ‘x-axis direction’and a ‘y-axis direction’.

The ‘auto focus (AF) function’ used below is defined as a function that adjusts the distance to an image sensor by moving a lens in an optical axis direction according to the distance of a subject so that a clear image of the subject can be obtained on the image sensor, thereby automatically focusing on the subject. In addition, ‘closed-loop auto focus (CLAF) control’ is defined as real-time feedback control of the position of a lens by detecting the distance between an image sensor and a lens to enhance the accuracy of focus control An ‘optical image stabilization (OIS) function’ used below is defined as a function that moves or tilts a lens in a direction perpendicular to an optical axis to offset the hand shake in order to prevent an image or a video from shaking due to a user's hand shake. In addition, ‘closed-loop auto focus (CLAF) control’ is defined as a real-time feedback control of lens position by detecting the position of the lens relative to an image sensor to enhance the accuracy of image stabilization.

Hereinafter, any one of the “AF moving part 200” and the “OIS moving part 300” may be referred to as a “first moving part” and the other may be referred to as a “second moving part”.

Hereinafter, any one of the “AF driving part 400” and the “OIS driving part” may be referred to as a “first driving part” and the other may be referred to as a “second driving part”.

Hereinafter, any one of the “AF driving part 400”, the “OIS-x driving part 500” and the “OIS-y driving part 600” is referred to as a “first driving part”, the other may be referred to as a “second driving part”, and the other may be referred to as a “third driving part”.

Hereinafter, one of the “AF magnet 410”, the “OIS-x magnet 510” and the “OIS-y magnet 610” is referred to as a “first magnet”, the other is referred to as a “second magnet”, and the other may be referred to as a “third magnet”.

Hereinafter, one of the “AF coil 420”, the “OIS-x coil 520” and the “OIS-y coil 620” is referred to as a “first coil”, the other is referred to as a “second coil”, and the other may be referred to as a “third coil”.

Hereinafter, one among the “AF magnet 410”, the “OIS-x magnet 510”, the “OIS-y magnet 610”, the “AF coil 420”, the “OIS-x coil 520” and the “OIS-y coil 620” is referred to as “first driving unit”, the other is referred to as a “second driving unit”, the other is referred to as a “third driving unit”, the other is referred to as a “fourth driving unit”, the other is referred to as a “fifth driving unit”, and the other may be referred to as a “sixth driving unit”.

Hereinafter, any one of the “outer substrate 710” and the “inner substrate 720” may be referred to as a “first substrate” and the other may be referred to as a “second substrate”.

Hereinafter, any one of the “holder member 220” and the “pre-pressurizing member 230” is referred to as a “first member” and the other may be referred to as a “second member”. In addition, hereinafter, any one of the “holder member 220” and the “pre-pressurizing member 230” may be referred to as a “first housing” and the other may be referred to as a “second housing”.

Hereinafter, any one of the “upper elastic member 830” and the “lower elastic member 840” is referred to as a “first elastic member” and the other may be referred to as a “second elastic member”.

Hereinafter, one among the “upper elastic member 830”, the “lower elastic member 840”, and the “wire 850” is referred to as a “first support member”, the other is referred to as a “second support member”, and the other may be referred to as a “third support member”.

Hereinafter, one among the “AF sensor 430”, the “OIS-x sensor 530”, and the “OIS-y sensor 630” is referred to as a “first sensor”, the other is referred to as a “second sensor”, and the other may be referred to as a “third sensor”.

Hereinafter, one among the “AF yoke 440”, the “OIS-x yoke 540”, and the “OIS-y yoke 640” is referred to as a “first yoke”, the other is referred to as a “second yoke”, and the other may be referred to as a “third yoke”.

Hereinafter, one among the individual balls of the AF guide ball 810 is referred to as a “first unit ball”, the other is referred to as a “second unit ball”, the other is referred to as a “third unit ball”, and the other may be referred to as a “fourth unit ball”. Furthermore, “nth unit ball” may be used to refer to individual balls such as “fifth unit ball” and “sixth unit ball”.

Hereinafter, one of the “pillar part 111” and the “outer wall part 112” is referred to as a “first portion”, and the other may be referred to as a “second portion”.

Hereinafter, one of the “inner groove 111-1” and the “outer groove 112-1” is referred to as a “first groove”, and the other may be referred to as a “second groove”.

Hereinafter, one of the “inner groove 224-1” and “outer groove 224-2” is referred to as a “first groove”, and the other may be referred to as a “second groove”.

Hereinafter, one of the “inner ball 811” and the “outer ball 812” is referred to as a “first unit ball”, and the other may be referred to as a “second unit ball”.

Hereinafter, one of the “uppermost inner ball 811-1” and the “uppermost outer ball 812-1” is referred to as a “first uppermost ball”, and the other may be referred to as a “second uppermost ball”.

Hereinafter, one of the “lowermost inner ball 811-2” and the “lowermost outer ball 812-2” is referred to as a “first lowermost ball”, and the other may be referred to as a “second lowermost ball”

Hereinafter, one among the “upper bent part 921”, the “lower bent part 922”, and the “connection bent part 923” is referred to as a “first bent part”, the other is referred to as a “second bent part”, and the other may be referred to as a “third bent part”.

Hereinafter, any one of the “AF moving part 1200” and the “OIS moving part 1300” is referred to as a “first moving part”, and the other may be referred to as a “second moving part”.

Hereinafter, any one of the “AF driving unit 1400” and the “OIS driving unit” is referred to as a “first driving unit” and the other may be referred to as a “second driving unit”.

Hereinafter, any one among the “AF driving part 1400”, the “OIS-x driving part 1500”, and the “OIS-y driving part 1600” is referred to as a “first driving part”, the other is referred to as “second driving part”, and the other can be referred to as a “third driving part”.

Hereinafter, any one of the “AF magnet 1410”, the “OIS-x magnet 1510”, and the “OIS-y magnet 1610” is referred to as a “first magnet”, the other is referred to as a “second magnet”, and the other may be referred to as a “third magnet”.

Hereinafter, one among the “AF coil 1420”, the “OIS-x coil 1520”, and the “OIS-y coil 1620” is referred to as a “first coil”, the other is referred to as a “second coil”, and the other may be referred to as a “third coil”.

Hereinafter, one among the “AF magnet 1410”, the “OIS-x magnet 1510”, the “OIS-y magnet 1610”, the “AF coil 1420”, the “OIS-x coil 1520”, and the “OIS-y coil 1620” is referred to as a “first driving unit”, the other is referred to as a “second driving unit”, the other is referred to as a “third driving unit”, the other is referred to as a “fourth driving unit”, the other is referred to as a “fifth driving unit”, and the other may be referred to as a “sixth driving unit”.

Hereinafter, any one of the “outer substrate 1710” and the “inner substrate 1720” may be referred to as a “first substrate” and the other may be referred to as a “second substrate”.

Hereinafter, any one of the “AF guide ball 1810” and the “OIS guide ball 1820” is referred to as a “first ball”, and the other may be referred to as a “second ball”.

Hereinafter, any one of the “holder member 1220” and the “pre-pressurizing member 1230” is referred to as a “first member”, and the other may be referred to as a “second member”. In addition, hereinafter, any one of the “holder member 1220” and the “pre-pressurizing member 1230” is referred to as a “first housing”, and the other may be referred to as a “second housing”.

Hereinafter, any one of the “upper elastic member 1830” and the “lower elastic member 1840” is referred to as a “first elastic member”, and the other may be referred to as a “second elastic member”.

Hereinafter, one among the “upper elastic member 1830”, the “lower elastic member 1840”, and the “wire 1850” is referred to as a “first support member”, the other is referred to as a “second support member”, and the other may be referred to as a “third support member”.

Hereinafter, one among the “AF sensor 1430”, the “OIS-x sensor 1530”, and the “OIS-y sensor 1630” is referred to as a “first sensor”, the other is referred to as a “second sensor”, and the other may be referred to as a “third sensor”.

Hereinafter, one among the “AF yoke 1440”, the “OIS-x yoke 1540”, and the “OIS-y yoke 1640” is referred to as a “first yoke”, the other is referred to as a “second yoke”, and the other may be referred to as a “third yoke”.

Hereinafter, one of the individual balls of the AF guide ball 1810 and the individual ball of the OIS guide ball 1820 is referred to as a “first unit ball”, the other is referred to as a “second unit ball”, the other is referred to as a “third unit ball”, and the other may be referred to as a “fourth unit ball”. Furthermore, “nth unit ball” may be used to refer to individual balls such as “fifth unit ball” and “sixth unit ball”.

Hereinafter, one of the “pillar part 1111” and the “outer wall part 1112” is referred to as a “first portion”, and the other may be referred to as a “second portion”. Or, hereinafter, one of the “pillar part 1111” and the “outer wall part 1112” is referred to as a “first pillar”, and the other may be referred to as a “second pillar”. Or, hereinafter, one of the “pillar part 1111” and the “outer wall part 1112” may be referred to as a “first protruding part” and the other may be referred to as a “second protruding part”.

Hereinafter, one of the “inner groove 1111-1” and the “outer groove 1112-1” is referred to as a “first groove”, and the other may be referred to as a “second groove”.

Hereinafter, one of the “inner groove 1224-1” and “outer groove 1224-2” is referred to as a “first groove”, and the other may be referred to as a “second groove”.

Hereinafter, one of the “inner ball 1811” and the “outer ball 1812” is referred to as a “first unit ball”, and the other may be referred to as a “second unit ball”. Or, hereinafter, one of the “inner ball 1811” and the “outer ball 1812” is referred to as a “first ball part” and the other may be referred to as a “second ball part”.

Hereinafter, one of the “uppermost inner ball 1811-1” and the “uppermost outer ball 1812-1” is referred to as a “first uppermost ball”, and the other may be referred to as a “second uppermost ball”.

Hereinafter, one of the “lowermost inner ball 1811-2” and the “lowermost outer ball 1812-2” is referred to as a “first lowermost ball”, and the other may be referred to as a “second lowermost ball”.

Hereinafter, one among the “upper bent part 1921”, the “lower bent part 1922”, and the “connection bent part 1923” is referred to as a “first bent part”, the other is referred to as a “second bent part”, and the other may be referred to as a “third bent part”.

Hereinafter, a configuration of a lens driving device according to a first embodiment of the present invention will be described with reference to the drawings.

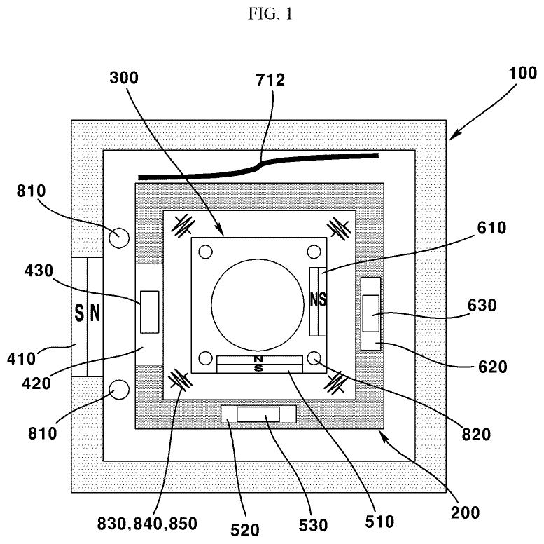

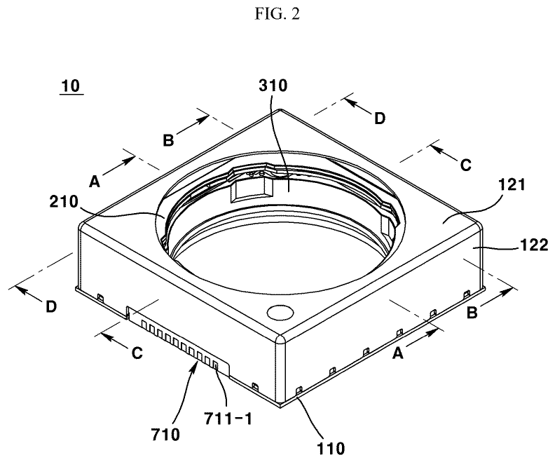

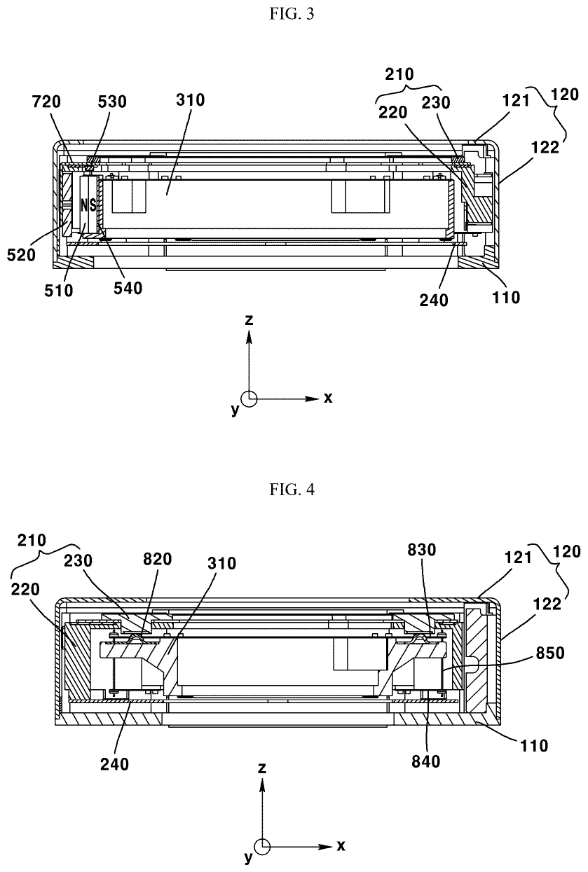

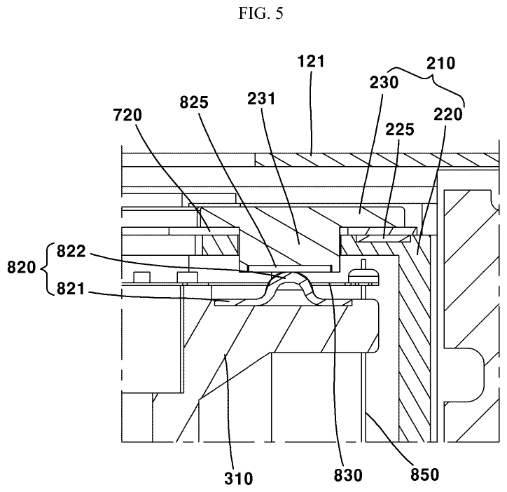

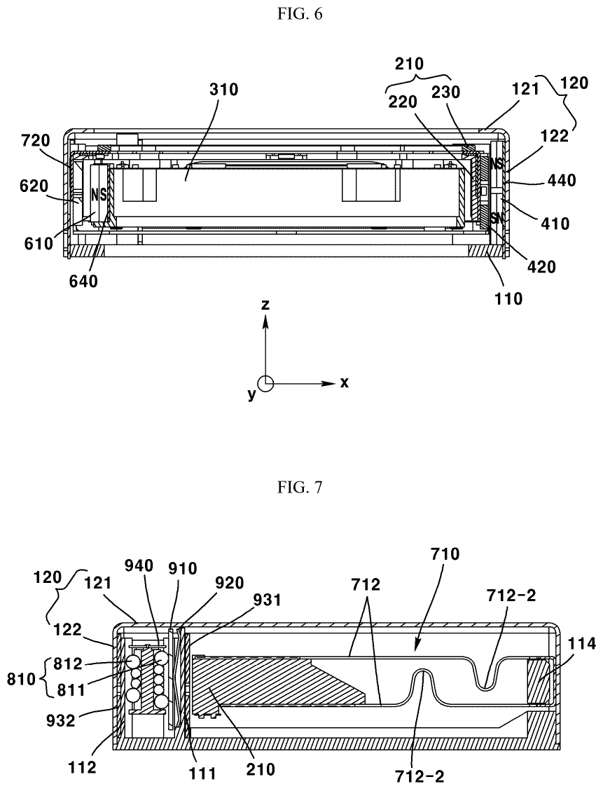

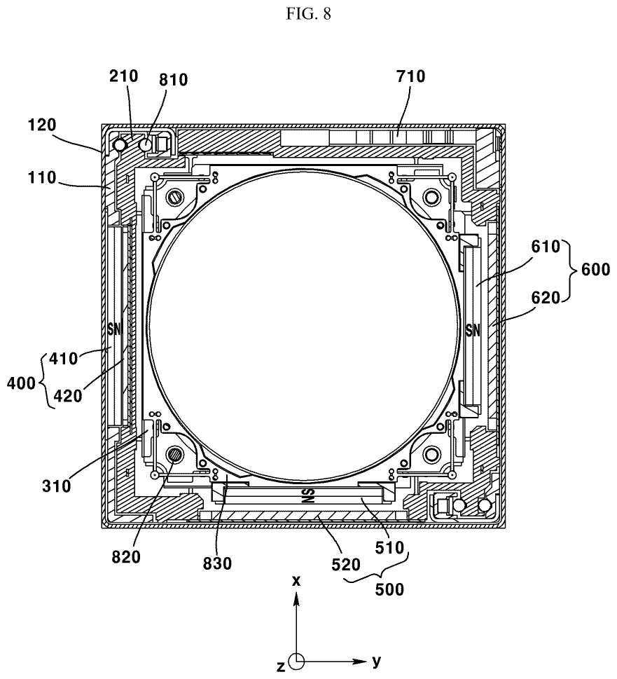

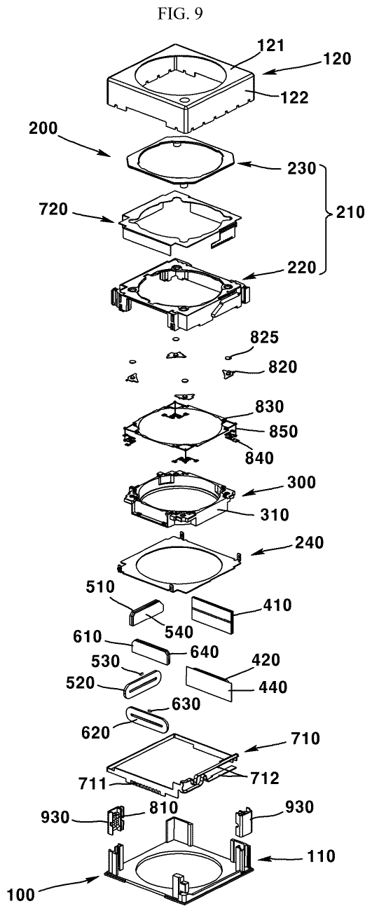

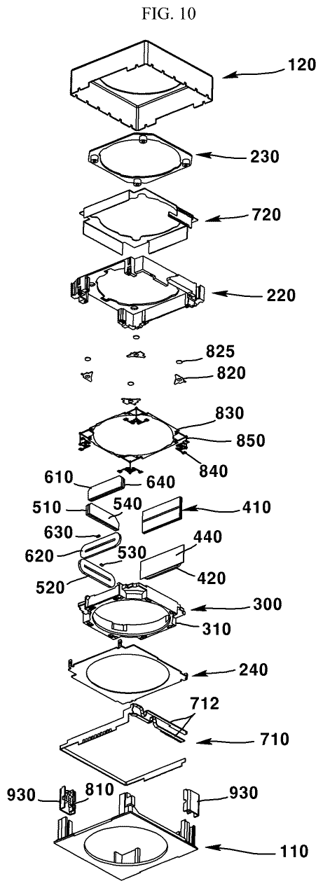

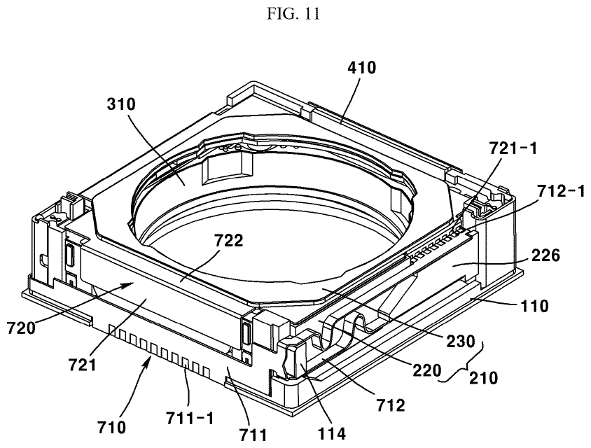

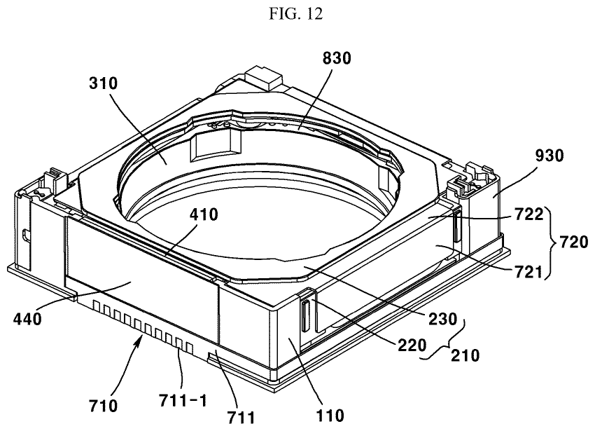

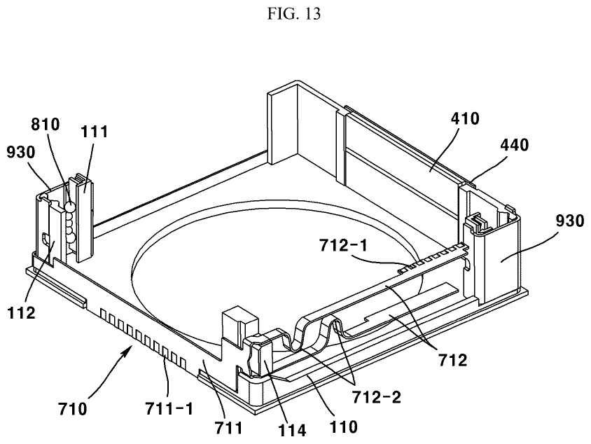

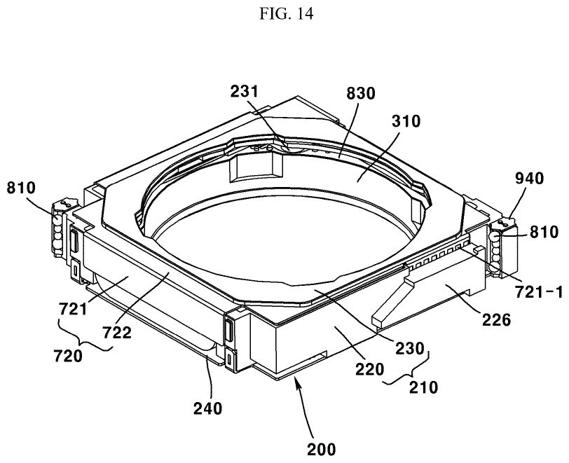

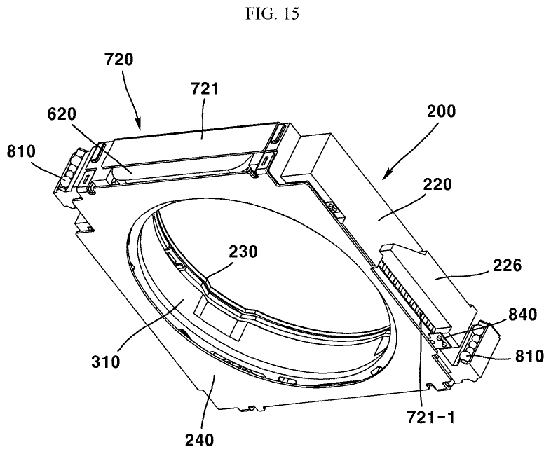

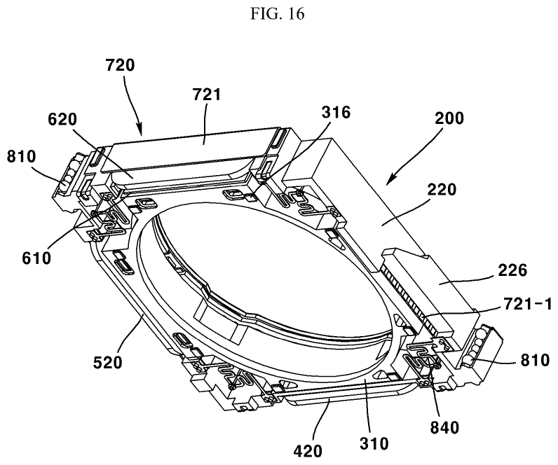

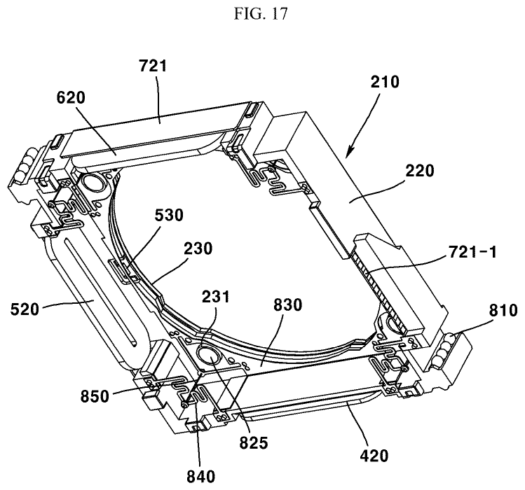

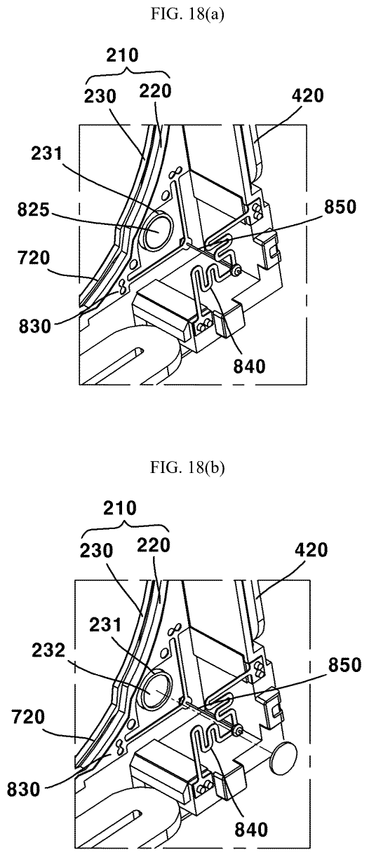

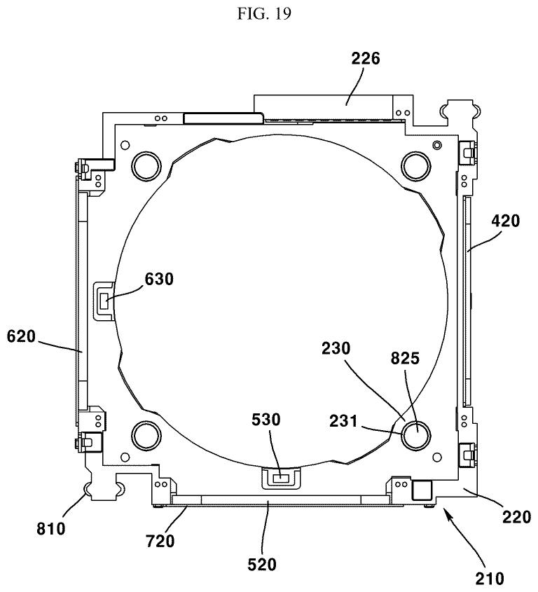

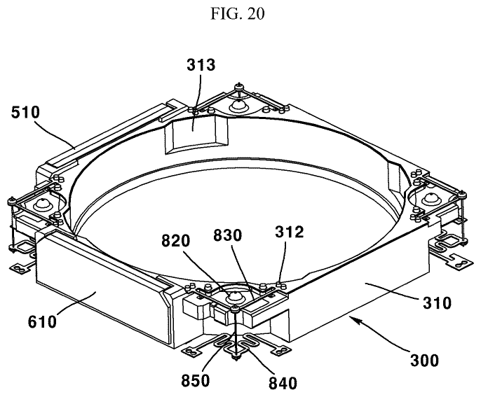

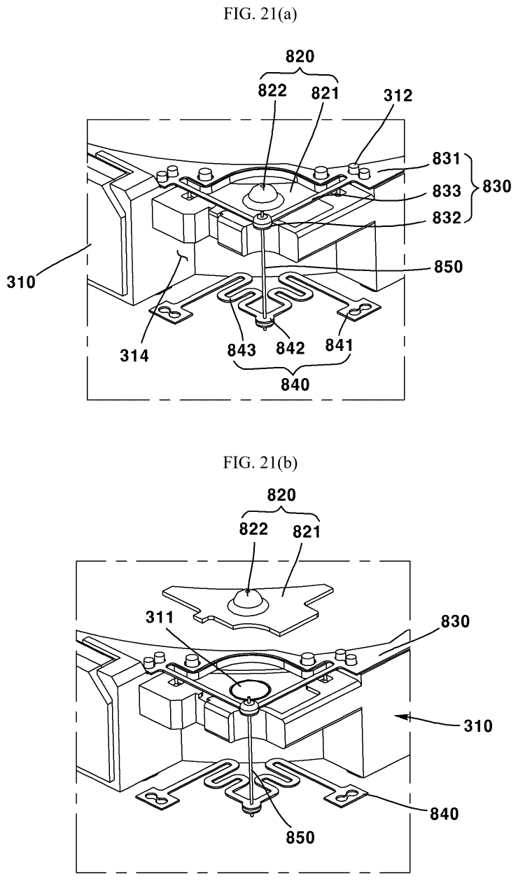

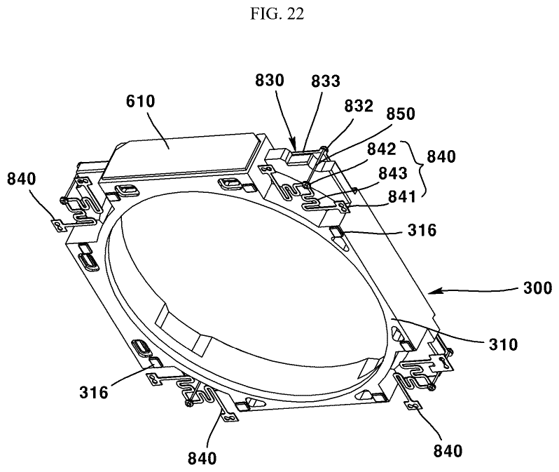

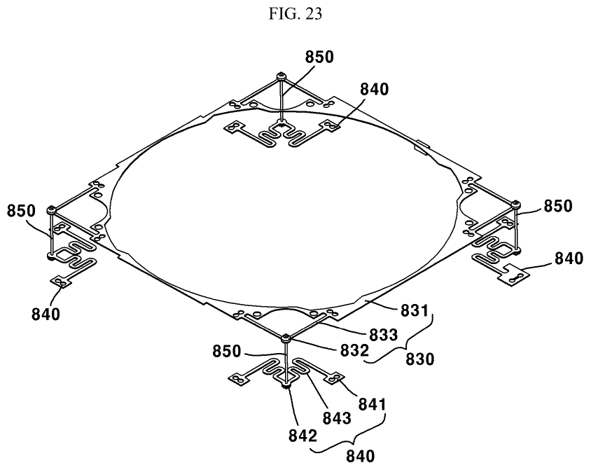

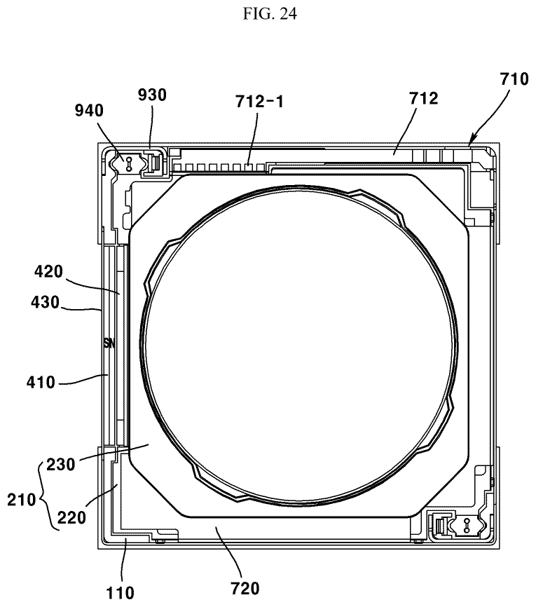

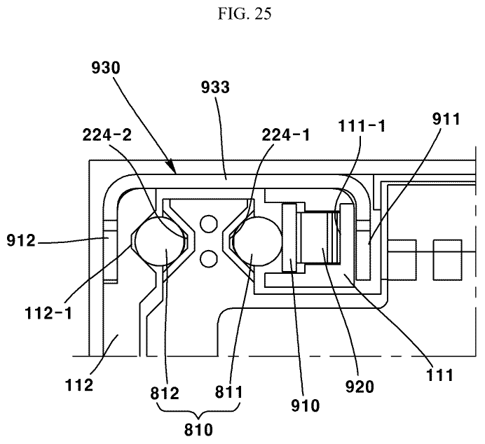

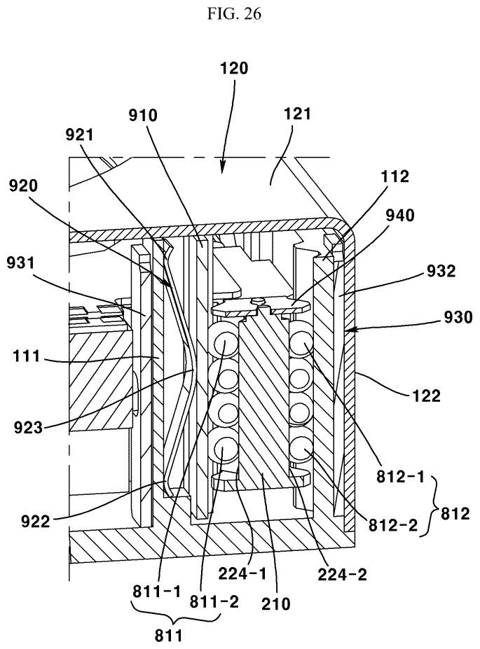

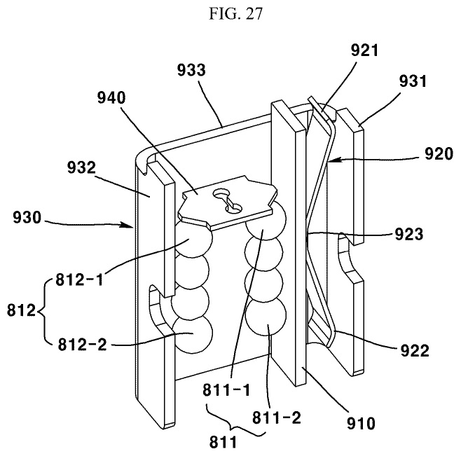

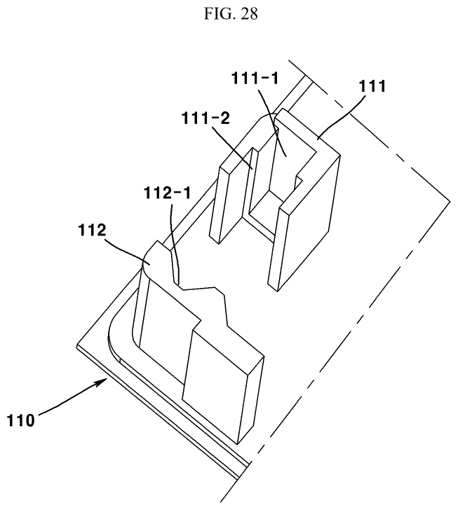

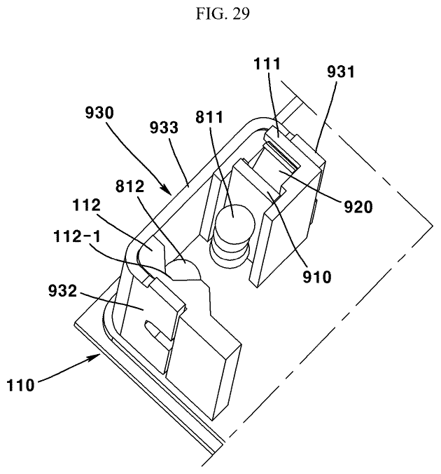

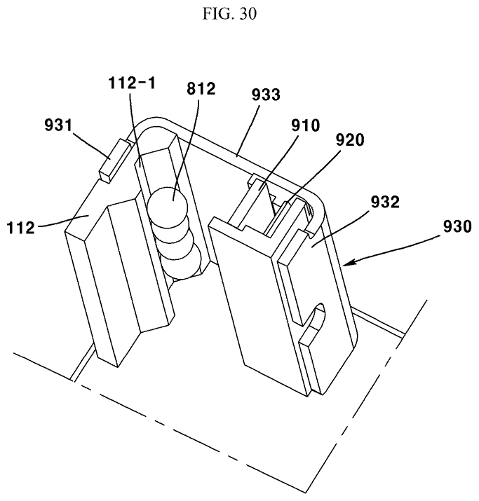

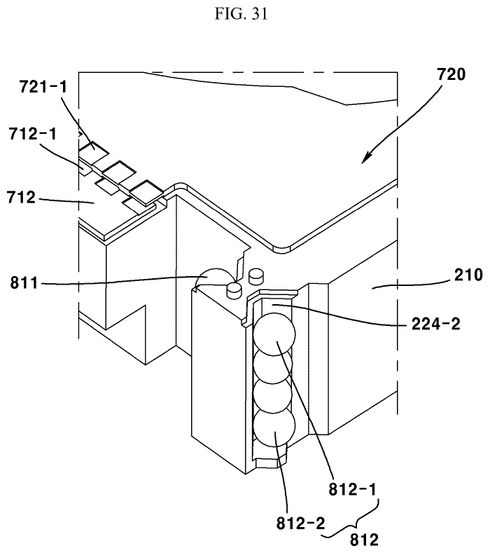

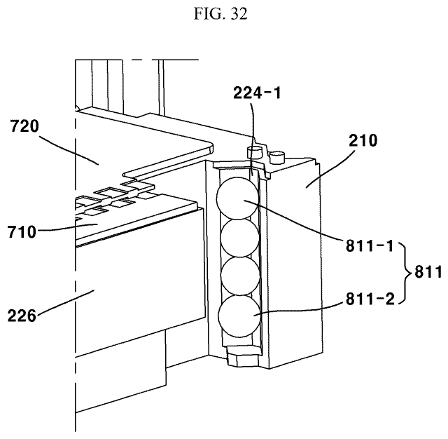

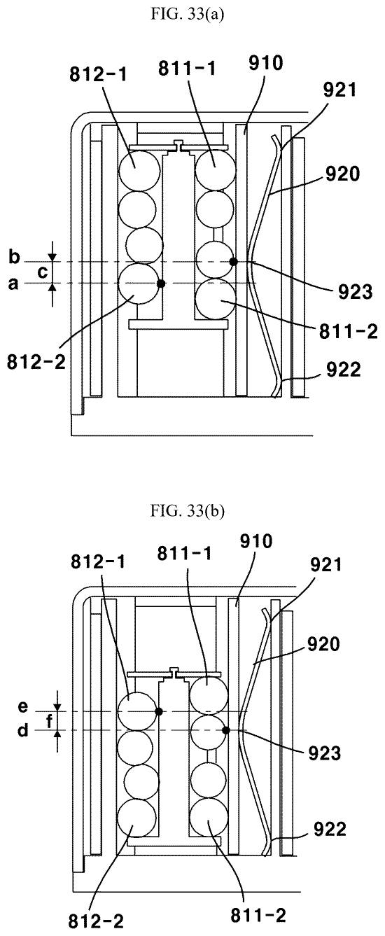

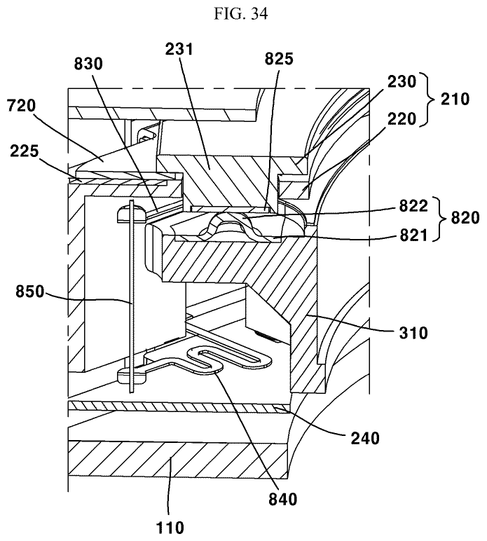

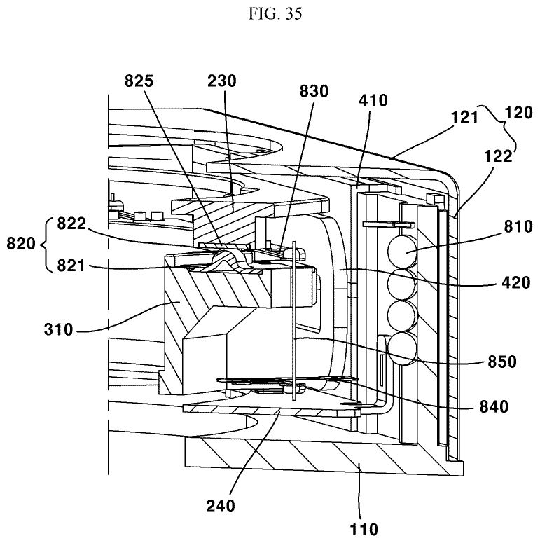

FIG. 1 is a conceptual diagram of a lens driving device according to a first embodiment of the present invention. FIG. 2 is a perspective view of a lens driving device according to a first embodiment of the present invention. FIG. 3 is a cross-sectional view viewed from A-A in FIG. 2. FIG. 4 is a cross-sectional view viewed from B-B in FIG. 2. FIG. 5 is an enlarged view of a partial region of FIG. 4. FIG. 6 is a cross-sectional view viewed from C-C in FIG. 2. FIG. 7 is a cross-sectional view viewed from D-D in FIG. 2. FIG. 8 is a cross-sectional view of a lens driving device according to a first embodiment of the present invention cut in a direction perpendicular to an optical axis and viewed from above. FIG. 9 is an exploded perspective view of a lens driving device according to a first embodiment of the present invention. FIG. 10 is an exploded perspective view of a lens driving device according to a first embodiment of the present invention viewed from a direction different from that of FIG. 9. FIG. 11 is a perspective view of a state in which a cover is omitted from a lens driving device according to a first embodiment of the present invention. FIG. 12 is a perspective view viewed from a direction different from that of FIG. 11. FIG. 13 is a perspective view illustrating a fixed part and related components of a lens driving device according to a first embodiment of the present invention. FIG. 14 is a perspective view illustrating a moving part and related components of a lens driving device according to a first embodiment of the present invention. FIG. 15 is a bottom perspective view viewed from a direction different from that of FIG. 14. FIG. 16 is a bottom perspective view of a state in which the cover of an AF moving part in FIG. 15 is removed. FIG. 17 is a bottom perspective view of a state in which an OIS moving part is removed in FIG. 16. FIG. 18(a) is an enlarged view of a partial region of FIG. 17, and FIG. 18(b) is a separated view of the plate member in FIG. 18(a). FIG. 19 is a bottom view of FIG. 17 viewed from below. FIG. 20 is a perspective view illustrating an OIS moving part and related components of a lens driving device according to a first embodiment of the present invention. FIG. 21(a) is an enlarged view of a partial region of FIG. 20, and FIG. 21(b) is a separated view of the guide member in FIG. 21(a). FIG. 22 is a bottom perspective view of FIG. 20 viewed from a different direction. FIG. 23 is a perspective view of an elastic member of the lens driving device according to a first embodiment of the present invention. FIG. 24 is a plan view of a lens driving device according to a first embodiment of the present invention in a state where a cover is removed. FIG. 25 is an enlarged plan view of a part of FIG. 24 in which a cover is omitted. FIG. 26 is a cross-sectional perspective view illustrating a ball and a related structure of a lens driving device according to a first embodiment of the present invention. FIG. 27 is a perspective view illustrating a ball and a related structure of a lens driving device according to a first embodiment of the present invention. FIG. 28 is a perspective view illustrating a structure for accommodating a ball of a base of a lens driving device according to a first embodiment of the present invention. FIG. 29 is a perspective view illustrating a state in which a ball, a plate member, an elastic member, and a reinforcing member are disposed in FIG. 28. FIG. 30 is a perspective view of FIG. 29 viewed from another direction. FIG. 31 is a perspective view illustrating a moving part and a ball of a lens driving device according to a first embodiment of the present invention. FIG. 32 is a perspective view of FIG. 31 viewed from another direction; FIG. 33(a) is a view comparing the heights of a ball and a pressing point in a state in which the moving part has moved upward; and FIG. 33(b) is a diagram comparing the heights of a ball and a pressing point in a state in which the moving part has moved downward. FIG. 34 is a cross-sectional perspective view that illustrates an OIS guide member and related components of a lens driving device according to a first embodiment of the present invention. FIG. 35 is a cross-sectional perspective view that illustrates an OIS guide member and related components of a part of a lens driving device according to a first embodiment of the present invention.

The lens driving device 10 may be a voice coil motor (VCM). The lens driving device 10 may be a lens driving motor. The lens driving device 10 may be a lens driving actuator. The lens driving device 10 may comprise an AF module. The lens driving device 10 may comprise an OIS module.

The lens driving device 10 may comprise a fixed part 100. The fixed part 100 may be a relatively fixed part when the moving part moves. The moving part may move against the fixed part 100.

The lens driving device 10 may comprise a base 110. The fixed part 100 may comprise a base 110. The base 110 may be disposed below the AF carrier 210. The base 110 may be disposed below the OIS carrier 310. The base 110 may be coupled with cover 120. The AF carrier 210 and the OIS carrier 310 may be disposed on the base 110. The AF carrier 210 and the OIS carrier 310 may be disposed on a lower plate portion of the base 110. The AF carrier 210 and the OIS carrier 310 may be disposed inside the base 110. The AF carrier 210 and the OIS carrier 310 may be disposed inside the side wall part of the base 110.

The base 110 may comprise a lower plate portion. The lower plate portion of the base 110 may support a lower surface of the AF moving part 200. The lower plate portion of the base 110 may support a lower surface of the AF carrier 210.

The base 110 may comprise a pillar part 111. The pillar part 111 may be extended from an upper surface of the lower plate portion. The pillar part 111 may be disposed inside the outer wall part 112.

The base 110 may comprise an inner groove 111-1. The pillar part 111 may comprise an inner groove 111-1. The inner groove 111-1 may be formed in the pillar part 111. The inner groove 111-1 may be an ‘AF guide ball accommodating groove’. An AF guide ball 810 may be disposed in the inner groove 111-1. An inner ball 811 may be disposed in the inner groove 111-1. The inner groove 111-1 may be directly in contact with the AF guide ball 810. The inner groove 111-1 may be disposed in an optical axis direction. The inner groove 111-1 may comprise a plurality of grooves. The inner groove 111-1 may comprise two grooves. The two grooves may be disposed parallel to each other. The two grooves may be disposed in a diagonal direction from each other with respect to an optical axis.

The base 110 may comprise a step 111-2. The step 111-2 may be formed in the pillar part 111. A plate member 910 may be disposed in the step 111-2.

The base 110 may comprise an outer wall part 112. The outer wall part 112 may be a ‘side portion’. The outer wall part 112 may be a ‘side plate’. The outer wall part 112 may be a ‘side wall’. The outer wall part 112 of the base 110 may be extended from an upper surface of the lower plate portion.

The base 110 may comprise an outer groove 112-1. The outer wall part 112 may comprise an outer groove 112-1. The outer groove 112-1 may be formed to face the inner groove 111-1. The outer groove 112-1 may face the inner groove 111-1. The outer groove 112-1 may be an ‘AF guide ball accommodating groove’. An AF guide ball 810 may be disposed in the outer groove 112-1. An outer ball 812 may be disposed in the outer groove 112-1. The outer groove 112-1 may directly in contact with the AF guide ball 810. The outer groove 112-1 may be disposed in an optical axis direction. The outer groove 112-1 may comprise a plurality of grooves. The outer groove 112-1 may comprise two grooves. The two grooves may be disposed parallel to each other. The two grooves may be disposed in a diagonal direction from each other with respect to an optical axis. The outer groove 112-1 may be disposed at an opposite side of the inner groove 111-1. The outer groove 112-1 may have a shape corresponding to the inner groove 111-1. The outer groove 112-1 and the inner groove 111-1 may have the same length in an optical axis direction.

The base 110 may comprise a protruding part 114. The protruding part 114 may be protruded outward. A connection part 712 of the outer substrate 710 may be disposed above and below the protruding part 114. A groove may be formed in the protruding part 114 so as not to interfere even when the connecting part 712 of the outer substrate 710 moves.

The base 110 may comprise a step. The step may be formed on a lower end portion of an outer side surface of the base 110. The step may be protruded from an outer side surface of the base 110. The side plate 122 of the cover 120 may be disposed in a step of the base 110.

The lens driving device 10 may comprise a cover 120. The fixed part 100 may comprise a cover 120. The cover 120 may be disposed in the base 110. The cover 120 may be disposed on the base 110. The cover 120 may be coupled to the base 110. The cover 120 may be fixed to the base 110. The cover 120 may accommodate the AF carrier 210 therein. The cover 120 may accommodate the OIS carrier 310 therein. The cover 120 may be a shield member. The cover 120 may be a shield can.

The cover 120 may comprise an upper plate 121. The upper plate 121 may be disposed on a moving part. The upward movement of the moving part may be limited by contacting of the moving part with the upper plate 121. The upper plate 121 may comprise a hole through which light passes.

The cover 120 may comprise a side plate 122. The side plate 122 may be extended from the upper plate 121. The side plate 122 may be disposed in the base 110. The side plate 122 may be disposed on a step portion being protruded from a lower end portion of an outer side surface of the base 110. The side plate 122 may comprise a plurality of side plates. The side plate 122 may comprise four side plates. The side plate 122 may comprise a first side plate and a second side plate being disposed opposite to each other, and a third side plate and a fourth side plate being disposed opposite to each other.

The lens driving device 10 may comprise a moving part. The moving part may be disposed in the fixed part 100. The moving part may be disposed inside the fixed part 100. The moving part may be disposed on the fixed part 100. The moving part may be movably disposed in the fixed part 100. The moving part may move based on the fixed part 100 by the driving part. The moving part can move during AF driving. The moving part can move during OIS driving. A lens may be coupled to the moving part.

The lens driving device 10 may comprise an AF moving part 200. The AF moving part 200 may be disposed in the fixed part 100. The AF moving part 200 may be disposed inside the fixed part 100. The AF moving part 200 may be disposed on the fixed part 100. The AF moving part 200 may be disposed between the fixed part 100 and the OIS moving part 300. The AF moving part 200 may be movably disposed in the fixed part 100. The AF moving part 200 may move in an optical axis direction against the fixed part 100 by the AF driving part 400. The AF moving part 200 may move during AF driving.

In a modified embodiment, the AF moving part 200 and the AF driving part 400 may be omitted. That is, the OIS moving part 300 may be disposed in the fixed part 100. Or, the OIS moving part 300 may be disposed on the fixed part 100 and the AF moving part 200 may be disposed inside the OIS moving part 300.

The lens driving device 10 may comprise an AF carrier 210. The AF moving part 200 may comprise an AF carrier 210. The AF carrier 210 may be an ‘AF holder’. The AF carrier 210 may be a ‘housing’. The AF carrier 210 may be disposed inside the base 110. AF carrier 210 may be disposed on the base 110. The AF carrier 210 may be disposed inside the cover 120. The AF carrier 210 may be disposed between the base 110 and the OIS carrier 310. The AF carrier 210 may be movably disposed in an optical axis direction.

The AF carrier 210 may comprise a frame, a first upper plate, and a second upper plate. At this time, the frame may be a body part. The frame may be the holder member 220. The first upper plate may be a metal member 225. The second upper plate may be a pre-pressurizing member 230. The AF carrier 210 may be a housing. The housing may comprise a first housing and a second housing. At this time, the first housing may comprise the holder member 220 and the second housing may comprise the pre-pressurizing member 230. The OIS carrier 310 may be a bobbin. The OIS guide member 820 may be disposed between the housing and the bobbin. The AF guide ball 810 may be disposed between a side surface of the housing and the cover 120. The AF guide ball 810 may be disposed between a side surface of the housing and a base or pillar of the base.

The lens driving device 10 may comprise a holder member 220. The AF carrier 210 may comprise a holder member 220. The holder member 220 may be formed separately from the pre-pressurizing member 230. A lower elastic member 840 may be coupled to the holder member 220.

The AF carrier 210 may comprise an upper plate. The upper plate may be disposed on the OIS carrier 310. The upper plate may be disposed between the OIS carrier 310 and the upper plate 121 of the cover 120. The upper plate may be disposed on the OIS moving part 300.

The AF carrier 210 may comprise a hole. The holder member 220 may comprise a hole. The upper plate of the holder member 220 may comprise a hole. A hole may be formed in an upper plate of the holder member 220. The hole can be opened inward. A pre-pressurizing member 230 may be inserted into the hole. The protruding part 231 of the pre-pressurizing member 230 may be inserted into the hole. The hole may be formed as a groove. The hole can be replaced by a groove. That is, as a modified embodiment, the AF carrier 210 may comprise a groove into which the protruding part 231 of the pre-pressurizing member 230 is inserted.

The AF carrier 210 may comprise a side wall. The sidewall may be extended downward from an upper plate. An inner substrate 720 may be disposed on a sidewall. An AF coil 420 may be disposed on the sidewall. An OIS-x coil 520 may be disposed on a side wall. An OIS-y coil 620 may be disposed on a side wall. The sidewall may comprise a groove that avoids the coil. The sidewall may comprise a plurality of sidewalls. The sidewall may comprise four sidewalls. The sidewall may comprise a first sidewall and a second sidewall being disposed opposite to each other, and a third sidewall and a fourth sidewall being disposed opposite to each other.

The AF carrier 210 may comprise an inner groove 224-1. The holder member 220 may comprise an inner groove 224-1. The inner groove 224-1 may be an ‘AF guide ball accommodating groove’. An AF guide ball 810 may be disposed in the inner groove 224-1. An inner ball 811 may be disposed in the inner groove 224-1. The inner groove 224-1 may directly in contact with the AF guide ball 810. The inner groove 224-1 may be disposed in an optical axis direction. The inner groove 224-1 may guide the AF guide ball 810 to move in an optical axis direction. The inner groove 224-1 may comprise a plurality of grooves. The inner groove 224-1 may comprise two grooves. The two grooves may be disposed parallel to each other. The two grooves may be disposed at a diagonal direction from each other with respect to an optical axis.

The AF carrier 210 may comprise an outer groove 224-2. The holder member 220 may comprise an outer groove 224-2. The outer groove 224-2 may be an ‘AF guide ball accommodating groove’. An AF guide ball 810 may be disposed in the outer groove 224-2. An outer ball 812 may be disposed in the outer groove 224-2. The outer groove 224-2 may be directly in contact with the AF guide ball 810. The outer groove 224-2 may be disposed in an optical axis direction. The outer groove 224-2 may guide the AF guide ball 810 to move in an optical axis direction. The outer groove 224-2 may comprise a plurality of grooves. The outer groove 224-2 may comprise two grooves. The two grooves may be disposed parallel to each other. The two grooves may be disposed in a diagonal direction from each other with respect to an optical axis. The outer groove 224-2 may be disposed at an opposite side of the inner groove 224-1. The outer groove 224-2 may have a shape corresponding to the inner groove 224-1. The outer groove 224-2 and the inner groove 224-1 may have the same length in an optical axis direction.

The AF carrier 210 may comprise a metal member 225. The holder member 220 may comprise a metal member 225. The metal member 225 may be insert-injected into the holder member 220. At least a portion of the metal member 225 may be disposed on an upper surface of the holder member 220. The metal member 225 may be disposed to reinforce the strength of the holder member 220.

The AF carrier 210 may comprise a protruding part 226. The holder member 220 may comprise a protruding part 226. The protruding part 226 may be formed on an outer side surface of the AF carrier 210. The protruding part 226 may be protruded outward from the AF carrier 210. A connection part 712 may be disposed on an upper surface and a lower surface of the protruding part 226.

The lens driving device 10 may comprise a pre-pressurizing member 230. The AF carrier 210 may comprise a pre-pressurizing member 230. The pre-pressurizing member 230 may be coupled to an upper surface of the holder member 220. The pre-pressurizing member 230 may be coupled with the holder member 220. The pre-pressurizing member 230 may be inserted and coupled to the holder member 220 from above. The pre-pressurizing member 230 may apply pressure to the OIS guide member 820. The pre-pressurizing member 230 may be in contact with the OIS guide member 820. The pre-pressurizing member 230 may be directly in contact with the OIS guide member 820. The pre-pressurizing member 230 may apply pressure to the OIS guide member 820 by being coupled to the holder member 220.

The AF carrier 210 may comprise a protruding part 231. The pre-pressurizing member 230 may comprise a protruding part 231. The protruding part 231 may be coupled to the hole of the holder member 220. The protruding part 231 of the pre-pressurizing member 230 may be inserted into a hole of the holder member 220 from above. The protruding part 231 of the pre-pressurizing member 230 may be disposed in a hole of the holder member 220. At least a part of the protruding part 231 of the pre-pressurizing member 230 may be disposed in a hole of the holder member 220. The OIS guide member 820 may be disposed on a lower end portion of the protruding part 231 of the pre-pressurizing member 230. The protruding part 231 may comprise a plurality of protrusions. The protruding part 231 may comprise four protrusions.

The AF carrier 210 may comprise a groove 232. The pre-pressurizing member 230 may comprise a groove 232. The groove 232 may be a ‘plate member accommodating groove’. The groove 232 may be formed in the protruding part 231. The groove 232 may be formed on a lower surface of the protruding part 231. The groove 232 may be formed at an end portion of the protruding part 231. The groove 232 may be concavely formed on a lower surface of the protruding part 231. A plate member 825 may be disposed in the groove 232. The groove 232 may be directly in contact with the plate member 825. At this time, the OIS guide member 820 may be in contact with the plate member 825.

However, the plate member 825 may be omitted as a modified embodiment. At this time, the groove 232 may comprise a flat bottom surface. The OIS guide member 820 may be in contact with the bottom surface of the groove 232 at one point. In other words, the groove 232 comprises a flat bottom surface, and the OIS guide member 820 may be in contact with the flat surface at one point. Or, the bottom surface of the groove 232 may comprise at least three planes being disposed inclined to each other. In this case, the OIS guide member 820 may be in contact with the bottom surface of the groove 232 at three points.

The lens driving device 10 may comprise a cover 240. The AF moving part 200 may comprise a cover 240. The cover 240 may be coupled with the AF carrier 210. The cover 240 may be coupled to a lower surface of the AF carrier 210. The cover 240 may be coupled to the AF carrier 210 at a lower side. The cover 240 may comprise a hook. The hook of the cover 240 may be coupled to the AF carrier 210. The hook of the cover 240 is protruded upward and may be coupled to a side surface of the AF carrier 210.

The lens driving device 10 may comprise an OIS moving part 300. The OIS moving part 300 may be disposed in the fixed part 100. The OIS moving part 300 may be disposed inside the fixed part 100. The OIS moving part 300 may be disposed on the fixed part 100. The OIS moving part 300 may be disposed inside the AF moving part 200. The OIS moving part 300 may be movably disposed. The OIS moving part 300 may move in a direction perpendicular to the optical axis against the fixed part 100 and the AF moving part 200 by the OIS driving part. The OIS moving part 300 may move in an x-axis direction by the OIS-x driving part 500. The OIS moving part 300 may move in a y-axis direction by the OIS-y driving part 600. The OIS moving part 300 may move during OIS driving.

The lens driving device 10 may comprise an OIS carrier 310. The OIS moving part 300 may comprise an OIS carrier 310. The OIS carrier 310 may be an ‘OIS holder’. The OIS carrier 310 may be a ‘bobbin’. The OIS carrier 310 may be disposed inside the AF carrier 210. The OIS carrier 310 may be disposed inside the base 110. The OIS carrier 310 may be disposed on the base 110. The OIS carrier 310 may be disposed inside the cover 120. The OIS carrier 310 may be movably disposed in a direction perpendicular to the optical axis.

The OIS carrier 310 may comprise an outer side surface. The OIS carrier 310 may comprise a plurality of side surfaces. The OIS carrier 310 may comprise a first side surface and a second side surface being disposed opposite to each other, and a third side surface and a fourth side surface being disposed opposite to each other. The AF coil 420 may be disposed between a first side surface of the OIS carrier 310 and the AF magnet 410. The OIS-x magnet 510 may be disposed on a third side surface of the OIS carrier 310. The OIS-y magnet 610 may be disposed on a second side surface of the OIS carrier 310.

The OIS carrier 310 may comprise a groove. The groove may be an ‘upper elastic member interference prevention groove’. A groove may be formed on an upper surface of the OIS carrier 310. The groove may be concavely formed on an upper surface of the OIS carrier 310. The groove may be disposed at a position corresponding to the upper elastic member 830 to prevent interference between the OIS carrier 310 and the upper elastic member 830.

The OIS carrier 310 may comprise a groove 311. The groove 311 may be an ‘insert groove’. An OIS guide member 820 may be disposed in the groove 311. The groove 311 may be directly in contact with the OIS guide member 820. The groove 311 may be disposed in a direction perpendicular to the optical axis. The groove 311 may be recessed in an optical axis direction. The groove 311 may comprise a plurality of grooves. The groove 311 may comprise four grooves. The OIS guide member 820 may be coupled to the groove 311. The OIS guide member 820 may be disposed in the groove 311. The OIS guide member 820 may be coupled to the groove 311. The OIS guide member 820 may be coupled to the groove 311 through insert injection. The OIS guide member 820 may be fixed to the groove 311. The groove 311 may be formed on an upper surface of the OIS carrier 310.

The OIS carrier 310 may comprise a lateral stopper. The lateral stopper may limit the stroke of the OIS carrier 310 in a lateral direction. That is, when the OIS carrier 310 moves to the maximum, the lateral stopper of the OIS carrier 310 may be in contact with one or more of the AF carrier 210 and the base 110. The lateral stopper may be formed on an outer side surface of the OIS carrier 310. The lateral stopper may be protruded outward from a side surface of the OIS carrier 310.

The OIS carrier 310 may comprise a protrusion 312. The protrusion 312 may be coupled with the upper elastic member 830. The protrusion 312 may be a ‘coupling protrusion’. The upper elastic member 830 may comprise a hole into which the protrusion 312 of the OIS carrier 310 is inserted. The protrusion 312 may be formed on an upper surface of the OIS carrier 310.

The OIS carrier 310 may comprise a groove 313. The groove 313 may be a ‘lens adhesive accommodating groove’. The groove 313 may be formed on an inner circumferential surface of the OIS carrier 310. The groove 313 may be concavely formed on an inner circumferential surface of the OIS carrier 310. An adhesive may be injected between the lens and the OIS carrier 310 through the groove 313. An adhesive for bonding the lens and the OIS carrier 310 may be disposed in the groove 313.

The OIS carrier 310 may comprise a groove 314. The groove 314 may be formed on a lower surface of the OIS carrier 310. The groove 314 may be opened outward.

The OIS carrier 310 may comprise a mounting part 315. The mounting part 315 may be a ‘magnet mounting part’. The magnets 510 and 620 may be disposed on the mounting part 315. The mounting part 315 may be formed as a groove, for an example.

The OIS carrier 310 may comprise a lower stopper 316. The lower stopper 316 may be formed on a lower surface of the OIS carrier 310. The lower stopper 316 may be protruded downward from a lower surface of the OIS carrier 310. The lower stopper 316 may limit the downward movement of the OIS carrier 310 by being in contact with the AF carrier 210 or the base 110.

Hereinafter, one among the ‘groove 311’, the ‘groove 313’, and the ‘groove 314’ of the OIS carrier 310 is referred to as a ‘first groove’, the other is referred to as a ‘second groove’, and another one may be referred to as the ‘third groove’.

The lens driving device 10 may comprise a driving part. The driving part may move the moving part against the fixed part 100. The driving part may comprise the AF driving part 400. The driving part may comprise an OIS driving part. The driving part may comprise an OIS-x driving part 500. The driving part may comprise an OIS-y driving part 600. The driving part may comprise a coil and a magnet.

The lens driving device 10 may comprise an AF driving part 400. The AF driving part 400 may move the AF moving part 200 in an optical axis direction. The AF driving part 400 may move the AF carrier 210 in an optical axis direction. The AF driving part 400 may move the AF carrier 210 in an optical axis direction through electromagnetic force. The AF driving part 400 may comprise a coil and a magnet.

In a first embodiment of the present invention, the AF carrier 210 and the OIS carrier 310 can move in an optical axis direction by the interaction between the AF coil 420 and the AF magnet 410. The AF coil 420, the AF carrier 210, and the OIS carrier 310 may move integrally in an optical axis direction.

The lens driving device 10 may comprise an AF magnet 410. The AF driving part 400 may comprise an AF magnet 410. The AF magnet 410 may be an ‘AF magnet’. The AF magnet 410 may be a permanent magnet. The AF magnet 410 may be disposed in the fixed part 100. The AF magnet 410 may be disposed in the base 110. The AF magnet 410 may be disposed in the cover 120. The AF magnet 410 may be disposed in the side plate 122 of the cover 120. The AF magnet 410 may be disposed on an outer side surface of the base 110. The AF magnet 410 may be disposed on an inner side surface of the base 110. The AF magnet 410 may be fixed to the base 110. AF magnet 410 may be coupled to the base 110. The AF magnet 410 may be attached to the base 110 with an adhesive. The AF magnet 410 may be disposed inside the cover 120. The AF magnet 410 may interact with the AF coil 420. The AF magnet 410 may interact with the AF coil 420 electromagnetically. The AF magnet 410 may be disposed at a position corresponding to the AF coil 420. The AF magnet 410 and the AF coil 420 may face each other. The AF magnet 410 may face the AF coil 420. The AF magnet 410 may be overlapped with the AF coil 420 in a direction perpendicular to the optical axis.

The AF magnet 410 may be a 4-pole magnet. The AF magnet 410 may comprise a 4-pole magnetized magnet. The AF magnet 410 may comprise a first magnet part comprising an N pole and an S pole, and a second magnet part comprising an N pole and an S pole. The first magnet part and the second magnet part may be disposed in a vertical direction. The first magnet part and the second magnet part are disposed spaced apart from each other in a vertical direction, and a neutral part may be disposed between the first magnet part and the second magnet part.

The lens driving device 10 may comprise an AF coil 420. The AF driving part 400 may comprise an AF coil 420. The AF coil 420 may interact with the AF magnet 410. The AF coil 420 may face the AF magnet 410. The AF coil 420 and the AF magnet 410 may face each other. The AF coil 420 may be disposed at a position corresponding to the AF magnet 410. The AF coil 420 may be overlapped with the AF magnet 410 in a direction perpendicular to the optical axis. The AF coil 420 may be disposed on an inner substrate 720. The AF coil 420 may be disposed in the AF carrier 210. The AF coil 420 may be disposed in the AF moving part 200.

In a first embodiment of the present invention, the AF coil 420 can move in an optical axis direction. The AF coil 420 may move in an optical axis direction through interaction with the AF magnet 410. The AF coil 420 may move together with the AF moving part 200. The AF coil 420 may move in an optical axis direction together with the AF moving part 200. During the AF driving process, the AF coil 420 may move along with the AF moving part 200 in an optical axis direction. The AF coil 420 may be disposed in the AF moving part 200. The AF coil 420 may be fixed to the AF moving part 200. The AF coil 420 may be coupled to the AF moving part 200.

The lens driving device 10 may comprise an AF sensor 430. The AF driving part 400 may comprise an AF sensor 430. The AF sensor 430 may be a Hall sensor. The AF sensor 430 may be disposed in the inner substrate 720. The AF sensor 430 may detect the AF magnet 410. The AF sensor 430 may detect movement of the AF magnet 410. The movement amount or position of the AF magnet 410 detected by the AF sensor 430 may be used for feedback of auto focus driving.

The AF sensor 430 may be a driver IC. The driver IC may comprise a sensing unit. The sensing unit may comprise a Hall IC. The driver IC may be electrically connected to the AF coil 420. The driver IC may supply current to the AF coil 420.

The AF sensor 430 may be disposed inside the AF coil 420. The AF sensor 430 may be overlapped with a neutral portion of the AF magnet 410 in a direction perpendicular to the optical axis. As a modified embodiment, the AF sensor 430 may be disposed outside the AF coil 420. The AF sensor 430 may be overlapped with the AF coil 420 in an optical axis direction. The AF sensor 430 may be overlapped with the AF coil 420 in a direction perpendicular to the optical axis.

The lens driving device 10 may comprise an AF yoke 440. The AF yoke 440 may be disposed at a position corresponding to the AF magnet 410. An attractive force may act between the AF yoke 440 and the AF magnet 410. The contact between the AF guide ball 810 and the base 110 and the AF carrier 210 can be maintained as it is by the attractive force between the AF yoke 440 and the AF magnet 410. The AF yoke 440 may be disposed in the inner substrate 720. The AF yoke 440 may be disposed inside the AF coil 420.

The lens driving device 10 may comprise an OIS driving part. The OIS driving part may move the OIS moving part 300 in a direction perpendicular to the optical axis direction. The OIS driving part may move the OIS carrier 310 in a direction perpendicular to the optical axis. The OIS driving part may move the OIS carrier 310 in a direction perpendicular to the optical axis through electromagnetic force.

The lens driving device 10 may comprise an OIS-x driving part 500. The OIS driving part may comprise an OIS-x driving part 500. The OIS-x driving part 500 may move the OIS carrier 310 in an x-axis direction perpendicular to the optical axis. The OIS-x driving part 500 may move the OIS carrier 310 in an x-axis direction perpendicular to the optical axis through electromagnetic force. The OIS-x driving part 500 may comprise a coil and a magnet.

In a first embodiment of the present invention, the OIS-x magnet 510 and the OIS-x coil 520 may move the OIS moving part 300 in a first direction perpendicular to the optical axis direction. At this time, the first direction may be an x-axis direction. Due to the interaction between the OIS-x coil 520 and the OIS-x magnet 510, the OIS carrier 310 can move in an x-axis direction perpendicular to the optical axis direction. The OIS-x magnet 510 and the OIS carrier 310 may integrally move in an x-axis direction.

The lens driving device 10 may comprise an OIS-x magnet 510. The OIS driving part may comprise an OIS-x magnet 510. The OIS-x magnet 510 may be ‘OIS-x magnet’. The OIS-x magnet 510 may be a permanent magnet. The OIS-x magnet 510 may be disposed in the OIS moving part 300. The OIS-x magnet 510 may be spaced apart from the AF magnet 410. The OIS-x magnet 510 may be disposed in the OIS carrier 310. The OIS-x magnet 510 may be disposed on an outer side surface of the OIS carrier 310. The OIS-x magnet 510 may be fixed to the OIS carrier 310. The OIS-x magnet 510 may be coupled to the OIS carrier 310. The OIS-x magnet 510 may be attached to the OIS carrier 310 with an adhesive. The OIS-x magnet 510 may be disposed inside the cover 120. The OIS-x magnet 510 may interact with the OIS-x coil 520. The OIS-x magnet 510 may interact electromagnetically with the OIS-x coil 520. The OIS-x magnet 510 may be disposed at a position corresponding to the OIS-x coil 520. The OIS-x magnet 510 and the OIS-x coil 520 may face each other. The OIS-x magnet 510 may face the OIS-x coil 520. The OIS-x magnet 510 may be overlapped with the OIS-x coil 520 in a direction perpendicular to the optical axis. The OIS-x magnet 510 may be overlapped with the OIS-x coil 520 in an x-axis direction. The OIS-x magnet 510 can move in an x-axis direction perpendicular to the optical axis.

The OIS-x magnet 510 may be a two-pole magnet. The OIS-x magnet 510 may comprise a two-pole magnetized magnet. The OIS-x magnet 510 may comprise an N pole and an S pole.

The lens driving device 10 may comprise an OIS-x coil 520. The OIS driving part may comprise an OIS-x coil 520. The OIS-x coil 520 may interact with the OIS-x magnet 510. The OIS-x coil 520 may move the OIS-x magnet 510 in an x-axis direction perpendicular to the optical axis. The OIS-x coil 520 may move the OIS-x magnet 510 in an x-axis direction through interaction with the OIS-x magnet 510. The OIS-x coil 520 may face the OIS-x magnet 510. The OIS-x coil 520 and the OIS-x magnet 510 may face each other. The OIS-x coil 520 may be disposed at a position corresponding to the OIS-x magnet 510. The OIS-x coil 520 may be overlapped with the OIS-x magnet 510 in a direction perpendicular to the optical axis. The OIS-x coil 520 may be disposed in the inner substrate 720. The OIS-x coil 520 may be disposed in the AF carrier 210.

In a first embodiment of the present invention, the OIS-x coil 520 may move together with the AF moving part 200. The OIS-x coil 520 may move in an optical axis direction together with the AF moving part 200. During the AF driving process, the OIS-x coil 520 may move along with the AF moving part 200 in an optical axis direction. The OIS-x coil 520 may be disposed in the AF moving part 200. The OIS-x coil 520 may be fixed to the AF moving part 200. The OIS-x coil 520 may be coupled to the AF moving part 200.

The lens driving device 10 may comprise an OIS-x sensor 530. The OIS driving part may comprise an OIS-x sensor 530. The OIS-x sensor 530 may be disposed in the inner substrate 720. The OIS-x sensor 530 may comprise a Hall sensor. The OIS-x sensor 530 may detect the OIS-x magnet 510. The OIS-x sensor 530 may detect the magnetic force of the OIS-x magnet 510. The OIS-x sensor 530 may be disposed above the OIS-x magnet 520. The OIS-x sensor 530 may be overlapped with the OIS-x magnet 520 in an optical axis direction. In a modified embodiment, the OIS-x sensor 530 may be disposed inside the OIS-x coil 520. The OIS-x sensor 530 may be overlapped with the OIS-x coil 520 in an optical axis direction. The OIS-x sensor 530 may be overlapped with the OIS-x coil 520 in a direction perpendicular to the optical axis. The OIS-x sensor 530 may face the OIS-x magnet 510. The OIS-x sensor 530 may be disposed at a position corresponding to the OIS-x magnet 510. The OIS-x sensor 530 may detect the movement of the OIS-x magnet 510. The movement amount or position of the OIS-x magnet 510 detected by the OIS-x sensor 530 may be used for feedback of hand shake correction driving in an x-axis direction.

The lens driving device 10 may comprise an OIS-x yoke 540. The OIS-x yoke 540 may be disposed in the OIS-x magnet 510. The OIS-x yoke 540 may be disposed between the OIS-x magnet 510 and the OIS carrier 310. The OIS-x yoke 540 may enhance the interaction force with the OIS-x coil 520 by preventing magnetic flux leakage of the OIS-x magnet 510.

The lens driving device 10 may comprise an OIS-y driving part 600. The OIS driving part may comprise an OIS-y driving part 600. The OIS-y driving part 600 may move the OIS carrier 310 in a y-axis direction perpendicular to both the optical axis and the x-axis direction. The OIS-y driving part 600 may move the OIS carrier 310 in a y-axis direction perpendicular to both the optical axis and the x-axis direction through electromagnetic force. The OIS-y driving part 600 may comprise a coil and a magnet.

In a first embodiment of the present invention, the OIS-y magnet 610 and the OIS-y coil 620 may move the OIS moving part 300 in a second direction perpendicular to the optical axis direction and the first direction. At this time, the second direction may be a y-axis direction. Due to the interaction between the OIS-y coil 620 and the OIS-y magnet 610, the OIS carrier 310 can move in a y-axis direction perpendicular to both the optical-axis direction and the x-axis direction. The OIS-y magnet 610 and the OIS carrier 310 may move integrally in a y-axis direction. The OIS-y magnet 610 may be overlapped with the AF magnet 410 in a second direction. The OIS-y magnet 610 may be overlapped with the AF magnet 410 in a y-axis direction.

The lens driving device 10 may comprise an OIS-y magnet 610. The OIS-y driving part 600 may comprise an OIS-y magnet 610. The OIS-y magnet 610 may be ‘OIS-y magnet’. The OIS-y magnet 610 may be a permanent magnet. The OIS-y magnet 520 may be disposed in the OIS moving part 300. The OIS-y magnet 610 may be spaced apart from the OIS-x magnet 510. The OIS-y magnet 610 may be spaced apart from the AF magnet 410. The OIS-y magnet 610 may be disposed in the OIS carrier 310. The OIS-y magnet 610 may be disposed on an outer side surface of the OIS carrier 310. The OIS-y magnet 610 may be fixed to the OIS carrier 310. The OIS-y magnet 610 may be coupled to the OIS carrier 310. The OIS-y magnet 610 may be attached to the OIS carrier 310 with an adhesive. The OIS-y magnet 610 may be disposed inside the cover 120. The OIS-y magnet 610 may interact with the OIS-y coil 620. The OIS-y magnet 610 may interact electromagnetically with the OIS-y coil 620. The OIS-y magnet 610 may be disposed at a position corresponding to the OIS-y coil 620. The OIS-y magnet 610 and the OIS-y coil 620 may face each other. The OIS-y magnet 610 may face the OIS-y coil 620. The OIS-y magnet 610 may be overlapped with the OIS-y coil 620 in a direction perpendicular to the optical axis. The OIS-y magnet 610 may be overlapped with the OIS-y coil 620 in a y-axis direction. The OIS-y magnet 610 may move in a y-axis direction.

The OIS-y magnet 610 may be a two-pole magnet. The OIS-y magnet 610 may comprise a two-pole magnetized magnet. The OIS-y magnet 610 may comprise an N pole and an S pole.

The lens driving device 10 may comprise an OIS-y coil 620. The OIS-y driving part 600 may comprise an OIS-y coil 620. The OIS-y coil 620 may interact with the OIS-y magnet 610. The OIS-y coil 620 may be disposed at an opposite side of the AF coil 420 with respect to the optical axis. The OIS-y coil 620 may move the OIS-y magnet 610 in a y-axis direction perpendicular to both the optical axis and the x-axis. The OIS-y coil 620 may move the OIS-y magnet 610 in a y-axis direction through interaction with the OIS-y magnet 610. The OIS-y coil 620 may face the OIS-y magnet 610. The OIS-y coil 620 and the OIS-y magnet 610 may face each other. The OIS-y coil 620 may be disposed at a position corresponding to the OIS-y magnet 610. The OIS-y coil 620 may be overlapped with the OIS-y magnet 610 in a direction perpendicular to the optical axis. The OIS-y coil 620 may be disposed in the inner substrate 720. The OIS-y coil 620 may be disposed in the AF carrier 200.

In a first embodiment of the present invention, the OIS-y coil 620 may move together with the AF moving part 200. The OIS-y coil 620 may move in an optical axis direction together with the AF moving part 200. During the AF driving process, the OIS-y coil 620 may move along with the AF moving part 200 in an optical axis direction. The OIS-y coil 620 may be disposed in the AF moving part 200. The OIS-y coil 620 may be fixed to the AF moving part 200. The OIS-y coil 620 may be coupled to the AF moving part 200.

The lens driving device 10 may comprise an OIS-y sensor 630. The OIS-y driving part 600 may comprise an OIS-y sensor 630. The OIS-y sensor 630 may be disposed in the inner substrate 720. The OIS-y sensor 630 may comprise a Hall sensor. The OIS-y sensor 630 may detect the OIS-y magnet 610. The OIS-y sensor 630 may detect the magnetic force of the OIS-y magnet 610. The OIS-y sensor 630 may be disposed above the OIS-y magnet 620. The OIS-y sensor 630 may be overlapped with the OIS-y magnet 620 in an optical axis direction. The OIS-y sensor 630 may be overlapped with the OIS-y magnet 620 in a direction perpendicular to the optical axis. In a modified embodiment, the OIS-y sensor 630 may be disposed inside the OIS-y coil 620. The OIS-y sensor 630 may be overlapped with the OIS-y coil 620 in an optical axis direction. The OIS-y sensor 630 may face the OIS-y magnet 610. The OIS-y sensor 630 may be disposed at a position corresponding to the OIS-y magnet 610. The OIS-y sensor 630 may detect the movement of the OIS-y magnet 610. The movement amount or position of the OIS-y magnet 610 detected by the OIS-y sensor 630 may be used for feedback of hand shake correction driving in a y-axis direction.

The lens driving device 10 may comprise an OIS-y yoke 640. The OIS-y yoke 640 may be disposed in the OIS-y magnet 610. The OIS-y yoke 640 may be disposed between the OIS-y magnet 610 and the OIS carrier 310. The OIS-y yoke 640 may prevent magnetic flux leakage of the OIS-y magnet 610 to enhance interaction force with the OIS-y coil 620.

When viewed from above, the AF magnet 410, the AF coil 420, the OIS-y magnet 610, and the OIS-y coil 620 may be sequentially disposed on an imaginary straight line. When viewed from an upper surface, the AF magnet 410, the AF coil 420, the OIS-y magnet 610, and the OIS-y coil 620 may be sequentially disposed on an imaginary straight line. When viewed from above, the AF magnet 410, the AF coil 420, the OIS-y magnet 610, and the OIS-y coil 620 may be disposed in order. When viewed from above, the AF magnet 410, the AF coil 420, the OIS-y magnet 610, and the OIS-y coil 620 may be sequentially disposed in a y-axis direction. When viewed from above, the AF magnet 410, the AF coil 420, the OIS-y magnet 610, and the OIS-y coil 620 may be overlapped in a y-axis direction.

The lens driving device 10 may comprise substrates 710 and 720. The substrates 710 and 720 may comprise a flexible printed circuit board (FPCB). The substrates 710 and 720 may be electrically connected to the coils 420, 520, and 620. The substrates 710 and 720 may be electrically connected to the sensors 430, 530, and 630.

The lens driving device 10 may comprise an outer substrate 710. An outer substrate 710 may be disposed in the base 110. The outer substrate 710 may be electrically connected to the coils 420, 520, and 620. The outer substrate 710 may be electrically connected to the sensors 430, 530, and 630. The outer substrate 710 may connect the AF carrier 210 and the base 110. The outer substrate 710 may elastically connect the AF carrier 210 and the base 110. The outer substrate 710 may connect the fixed part 100 and the inner substrate 720. The outer substrate 710 may movably support the AF carrier 210 against the base 110. The outer substrate 710 may guide the AF carrier 210 to move in an optical axis direction against the base 110. The outer substrate 710 may comprise a flexible substrate. The outer substrate 710 may comprise a flexible printed circuit board (FPCB). The outer substrate 710 may comprise an elastic portion. The outer substrate 710 may comprise an elastic member. The outer substrate 710 may comprise an outer side portion 711 being disposed in the fixed part 100 and a connection part 712 being extended from the outer side portion 711 and coupled to the inner substrate 720.

The outer substrate 710 may comprise an outer side portion 711. The outer side portion 711 may be disposed in the base 110. The outer side portion 711 may be formed to surround the side surface of the base 110. The outer side portion 711 may be disposed on three side surfaces of the base 110. The outer side portion 711 may comprise two terminal units. The two terminal units may be disposed opposite to each other with respect to the optical axis. The terminal unit may comprise a terminal 711-1.

The outer substrate 710 may comprise a terminal 711-1. The outer side portion 711 of the outer substrate 710 may comprise a terminal 711-1. The terminal 711-1 may be electrically connected to the terminal 712-1. The terminal 711-1 may be disposed in a lower end portion of the base 110. The terminal 711-1 may be coupled to the printed circuit board 50. The terminal 711-1 may be coupled to a terminal of the printed circuit board 50 through soldering. The terminal 711-1 may be coupled to a terminal of the printed circuit board 50 through a conductive member. The terminal 711-1 may be connected to a terminal of the printed circuit board 50. The terminal 711-1 may be electrically connected to a terminal of the printed circuit board 50.

The outer substrate 710 may comprise a connection part 712. The connection part 712 may be an ‘extension part’. The connection part 712 may be a ‘leg part’. The connection part 712 may be extended from the outer side portion 711. At least a portion of the connection part 712 may move along with the AF carrier 210. The extension part may be extended from the outer side portion 711. At least a portion of the extension part may move together with the AF carrier 210. At least a portion of the connection part 712 may be disposed perpendicular to the optical axis direction. The connection part 712 of the outer substrate 710 may be coupled with the inner substrate 720 so that the inner substrate 720 can move in an optical axis direction. At least a portion of the connection part 712 may be disposed parallel to an optical axis direction.

The connection part 712 may comprise a plurality of connection parts. The connection part 712 may comprise a first connection part and a second connection part. The second connection part may be disposed under the first connection part.

The outer substrate 710 may comprise a terminal 712-1. The connection part 712 of the outer substrate 710 may comprise a terminal 712-1. The terminal 712-1 may be coupled with the terminal 721-1 of the inner substrate 720. The terminal 712-1 of the outer substrate 710 may be coupled to the terminal 721-1 of the inner substrate 720 through soldering. The terminal 712-1 of the outer substrate 710 may be coupled to the terminal 721-1 of the inner substrate 720 through a conductive member. The terminal 712-1 of the outer substrate 710 may be connected to the terminal 721-1 of the inner substrate 720. The terminal 712-1 of the outer substrate 710 may be electrically connected to the terminal 721-1 of the inner substrate 720.

The outer substrate 710 may comprise a bent part 712-2. The bent part 712-2 may be formed in the connection part 712. The bent part 712-2 may be formed in each of the first connection part and the second connection part. The bent part 712-2 may comprise a shape bent at least twice. The bent part 712-2 may comprise a shape bent in a U shape. The bent part 712-2 may have a rounded shape. The bent part 712-2 may comprise a part disposed parallel to an optical axis.

Hereinafter, one of the ‘terminal 711-1’ and the ‘terminal 712-1’ of the outer substrate 710 may be referred to as a ‘first terminal’, and the other may be referred to as a ‘second terminal’.

The lens driving device 10 may comprise an inner substrate 720. The inner substrate 720 may be electrically connected to the coils 420, 520, and 620. The inner substrate 720 may be electrically connected to the sensors 430, 530, and 630. The inner substrate 720 may be disposed in the AF moving part 200. The inner substrate 720 may be disposed in the AF carrier 210. The inner substrate 720 may be fixed to the AF carrier 210. The inner substrate 720 may be coupled to the AF carrier 210. The inner substrate 720 may be attached to the AF carrier 210 with an adhesive. The inner substrate 720 may comprise a flexible substrate. The inner substrate 720 may comprise a flexible printed circuit board (FPCB). The inner substrate 720 may comprise an elastic portion. The inner substrate 720 may comprise an elastic member.

The inner substrate 720 may comprise a side plate portion 721. The side plate portion 721 may be disposed on a side surface of the AF carrier 210. The side plate portion 721 may be disposed on an outer side surface of the AF carrier 210. In another embodiment, the side plate portion 721 may be disposed on an inner surface of the AF carrier 210. The side plate portion 721 of the inner substrate 720 may comprise a plurality of portions. The side plate portion 721 may comprise first to fourth portions.

The inner substrate 720 may comprise a first portion. The first portion may be disposed in the AF carrier 210. The AF coil 420 may be disposed in a first portion of the inner substrate 720. The AF sensor 430 may be disposed in a first portion of the inner substrate 720. The AF yoke 440 may be disposed on a first portion of the inner substrate 720.

The inner substrate 720 may comprise a second portion. The second portion can be placed at an opposite side of the first portion. The second portion may be disposed in the AF carrier 200. The second portion may be disposed on a second side surface of the AF carrier 200. The OIS-y coil 620 may be disposed in a second portion of the inner substrate 720. The OIS-y sensor 630 may be disposed in a second portion of the inner substrate 720. More specifically, the OIS-y sensor 630 may be disposed in the upper plate portion 722 which is bent and disposed above a second portion of the inner substrate 720. The OIS-y sensor 630 may be disposed on a lower surface of the upper plate portion 722.

The inner substrate 720 may comprise a third portion. A third portion may be disposed in the AF carrier 200. The third portion may be disposed on a third side surface of the AF carrier 200. The OIS-x coil 520 may be disposed in a third portion of the inner substrate 720. The OIS-x sensor 530 may be disposed in a third portion of the inner substrate 720. In more detail, the OIS-x sensor 530 may be disposed in the upper plate portion 722 bent from an upper side of the third portion of the inner substrate 720. The OIS-x sensor 530 may be disposed on a lower surface of the upper plate portion 722.

The inner substrate 720 may comprise a fourth portion. The fourth portion may be disposed at an opposite side of the third portion. The fourth portion may be disposed in the AF carrier 200. The fourth portion may be disposed on a fourth side surface of the AF carrier 200.

The inner substrate 720 may comprise a terminal 721-1. The terminal 721-1 may be disposed in the fourth portion of the inner substrate 720. The terminal 721-1 may be electrically connected to the coils 420, 520, and 620. The terminal 721-1 may be electrically connected to the sensors 430, 530, and 630.

The lens driving device 10 may comprise a guide member. The guide member may comprise a ball. The guide member may comprise a pin. The guide member may comprise a cylindrical member. The guide member may guide the movement of the moving part against the fixed part 100 in a specific direction.

The lens driving device 10 may comprise an AF guide ball 810. The AF guide ball 810 may guide the movement of the AF moving part 200 against the fixed part 100 in an optical axis direction. The AF guide ball 810 may guide the movement of the AF carrier 210 against the base 110 in an optical axis direction. The AF guide ball 810 may be disposed between the fixed part 100 and the AF moving part 200. The AF guide ball 810 may be disposed between the base 110 and the AF carrier 210. The AF guide ball 810 may be disposed between the base 110 and the AF carrier 210 in an x direction. Or, the AF guide ball 810 may be disposed between the base 110 and the AF carrier 210 in a y direction. The AF guide ball 810 may be disposed in a groove of the base 110. The AF guide ball 810 may be disposed in a groove of the AF carrier 210. The AF guide ball 810 may have a spherical shape. The AF guide ball 810 may be formed of metal. Grease may be applied to the surface of the AF guide ball 810.

The AF guide ball 810 may be disposed at a first corner of the base 110. The AF guide ball 810 may be disposed at a second corner in a diagonal direction of the first corner of the base 110. The AF guide ball 810 may be disposed at each of the first corner and the second corner of the base 110. The first corner region and the second corner region of the fixed part 100 may be disposed in diagonal directions with respect to an optical axis. The AF guide balls 810 may be disposed in the first corner region and the second corner region of the fixed part 100. Two sets of AF guide balls 810 may be disposed at each of the first corner and the second corner of the base 110. At this time, one set may comprise 4 balls. The two sets may be disposed at an opposite side of the pillar part of the AF carrier 210 from each other.

When viewed from above, the AF guide ball 810 may comprise: a first unit ball being disposed in a first corner region of the fixed part 100; and a second unit ball being disposed in a second corner region disposed in a diagonal direction of the first corner region of the fixed part 100. At this time, when viewed from above, the OIS guide member 820 may comprise: a first guide member being spaced apart from each other and disposed between the first unit ball and the second unit ball of the AF guide ball 810 in a diagonal direction; and a second guide member.

When viewed from above, the AF guide ball 810 may comprise: a first unit ball and a second unit ball being disposed in a first corner region of the fixed part 100; and a third unit ball and a fourth unit ball being disposed in a second corner region being disposed in a diagonal direction of the first corner region of the fixed part 100. The AF guide ball 810 may be disposed in two sets at one corner.

The AF guide ball 810 may comprise a ball being overlapped with the OIS guide member 820 in a direction perpendicular to the optical axis direction. At least a portion of the AF guide ball 810 may be overlapped with the OIS guide member 820.

The AF guide ball 810 may comprise an inner ball 811. The inner ball 811 may be disposed in the pillar part 111 of the base 110. The inner ball 811 may be disposed in the inner groove 111-1 of the base 110. The inner ball 811 may be disposed in the inner groove 224-1 of the AF carrier 210. The inner ball 811 may be disposed in the inner groove 224-1 of the AF moving part 200. The inner ball 811 may be disposed in the inner groove 111-1 of the base 110 and the inner groove 224-1 of the AF carrier 210. The inner ball 811 may be disposed between the inner groove 111-1 of the base 110 and the inner groove 224-1 of the AF carrier 210. The inner ball 811 may be disposed between the AF moving part 200 and the pillar part 111 of the fixed part 100.

The AF guide ball 810 may comprise an outer ball 812. The outer ball 812 may be disposed in the outer wall part 112 of the base 110. The outer ball 812 may be disposed in the outer groove 112-1 of the base 110. The outer ball 812 may be disposed in the outer groove 224-2 of the AF carrier 210. The outer ball 812 may be disposed in the outer groove 112-1 of the base 110 and the outer groove 224-2 of the AF carrier 210. The outer ball 812 may be disposed between the outer groove 112-1 of the base 110 and the outer groove 224-2 of the AF carrier 210. The outer ball 812 may be disposed between the outer groove 112-1 of the fixed part 100 and the outer groove 224-2 of the AF moving part 200. The outer ball 812 may be disposed between the AF moving part 200 and the outer wall part 112 of the fixed part 100.

The inner ball 811 may comprise a plurality of inner balls 811. The plurality of inner balls 811 may be disposed in an optical axis direction. The inner ball 811 may comprise four inner balls 811. The inner ball 811 may comprise first to fourth inner balls. Two of the four inner balls 811 may have a large diameter and the other two may have a small diameter. Two balls with a large diameter can be disposed at an uppermost place and at a lowermost place. That is, two balls with a small diameter may be disposed between the two balls with a large diameter.

The inner ball 811 may comprise an uppermost inner ball 811-1. The uppermost inner ball 811-1 may be disposed at a highest point among the inner balls 811. The uppermost inner ball 811-1 may be disposed closest to the upper plate 121 of the cover 120 among the inner balls 811. The inner ball 811 may comprise a lowermost inner ball 811-2. The lowermost inner ball 811-2 may be disposed at a lowest point among the inner balls 811. The lowermost inner ball 811-2 may be disposed closest to the lower plate portion of the base 110 among the inner balls 811. The plurality of inner balls 811 may comprise balls having a smaller diameter than each of the uppermost inner ball 811-1 and the lowermost inner ball 811-2. The plurality of inner balls 811 may comprise balls being disposed between the uppermost inner ball 811-1 and the lowermost inner ball 811-2.

The outer ball 812 may comprise a plurality of outer balls 812. The plurality of outer balls 812 may be disposed in an optical axis direction. The outer ball 812 may comprise four outer balls 812. The outer ball 812 may comprise first to fourth outer balls. Two of the four outer balls 812 may have a large diameter and the other two may have a small diameter. Two balls with a large diameter can be disposed at an uppermost place and at a lowermost place. That is, two balls with a small diameter may be disposed between the two balls with a large diameter.

The outer ball 812 may comprise an uppermost outer ball 812-1. The uppermost outer ball 812-1 may be disposed at a highest point among the outer balls 812. The uppermost outer ball 812-1 may be disposed closest to the upper plate 121 of the cover 120 among the outer balls 812. The outer ball 812 may comprise a lowermost outer ball 812-2. The lowermost outer ball 812-2 may be disposed at a lowest point among the outer balls 812. The lowermost outer ball 812-2 may be disposed closest to a lower plate portion of the base 110 among the outer balls 812. The plurality of outer balls 812 may comprise balls having a smaller diameter than each of the uppermost outer ball 812-1 and the lowermost outer ball 812-2. The plurality of outer balls 812 may comprise balls being disposed between the uppermost outer ball 812-1 and the lowermost outer ball 812-2.

The AF guide ball 810 may comprise a plurality of balls being disposed in an optical axis direction. At this time, the plurality of balls may comprise uppermost balls 811-1 and 812-1 being disposed at a highest point and lowermost balls 811-2 and 812-2 being disposed at a lowest point. The height of the point where the elastic member 920 presses the plate member 910 may be disposed between the heights of the uppermost balls 811-1 and 812-1 and the heights of the lowermost balls 811-2 and 812-2.

The lens driving device 10 may comprise an OIS guide member 820. The OIS guide member 820 may be a guide member. The OIS guide member 820 may be a guide unit. The OIS guide member 820 may be a guide plate. The OIS guide member 820 may be a guide plate. The OIS guide member 820 may be a guide structure.

The OIS guide member 820 may guide the movement of the OIS carrier 310 against the AF carrier 210 in a direction perpendicular to the optical axis. The OIS guide member 820 may be disposed between the AF moving part 200 and the OIS moving part 300. The OIS guide member 820 may be disposed between the AF carrier 210 and the OIS carrier 310. The OIS guide member 820 may be disposed between the AF carrier 210 and the OIS carrier 310 in an optical axis direction.

The OIS guide member 820 may be disposed between the pre-pressurizing member 230 of the AF carrier 210 and the OIS carrier 310. The OIS guide member 820 may be pressed between the AF carrier 210 and the OIS carrier 310 by the pressing force of the elastic members 830, 840, and 850. The pre-pressurizing member 230 may press the OIS guide member 820 downward while being coupled to the holder member 220. The pre-pressurizing member 230 may press the OIS guide member 820 in a direction of the OIS carrier 310 while being coupled to the holder member 220. At this time, the OIS carrier 310 may press the OIS guide member 820 in a direction of the pre-pressurizing member 230 by the restoring force of the elastic members 830, 840, and 850. Accordingly, the OIS guide member 820 may be pressed between the pre-pressurizing member 230 and the OIS carrier 310.

The OIS guide member 820 may guide the movement of the OIS moving part 300 in an x-axis direction and a y-axis direction. The OIS guide member 820 may guide the OIS carrier 310 to move in an x-axis direction and a y-axis direction perpendicular to an optical axis direction against the AF carrier 210. That is, the OIS guide member 820 may guide the OIS carrier 310 to move in an x-axis direction and a y-axis direction. In other words, the OIS guide member 820 may guide the movement in both the x-axis direction and the y-axis direction. For reference, compared to the comparative example in which the ball for guiding the x-axis direction and the ball for guiding the y-axis direction are separately provided, the size of the lens driving device 10 can be minimized in a first embodiment of the present invention in which a structure for guiding the x-axis direction and a structure for guiding the y-axis direction are integrally provided. In particular, the height of the lens driving device 10 in an optical axis direction can be reduced. Through this, the height being protruded from the smartphone, that is, the shoulder height can be minimized. The OIS guide member 820 may comprise a plurality of guide members. The OIS guide member 820 may comprise four guide members.

As a modified embodiment, the OIS guide member 820 may separately comprise a guide member for guiding the driving in an x-axis direction and a guide member for guiding the driving in a y-axis direction.

In a first embodiment of the present invention, the OIS guide member 820 may guide both the movement of the OIS moving part 300 in an x-axis direction and a y-axis direction. However, in a modified embodiment, the OIS guide member 820 may comprise a first member for guiding the movement of the OIS moving part 300 in an x-axis direction and a second member for guiding the movement of the OIS moving part 300 in a y-axis direction. At this time, the first member and the second member may be spaced apart. In a modified embodiment, the OIS moving part 300 may comprise an OIS-x moving part and an OIS-y moving part being disposed inside the OIS-x moving part. The first member may be disposed between the AF moving part 200 and the OIS-x moving part. The second member may be disposed between the OIS-x moving part and the OIS-y moving part. Each of the first member and the second member may comprise a protruding part 822.

The OIS guide member 820 may be disposed between the AF moving part 200 and the OIS moving part 300. The OIS guide member 820 may be formed of a metal member. The OIS guide member 820 may be made of metal. The OIS guide member 820 may be formed of the same material as the plate member 825. The OIS guide member 820 may be made of the same material as the plate member 825. The OIS guide member 820 may be formed of the same material as the plate member 825. The OIS guide member 820 may have a point contact structure. The OIS guide member 820 may be in contact with the AF moving part 200 at one point. The OIS guide member 820 may be formed of brass. The OIS guide member 820 may be formed of phosphor bronze. The OIS guide member 820 may be formed of a copper material. The OIS guide member 820 may be formed of a material different from that of the cover 120.

The OIS guide member 820 may comprise a plate portion 821. The plate portion 821 may be disposed in the OIS moving part 300. The plate portion 821 may be disposed in the OIS moving part 300 through insert injection. The plate portion 821 may be integrally formed with the OIS moving part 300.

The OIS guide member 820 may comprise a protruding part 822. The protruding part 822 may be fixed to the OIS moving part 300. The protruding part 822 may come into contact with the AF moving part 200. The protruding part 822 may be in contact with the AF moving part 200 at one point.

The OIS guide member 820 may comprise a plurality of OIS guide members. The OIS guide member 820 may comprise four OIS guide members. The OIS guide member 820 may comprise first to fourth OIS guide members. The four OIS guide members may be spaced apart from each other. Each of the four OIS guide members may comprise a protruding part 822. Each of the protruding parts 822 of the four OIS guide members may be in contact with the AF moving part 200 at one point. Accordingly, the four OIS guide members may be in contact with the AF moving part 200 at four points. That is, the OIS guide member 820 and the AF moving part 200 may be in contact with as many points as the number of OIS guide members. Furthermore, a contact point between the protruding part 822 of the OIS guide member 820 and the AF moving part 200 may be recognized as a surface when magnified. That is, the protruding part 822 of the OIS guide member 820 may be in contact with the AF moving part 200 at one area.

The protruding part 822 may be formed by bending a metal plate. The protruding part 822 may be integrally formed with the plate portion 821. The protruding part 822 may be protruded from the plate portion 821 toward the OIS moving part 300. The protruding part 822 may be in contact with the plate member 825. The protruding part 822 may be overlapped with the wire 850 in a direction perpendicular to the optical axis direction. The protruding part 822 may be overlapped with the upper elastic member 850 in a direction perpendicular to the optical axis direction. In a direction perpendicular to the optical axis direction, the AF coil 420 may comprise a portion being disposed between the AF magnet 410 and the protruding part 822 of the OIS guide member 820. Or, when viewed on the cross-sectional view of FIG. 35, the AF coil 420 may comprise a portion being disposed between the AF magnet 410 and the protruding part 822 of and the OIS guide member 820 in a direction perpendicular to the optical axis.

The protruding part 822 may comprise a curved surface. The protruding part 822 may be protruded in a round shape. The protruding part 822 may have a curvature. The protruding part 822 may have a hemispherical shape. As a modified embodiment, the protruding part 822 may comprise a conical shape. In another modified embodiment, the protruding part 822 may comprise a trapezoidal cross-sectional shape. The protruding part 822 may be formed to be convex upward.

The opposite side of the protruding part 822 may have a corresponding groove shape. However, in a modified embodiment, the opposite side of the protruding part 822 may be formed as a plane. That is, the opposite side of the protruding part 822 may be a shape fully filled without being depressed. Or, the opposite side of the protruding part 822 may be a shape partially filled. That is, the thickness of the protruding part 822 may be greater than the thickness of the plate portion 821.

The lens driving device 10 may comprise a plate member 825. The AF moving part 200 may comprise a plate member 825. The plate member 825 may be formed of a metal member. The plate member 825 may be formed of metal. The plate member 825 may be formed in a circular shape. An OIS guide member 820 may be disposed in the plate member 825. A protruding part 822 of the OIS guide member 820 may be disposed in the plate member 825. The plate member 825 may come into contact with the OIS guide member 820. The plate member 825 may come into contact with the protruding part 822 of the OIS guide member 820. The plate member 825 may be disposed in the pre-pressurizing member 230. The plate member 825 may be disposed on the protruding part 231 of the pre-pressurizing member 230. The plate member 825 may be disposed in the groove 232 of the pre-pressurizing member 230.

The plate member 825 may be formed of brass. The plate member 825 may be formed of phosphor bronze. The plate member 825 may be formed of a copper material. The plate member 825 may be formed of a material different from that of the cover 120.

In a modified embodiment, the plate member 825 may be omitted. In this case, the OIS guide member 820 may be directly in contact with the pre-pressurizing member 230. The OIS guide member 820 may be directly in contact with the AF moving part 200.

However, when the plate member 825 is provided, frictional force between the OIS guide members 820 may be minimized compared to a modified embodiment. In addition, when the plate member 825 is provided, flatness management may be advantageous. The plate member 825 may be formed of a member with minimized frictional force.

In a first embodiment of the present invention, the OIS guide member 820 may be disposed in the OIS moving part 300. At this time, the plate member 825 may be disposed in the AF moving part 200. However, in a modified embodiment, the OIS guide member 820 may be disposed in the AF moving part 200. At this time, the plate member 825 may be disposed in the OIS moving part 300. In a modified embodiment, the OIS guide member 820 may comprise a protruding part 822 being fixed to the AF moving part 200 and in contact with the OIS moving part 300. In a modified embodiment, the OIS guide member 820 may comprise a protruding part 822 that is convex downward.

The lens driving device 10 may comprise an elastic member. The elastic member may be formed to support the OIS driving. The elastic member may support the movement of the OIS moving part 300. The elastic member may be formed to press the OIS guide member 820. The elastic member may be formed to guide both the OIS-x-axis driving and the OIS-y-axis driving only with the OIS guide member 820. The elastic member may comprise a leaf spring. The elastic member may comprise a wire. The elastic member may have elasticity. The elastic member may be formed of metal.

The elastic member may press the OIS guide member 820 in a direction of the AF moving part 200. The elastic member may press the OIS moving part 300 in a direction of the AF moving part 200. At this time, the elastic member may comprise an upper elastic member 830, a lower elastic member 840, and a wire 850.

The first support member may be disposed between the fixed part 100 and the AF moving part 200. The first support member may guide the AF moving part 200 to move in an optical axis direction. The second support member may be disposed between the AF moving part 200 and the OIS moving part 300. The second support member may guide the OIS moving part 300 to move in a direction perpendicular to the optical axis direction. One side of the third support member may be coupled to the AF moving part 200 and the other side may be coupled to the OIS moving part 300.

The AF moving part 200 may comprise a first elastic member. The OIS moving part 300 may comprise a second elastic member. The third support member may couple the first elastic member and the second elastic member. The third support member may comprise a wire 850.

The lens driving device 10 may comprise an upper elastic member 830. The upper elastic member 830 may be an ‘upper spring’. The upper elastic member 830 may be a leaf spring. The upper elastic member 830 may have elasticity. The upper elastic member 830 may be disposed in the OIS moving part 300. The upper elastic member 830 may be coupled to the OIS moving part 300. The upper elastic member 830 may be connected to the OIS moving part 300. The upper elastic member 830 may be disposed on an upper surface of the OIS moving part 300. The upper elastic member 830 may be disposed on an upper surface of the OIS carrier 310. The upper elastic member 830 may be disposed in the OIS carrier 310. The upper elastic member 830 may be disposed at an upper portion of the OIS carrier 310. The upper elastic member 830 may be disposed above the OIS carrier 310. The upper elastic member 830 may be disposed perpendicular to the optical axis.

The upper elastic member 830 may comprise an inner side portion 831. The inner side portion 831 may be coupled to the OIS moving part 300. The upper elastic member 830 may comprise an outer side portion 832. The outer side portion 832 may be coupled to the wire 850. The upper elastic member 830 may comprise a connection part 833. The connection part 833 may connect the inner side portion 831 and the outer side portion 832. The connection part 833 may elastically connect the inner side portion 831 and the outer side portion 832. The connection part 833 may comprise elasticity. The connection part 833 may be an elastic part.

An inner side portion 831 of the upper elastic member 830 may be disposed lower than an outer side portion 832. The inner side portion 831 of the upper elastic member 830 may be disposed lower than the outer side portion 832 by a first distance. The reason why the inner side portion 831 of the upper elastic member 830 is lower than the outer side portion 832 may be due to the pressing force of the pre-pressurizing member 230. Through this structure, the OIS guide member 820 can be maintained as it is in contact with the pre-pressurizing member 230 of the AF carrier 210 and the OIS carrier 310.

The lens driving device 10 may comprise a lower elastic member 840. The lower elastic member 840 may be a ‘terminal on a lower surface of the housing’ or a ‘plate on a lower surface of the housing’. The lower elastic member 840 may be a leaf spring. The lower elastic member 840 may have elasticity. The lower elastic member 840 may be disposed in the AF moving part 200. The lower elastic member 840 may be coupled to the AF moving part 200. The lower elastic member 840 may be connected to the AF moving part 200. The lower elastic member 840 may be disposed on a lower surface of the AF moving part 200. The lower elastic member 840 may be disposed on a lower surface of the AF carrier 210. The lower elastic member 840 may be disposed in the AF carrier 210. The lower elastic member 840 may be disposed at a lower portion of the AF carrier 210. The lower elastic member 840 may be disposed below the AF carrier 210. The lower elastic member 840 may be disposed perpendicular to the optical axis.

The lower elastic member 840 may comprise an outer side portion 841. The outer side portion 841 may be coupled with the AF moving part 200. The lower elastic member 840 may comprise an inner side portion 842. The inner side portion 842 may be coupled to the wire 850. The lower elastic member 840 may comprise a connection part 843. The connection part 843 may connect the outer side portion 841 and the inner side portion 842. The connection part 843 may elastically connect the outer side portion 841 and the inner side portion 842. The connection part 843 may comprise elasticity. The connection part 843 may be an elastic part.

The lens driving device 10 may comprise a wire 850. The wire 850 may be a ‘side elastic member’. The wire 850 may be a wire. The wire 850 may be a wire spring. The wire 850 may be a suspension wire. The wire 850 may have elasticity. The wire 850 may connect the upper elastic member 830 and the lower elastic member 840. The wire 850 may elastically connect the upper elastic member 830 and the lower elastic member 840. The wire 850 may be disposed parallel to an optical axis. The wire 850 may be disposed in an optical axis direction.

The height of the point where the elastic member 920 presses the plate member 910 is lower than the height of the ball being disposed lower among the uppermost inner ball 811-1 and the uppermost outer ball 812-1, and may be higher than the height of the ball being disposed higher among the lowermost inner ball 811-1 and the lowermost outer ball 812-2. More specifically, as shown in FIG. 33(a), when the AF moving part 200 moves upward, the height b of the point where the elastic member 920 presses the plate member 910 may be higher than the height a of the ball being disposed higher among the lowermost inner ball 422 and the lowermost outer ball 412. A gap c may exist at a height between the two points. In addition, as shown in FIG. 33(b), when the AF moving part 200 moves downward, the height e of the point where the elastic member 920 presses the plate member 910 may be lower than the height d of the ball being disposed lower among the uppermost inner ball 421 and the uppermost outer ball 411. A gap f may exist at a height between the two points. Through this, generation of a moment generated when the elastic member 920 presses the plate member 910 may be prevented or minimized. That is, a phenomenon in which the plate member 910 is tilted or separated may be prevented.

The lens driving device 10 may comprise a pressing member. The pressing member may be an ‘AF guide ball pressing member’. The pressing member may press the AF guide ball 810. The pressing member may be formed to press a ball. The AF guide ball 810 pressed by the pressing member may be held between the fixed part 100 and the AF moving part 200. The AF guide ball 810 pressed by the pressing member may be held between the base 110 and the AF carrier 210. The pressing member may maintain the AF guide ball 810 as it is in contact with the fixed part 100 and the AF moving part 200. The pressing member may maintain the AF guide ball 810 as it is in contact with the base 110 and the AF carrier 210.

The lens driving device 10 may comprise a plate member 910. The pressing member may comprise a plate member 910. The plate member 910 may be disposed in the AF guide ball 810. The plate member 910 may be in contact with the AF guide ball 810. The plate member 910 may be disposed in the elastic member 920. The plate member 910 may be disposed in the base 110. The plate member 910 may be disposed between the elastic member 920 and the AF guide ball 810. The plate member 910 may press the AF guide ball 810 toward the AF carrier 210 by the elastic member 920. The plate member 910 may be disposed between the AF guide ball 810 and the fixed part 100. The plate member 910 may be disposed between the inner ball 811 and the pillar part 111 of the fixed part 100.

The lens driving device 10 may comprise an elastic member 920. The pressing member may comprise an elastic member 920. The elastic member 920 may be a spring. The elastic member 920 may be a tapered spring. The elastic member 920 may be disposed in the fixed part 100. The elastic member 920 may press the AF guide ball 810 toward the AF moving part 200. The elastic member 920 may press the plate member 910 toward the AF guide ball 810. The elastic member 920 may be disposed between the plate member 910 and the fixed part 100. The elastic member 920 may push the plate member 910 against the fixed part 100. The elastic member 920 may press the plate member 910 in an opposite direction to the fixed part 100. The elastic member 920 may be disposed between the plate member 910 and the pillar part 111 of the fixed part 100. The elastic member 920 may be disposed in the inner groove 111-1 of the fixed part 100.

As a modified embodiment, the elastic member 920 may be disposed in the AF moving part 200. At this time, the elastic member 920 may press the AF guide ball 810 toward the fixed part 100. The elastic member 920 may be disposed in one of the fixed part 100 and the AF moving part 200 to press the AF guide ball 810 toward the other one of the fixed part 100 and the AF moving part 200. The elastic member 920 may press the plate member 910. The elastic member 920 may be disposed between the plate member 910 and the base 110. The elastic member 920 may be disposed between the AF guide ball 810 and the base 110. The elastic member 920 may be disposed in the base 110. The elastic member 920 may be disposed in the inner groove 111-1 of the base 110. The elastic member 920 may press the AF guide ball 810 toward the AF carrier 210. Through this, the AF guide ball 810 can maintain a contact state between the plate member 910 and the AF carrier 210.

The elastic member 920 may comprise a bent part. The bent part may comprise a bent shape. The bent part may comprise a plurality of bent parts. The bent part may comprise three bent parts. The elastic member 920 may be bent at least three times. The elastic member 920 may comprise an upper bent part 921. The elastic member 920 may comprise a lower bent part 922. The elastic member 920 may comprise a connection bent part 923. The connection bent part 923 may be disposed between the upper bent part 921 and the lower bent part 922. The upper bent part 921 may form an obtuse angle. The lower bent part 922 may form an obtuse angle. The connection bent part 923 may form an obtuse angle. The upper bent part 921 may be disposed in the fixed part 100. The lower bent part 922 may be disposed in the fixed part 100. The connection bent part 923 may be disposed in the plate member 910. Through this structure, the elastic member 920 may push the plate member 910 against the fixed part 100. The connection bent part 923 may be in contact with the plate member 910 and press the plate member 910 toward the AF guide ball 810.

The lens driving device 10 may comprise a reinforcing member 930. The reinforcing member 930 may be disposed in the base 110. The reinforcing member 930 may be disposed to reinforce the strength of the base 110. The reinforcing member 930 may prevent damage to the base 110. The reinforcing member 930 can prevent the pillar part 111 of the base 110 from damages. The reinforcing member 930 may prevent the outer wall part 112 of the base 110 from damages. The reinforcing member 930 may have elasticity. The reinforcing member 930 may be formed of metal. The reinforcing member 930 may comprise a shape bent at least twice. The reinforcing member 930 may be formed in the shape of a symbol ‘⊂’ when viewed from above. The reinforcing member 930 may be opened inward.

The reinforcing member 930 may comprise an inner side portion 931. The inner side portion 931 may be disposed at an opposite surface of the inner groove 111-1 of the pillar part 111 of the fixed part 100. The reinforcing member 930 may comprise an outer side portion 932. The outer side portion 932 may be disposed at an opposite surface of the outer groove 112-1 of the outer wall part 112 of the fixed part 100. The reinforcing member 930 may comprise a connection part 933. The connection part 933 may connect the inner side portion 931 and the outer side portion 932.

The lens driving device 10 may comprise a cover 940. The cover 940 may be disposed above the AF guide ball 810. The cover 940 may be overlapped with the AF guide ball 810 in an optical axis direction. The cover 940 may be overlapped with the inner ball 811 in an optical axis direction. The cover 940 may be overlapped with the outer ball 812 in an optical axis direction. The cover 940 may be disposed on the inner groove 224-1 and the outer groove 224-2 of the AF carrier 210 to prevent the AF guide ball 810 from escaping upward.

Hereinafter, auto focus (AF) driving of the lens driving device according to a first embodiment of the present invention will be described with reference to the drawings.

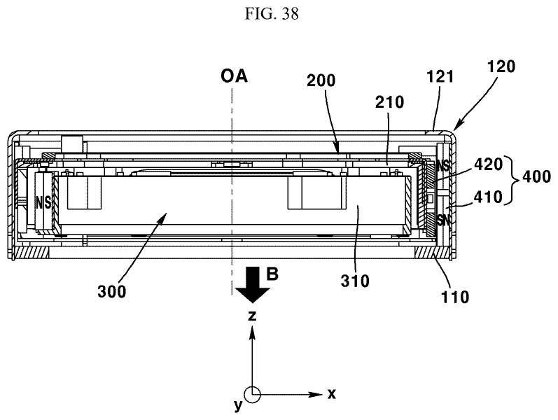

FIGS. 36 to 38 are views for explaining autofocus driving of a lens driving device according to a first embodiment of the present invention. FIG. 36 is a cross-sectional view of a moving part in an initial state in which no current is applied to an AF coil. FIG. 37 is a cross-sectional view illustrating a state in which a moving part moves upward in an optical axis direction when a forward current is applied to an AF coil. FIG. 38 is a cross-sectional view illustrating a moving part moving downward in an optical axis direction when a reverse current is applied to an AF coil.

As illustrated in FIG. 36, the moving part may be disposed at a position spaced apart from both the upper plate 121 of the cover 120 and the base 110 in an initial position where no current is applied to the AF coil 420. At this time, the moving part may be the AF moving part 200. In addition, the moving part may comprise the AF moving part 200 and the OIS moving part 300.

When a forward current is applied to the AF coil 420, the AF coil 420 may move upward in an optical axis direction due to electromagnetic interaction between the AF coil 420 and the AF magnet 410 (see A in FIG. 37). At this time, the AF carrier 210 together with the AF coil 420 may move upward in an optical axis direction. Furthermore, the OIS carrier 310 and the lens together with the AF carrier 210 may move upward in an optical axis direction. Accordingly, the distance between the lens and the image sensor is changed so that the focus of an image formed on the image sensor through the lens can be adjusted.

When a reverse current is applied to the AF coil 420, the AF coil 420 may move downward in an optical axis direction due to electromagnetic interaction between the AF coil 420 and the AF magnet 410 (see B in FIG. 38). At this time, the AF carrier 210 together with the AF coil 420 may move downward in an optical axis direction. Furthermore, the OIS carrier 310 and the lens together with the AF carrier 210 may move downward in an optical axis direction. Accordingly, the distance between the lens and the image sensor is changed so that the focus of an image formed on the image sensor through the lens can be adjusted.

Meanwhile, during the movement of the AF coil 420, the AF sensor 430 moves together with the AF coil 420 and detects the strength of the magnetic field of the AF magnet 410 to detect the amount or position of the lens in an optical axis direction. The movement amount or position of the lens in an optical axis direction detected by the AF sensor 430 may be used for autofocus feedback control.

Hereinafter, optical image stabilization (OIS) operation of the lens driving device according to a first embodiment of the present invention will be described with reference to drawings.

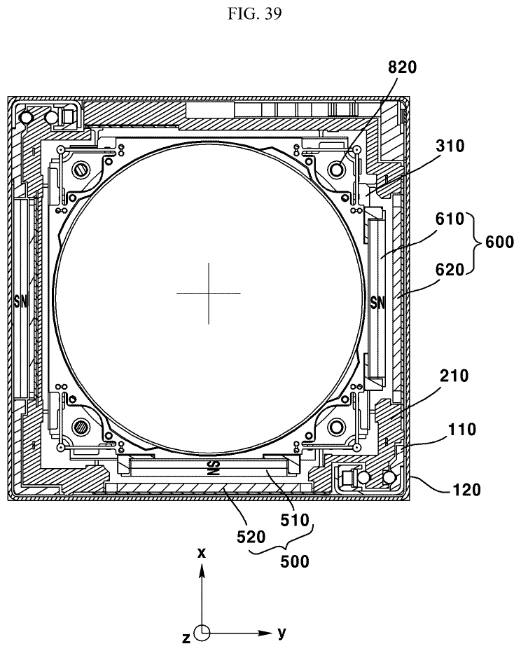

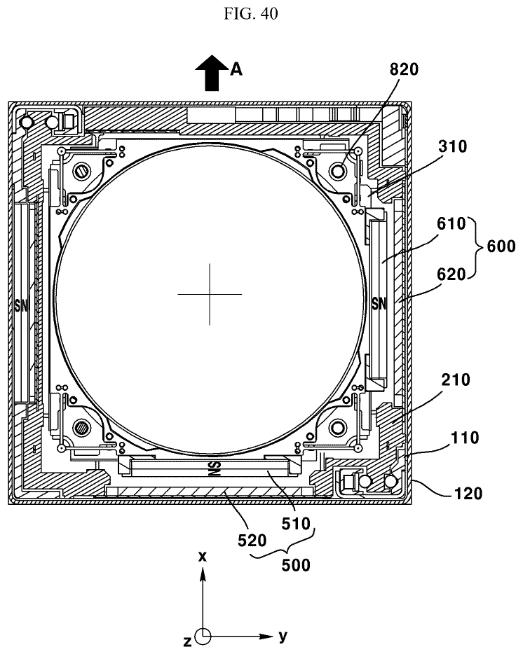

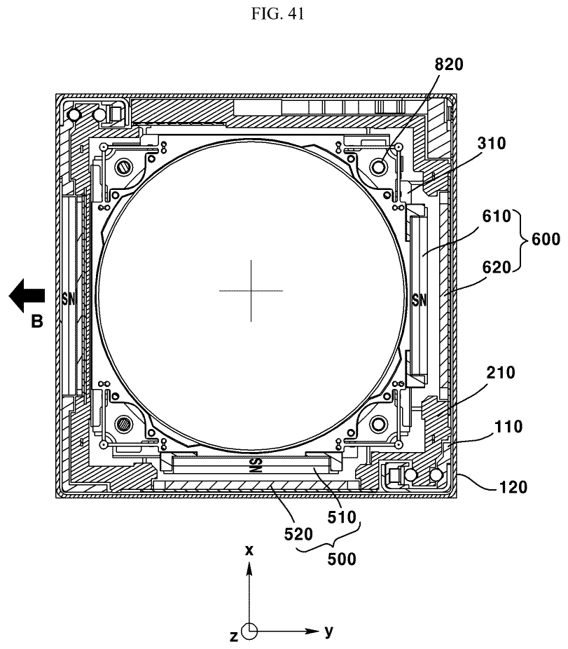

FIGS. 39 to 41 are views for explaining hand shake compensation driving of a lens driving device according to a first embodiment of the present invention. FIG. 39 is a cross-sectional view illustrating the appearance of an OIS moving part in an initial state in which no current is applied to an OIS-x coil and an OIS-y coil. FIG. 40 is a cross-sectional view illustrating a state in which an OIS moving part moves in an x-axis direction perpendicular to an optical axis as current is applied to an OIS-x coil. FIG. 41 is a cross-sectional view illustrating a state in which a current is applied to an OIS-y coil so that an OIS moving part moves in a y-axis direction perpendicular to both the optical axis and the x-axis.

As illustrated in FIG. 39, the moving part may be disposed at an initial position in a state in which no current is applied to the OIS-x coil 520 and the OIS-y coil 620. At this time, the moving part may be the OIS moving part 300.

When a current is applied to the OIS-x coil 520, the OIS-x magnet 510 may move in an x-axis direction perpendicular to the optical axis due to electromagnetic interaction between the OIS-x coil 520 and the OIS-x magnet 510 (see A in FIG. 40). At this time, the OIS carrier 310 together with the OIS-x magnet 510 may move in an x-axis direction. Furthermore, the lens may move in an x-axis direction together with the OIS carrier 310. More specifically, when a forward current is applied to the OIS-x coil 520, the OIS-x magnet 510, the OIS carrier 310, and the lens may move in one direction on the x-axis. In addition, when a reverse current is applied to the OIS-x coil 520, the OIS-x magnet 510, the OIS carrier 310, and the lens may move in another direction on the x-axis.

When current is applied to the OIS-y coil 620, due to the electromagnetic interaction between the OIS-y coil 620 and the OIS-y magnet 610, the OIS-y magnet 610 can move in a y-axis direction perpendicular to the optical axis (see B in FIG. 41). At this time, the OIS carrier 310 together with the OIS-y magnet 610 may move in a y-axis direction. Furthermore, the lens may move in a y-axis direction together with the OIS carrier 310. More specifically, when a forward current is applied to the OIS-y coil 620, the OIS-y magnet 610, the OIS carrier 310, and the lens may move in one direction on the y-axis. In addition, when a reverse current is applied to the OIS-y coil 620, the OIS-y magnet 610, the OIS carrier 310, and the lens may move in another direction on the y-axis.

Meanwhile, the OIS-x sensor 530 may detect the amount or position of the OIS-x magnet 510 by detecting the strength of the magnetic field of the OIS-x magnet 510. The movement amount or position detected by the OIS-x sensor 530 may be used for feedback control for hand shake compensation in an x-axis direction. The OIS-y sensor 630 may detect the movement amount or position of the OIS-y magnet 610 by detecting the strength of the magnetic field of the OIS-y magnet 610. The movement amount or position detected by the OIS-y sensor 630 may be used for hand shake compensation feedback control in a y-axis direction.

Hereinafter, a camera device according to a first embodiment of the present invention will be described with reference to the drawings.

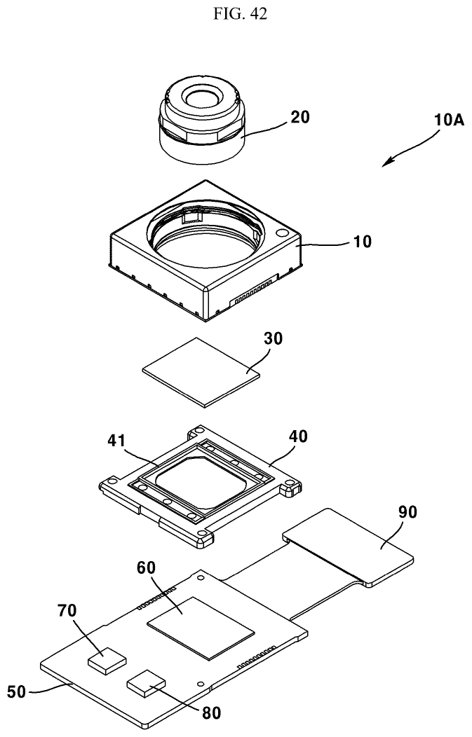

FIG. 42 is an exploded perspective view of a camera device according to a first embodiment of the present invention.

The camera device 10A may comprise a camera module.

The camera device 10A may comprise a lens module 20. The lens module 20 may comprise at least one lens. The lens may be disposed at a position corresponding to the image sensor 60. The lens module 20 may comprise a lens and a barrel. The lens module 20 may be coupled to the OIS carrier 310 of the lens driving device 10. The lens module 20 may be coupled to the OIS carrier 310 by screw-coupling and/or adhesive. The lens module 20 may move integrally with the OIS carrier 310.

The camera device 10A may comprise a filter 30. The filter 30 may serve to block light of a specific frequency band from entering the image sensor 60 from light passing through the lens module 20. The filter 30 may be disposed parallel to an x-y plane. The filter 30 may be disposed between the lens module 20 and the image sensor 60. The filter 30 may be disposed in the sensor base 40. In a modified embodiment, the filter 30 may be disposed in base 110. The filter 30 may comprise an infrared filter. The infrared filter may block light of an infrared region from being incident on the image sensor 60.

The camera device 10A may comprise a sensor base 40. The sensor base 40 may be disposed between the lens driving device 10 and the printed circuit board 50. The sensor base 40 may comprise a protruding part 41 in which the filter 30 is disposed. An opening may be formed in a portion of the sensor base 40 where the filter 30 is disposed so that light passing through the filter 30 may be incident to the image sensor 60. The adhesive member may couple or attach the base 110 of the lens driving device 10 to the sensor base 40. The adhesive member may additionally serve to prevent foreign substances from entering the lens driving device 10. The adhesive member may comprise any one or more of an epoxy, a thermosetting adhesive, and an ultraviolet curable adhesive.

The camera device 10A may comprise a printed circuit board (PCB) 50. The printed circuit board 50 may be a substrate or a circuit board. The lens driving device 10 may be disposed on the printed circuit board 50. A sensor base 40 may be disposed between the printed circuit board 50 and the lens driving device 10. The printed circuit board 50 may be electrically connected to the lens driving device 10. An image sensor 60 may be disposed on the printed circuit board 50. The printed circuit board 50 may comprise various circuits, elements, and control units to convert an image formed by the image sensor 60 into an electrical signal and transmit the converted electrical signal to an external device.

The camera device 10A may comprise an image sensor 60. The image sensor 60 may be a component in which the light passing through the lens and the filter 30 is incident to form an image. The image sensor 60 may be mounted on the printed circuit board 50. The image sensor 60 may be electrically connected to the printed circuit board 50. For an example, the image sensor 60 may be coupled to the printed circuit board 50 by a surface mounting technology (SMT). As another example, the image sensor 60 may be coupled to the printed circuit board 50 using a flip chip technology. The image sensor 60 may be disposed such that an optical axis coincides with a lens. That is, the optical axis of the image sensor 60 and the optical axis of the lens may be aligned. The image sensor 60 may convert light being irradiated onto an effective image region of the image sensor 60 into an electrical signal. The image sensor 60 may be any one among a charge coupled device (CCD), a metal oxide semi-conductor (MOS), a CPD, and a CID.

The camera device 10A may comprise a motion sensor 70. The motion sensor 70 may be mounted on a printed circuit board 50. The motion sensor 70 may be electrically connected to a control unit 80 through a circuit pattern provided on the printed circuit board 50. The motion sensor 70 may output rotational angular velocity information due to the movement of the camera module. The motion sensor 70 may comprise a 2-axis or 3-axis gyro sensor or an angular velocity sensor. The camera device 10A may comprise a control unit 80. The control unit 80 may be disposed in the printed circuit board 50. The control unit 80 may be electrically connected to the coil 130 of the lens driving device 10. The control unit 80 may individually control the direction, intensity, and amplitude of current supplied to the coil 130. The control unit 80 may perform an auto focus function by controlling the lens driving device 10. The control unit 80 may be electrically connected to the Hall sensor 140. The control unit 80 may detect the position of the mover 200 through the Hall sensor 140 and perform autofocus feedback control for the lens driving device 10.

The camera device 10A may comprise a connector 90. The connector 90 may be electrically connected to the printed circuit board 50. The connector 90 may comprise a port for electrical connection with an external device.

Hereinafter, an optical apparatus according to a first embodiment of the present invention will be described with reference to drawings.

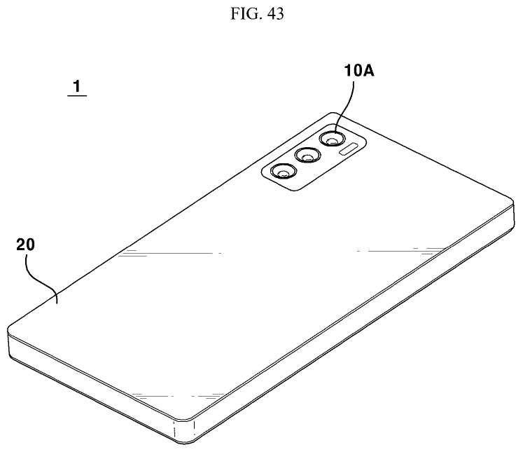

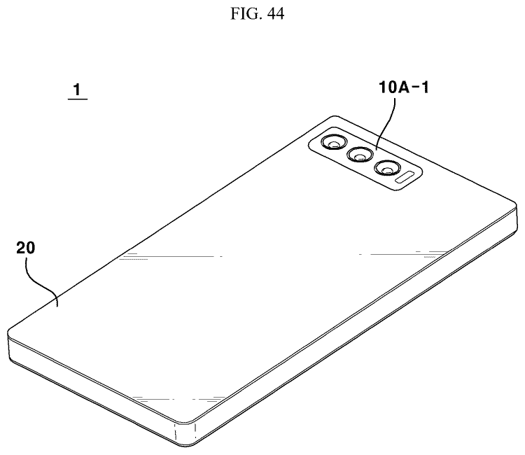

FIG. 43 is a perspective view of an optical apparatus according to a first embodiment of the present invention; and FIG. 44 is a perspective view of an optical apparatus according to a modified embodiment.

The optical apparatus 1 is a mobile phone, mobile phone, portable terminal, mobile terminal, smart phone, smart pad, portable smart device, digital camera, laptop computer, digital broadcasting terminal, personal digital assistants (PDAs), portable multimedia player (PMP), and navigation. The optical apparatus 1 may comprise any device for photographing images or photos.

The optical apparatus 1 may comprise a main body 20. The optical apparatus 1 may comprise a camera device 10A. The camera device 10A may be disposed on the main body 20. The camera device 10A may photograph a subject. The optical apparatus 1 may comprise a display. The display may be disposed on the main body 20. The display may output at least one of a video and an image photographed by the camera device 10A. The display may be disposed on a first surface of the main body 20. The camera device 10A may be disposed on at least one of a first surface of the main body 20 and a second surface opposite to the first surface. As illustrated in FIG. 43, in the camera device 10A, triple cameras may be disposed in a vertical direction. As illustrated in FIG. 44, in the camera device 10A-1, triple cameras may be disposed in a horizontal direction.

Hereinafter, the component of a lens driving device according to a second embodiment of the present invention will be described with reference to the drawings.

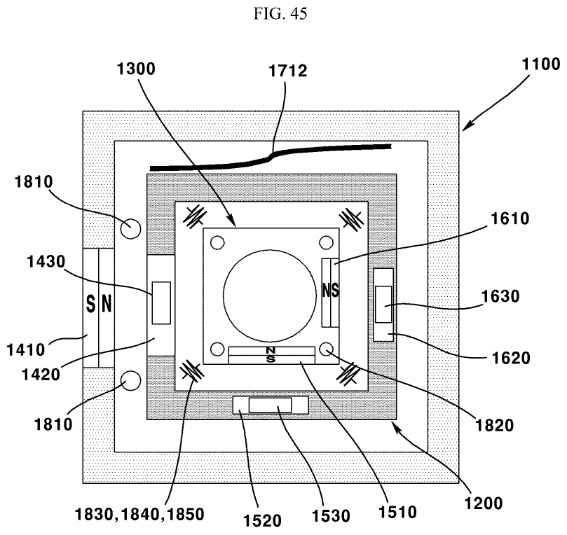

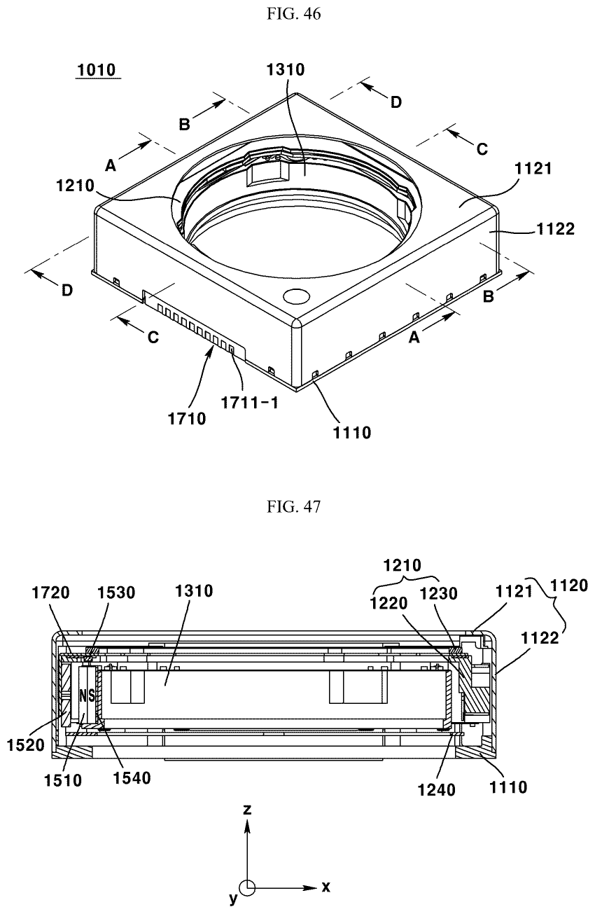

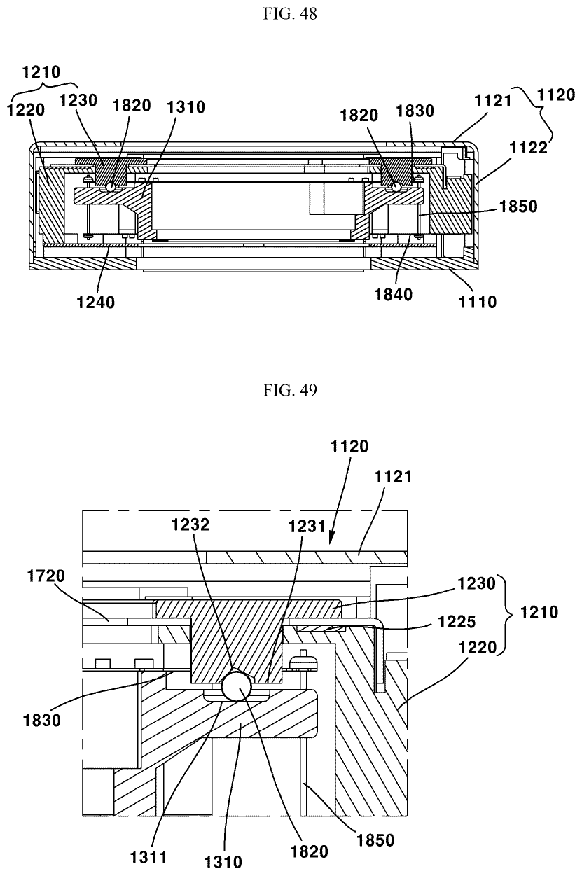

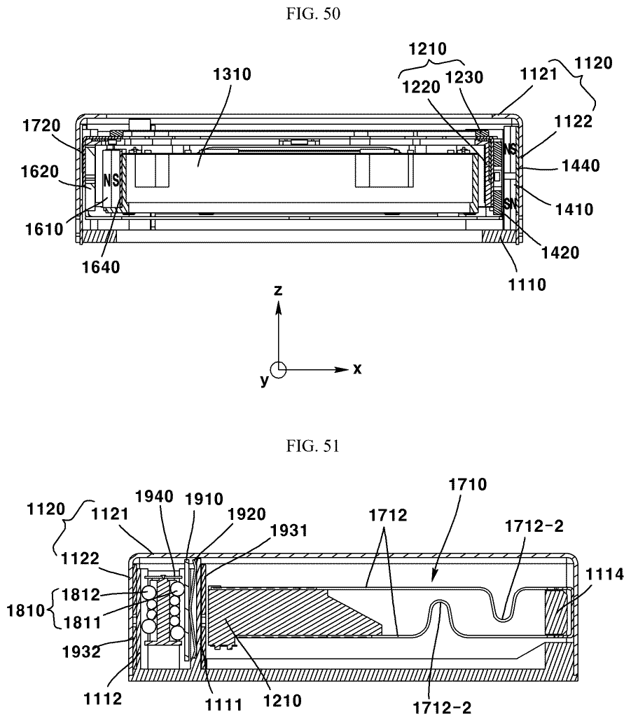

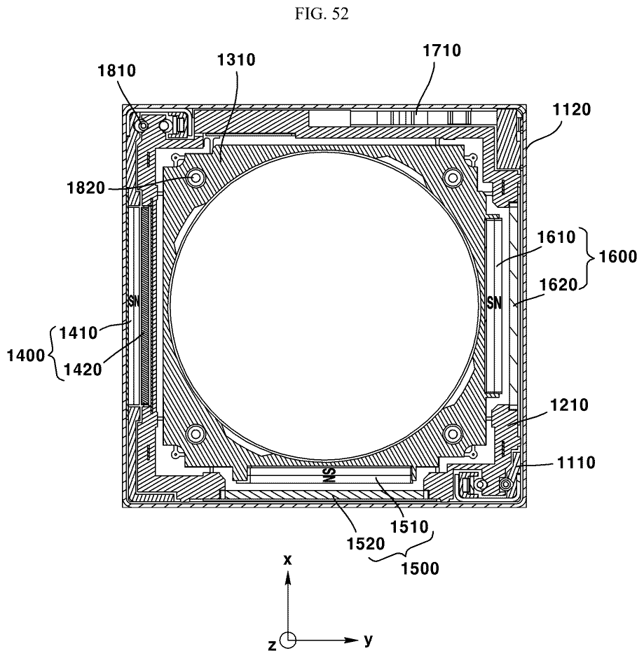

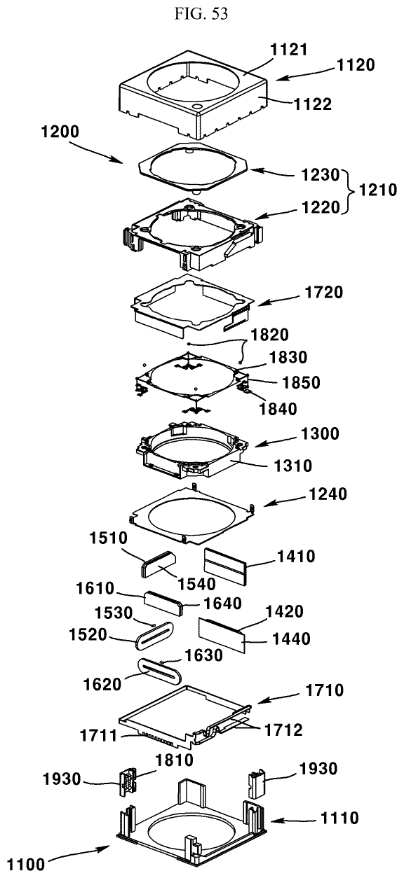

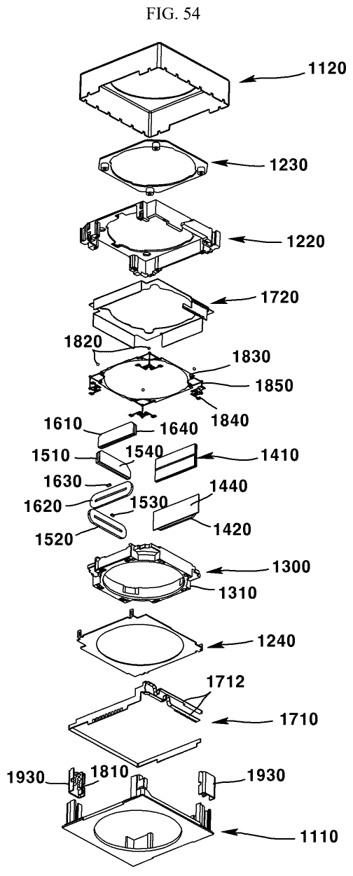

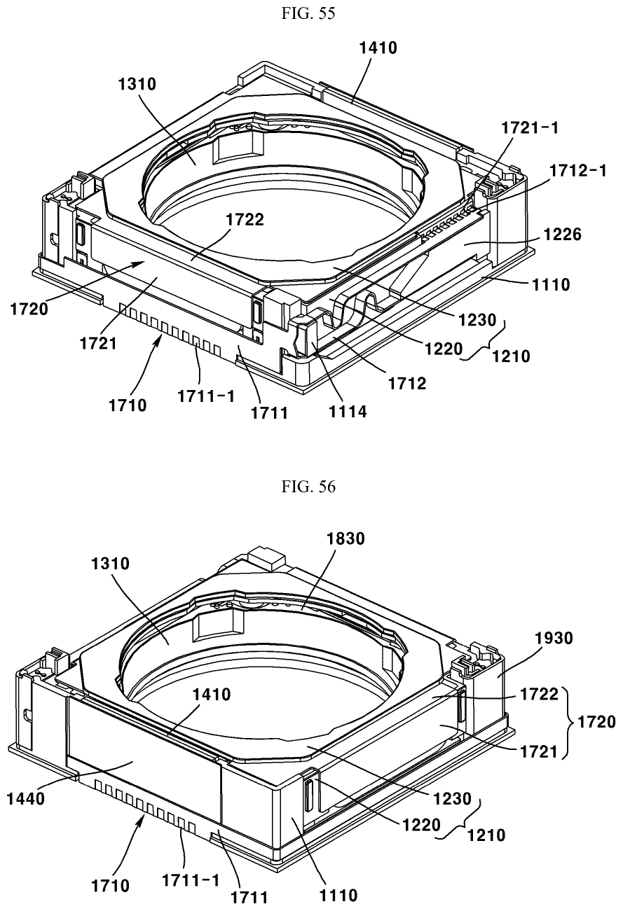

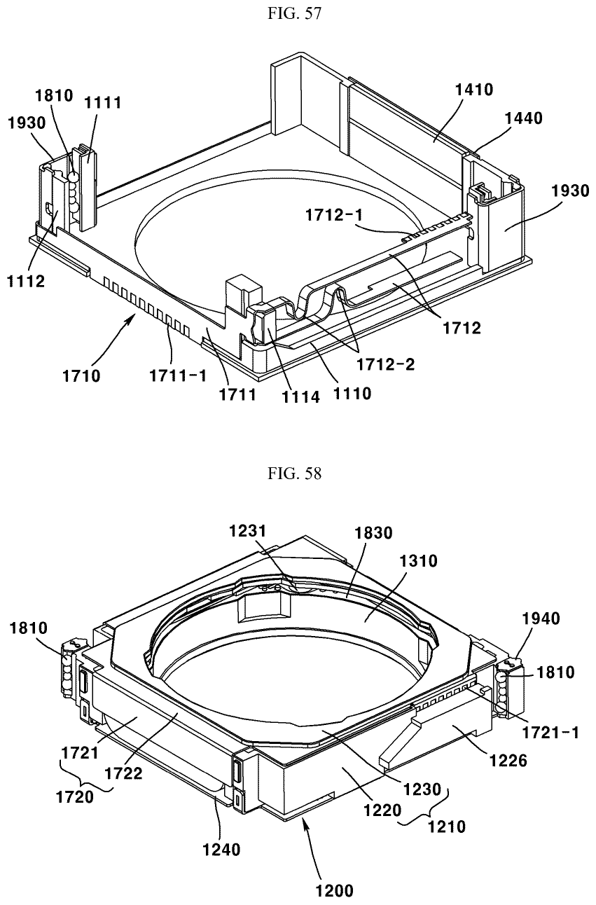

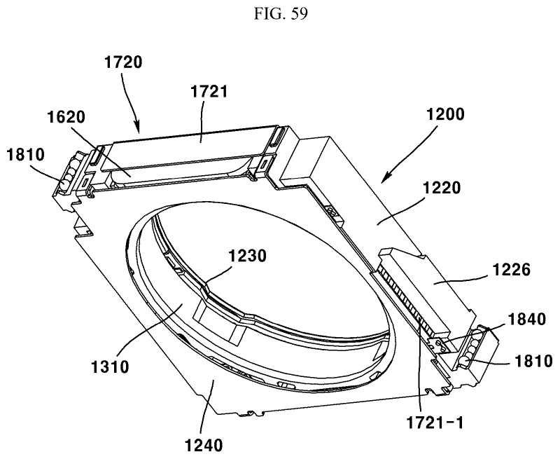

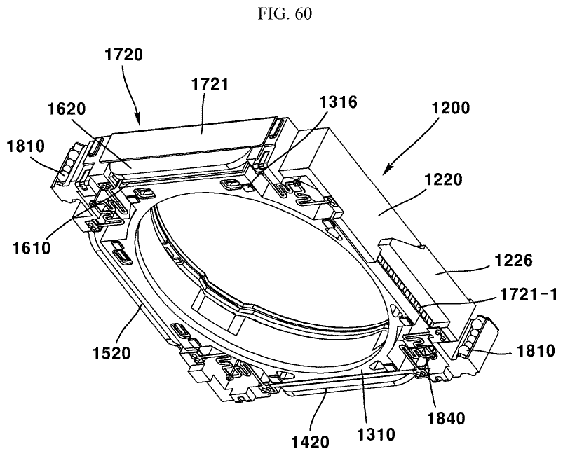

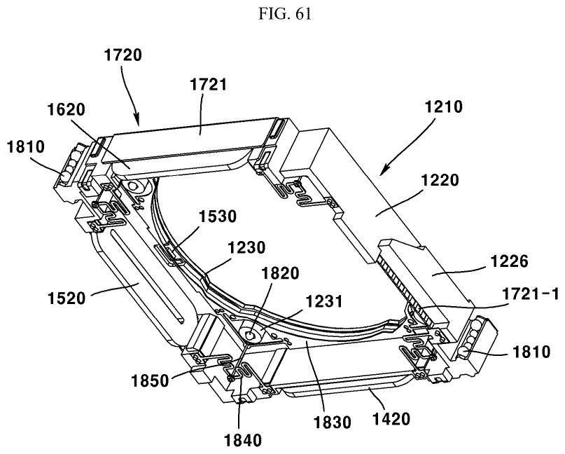

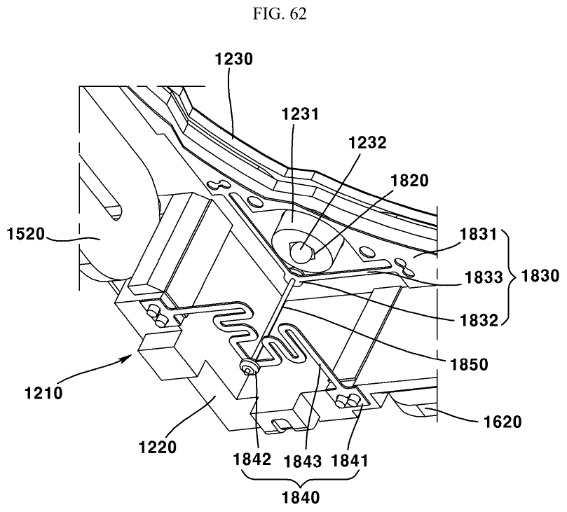

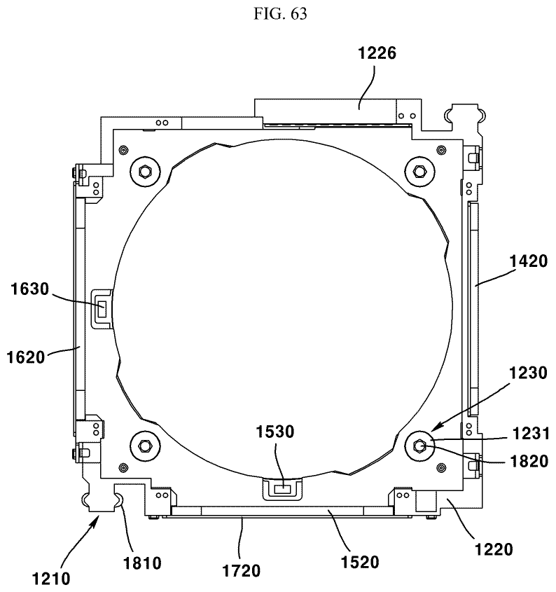

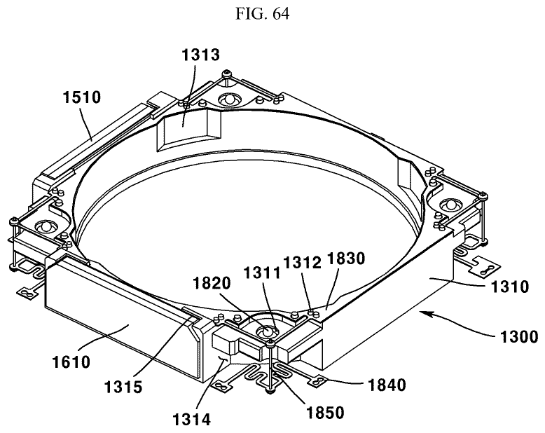

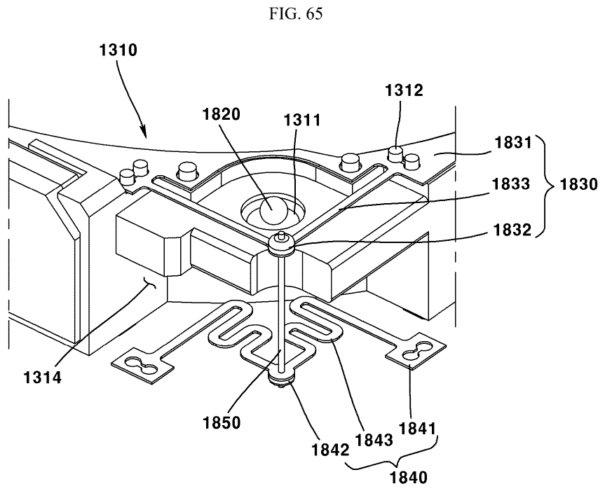

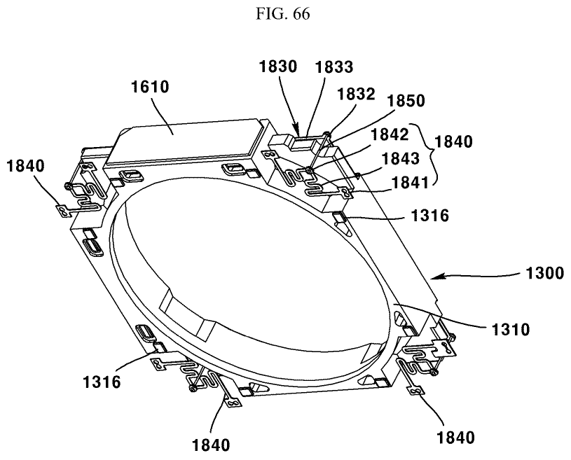

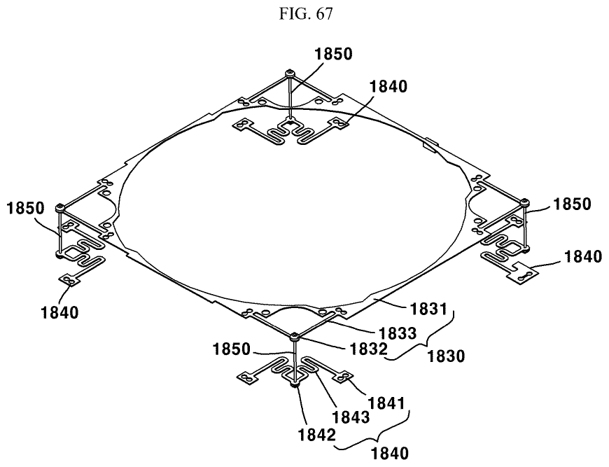

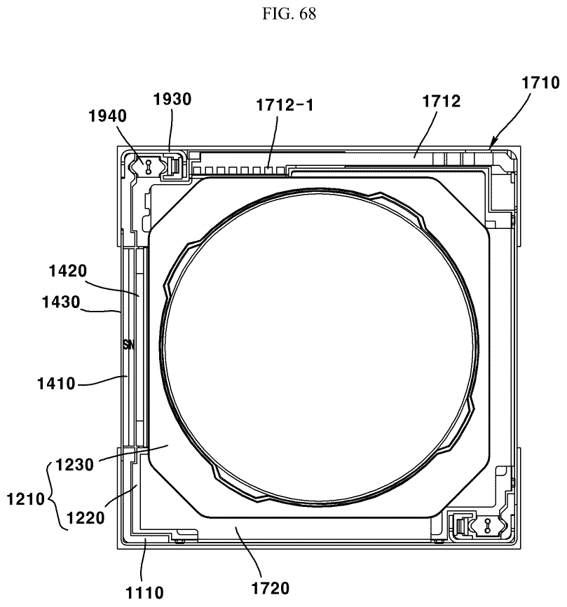

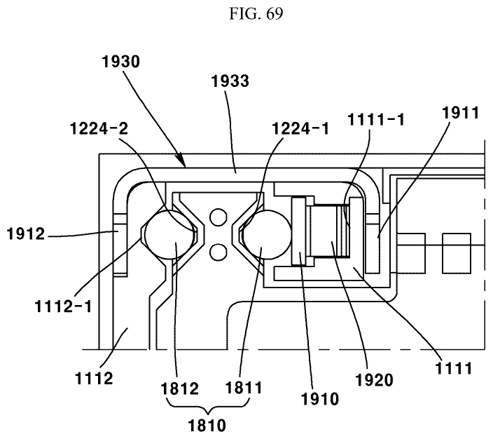

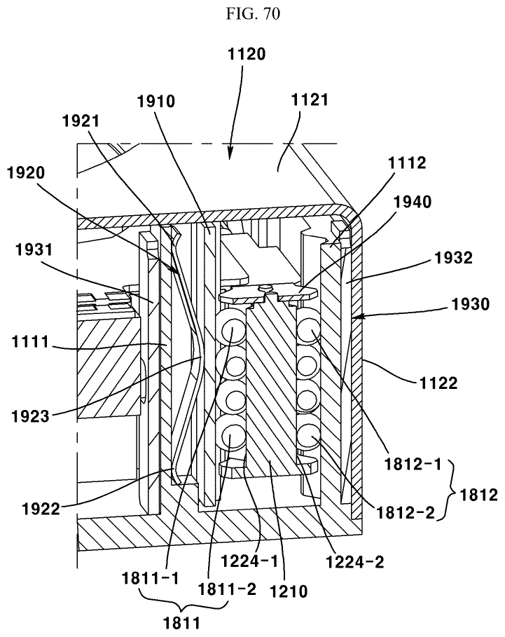

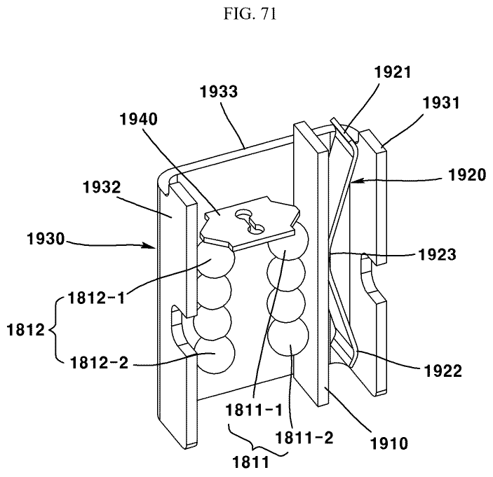

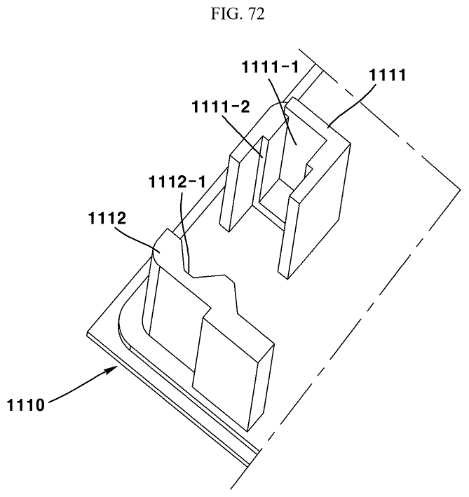

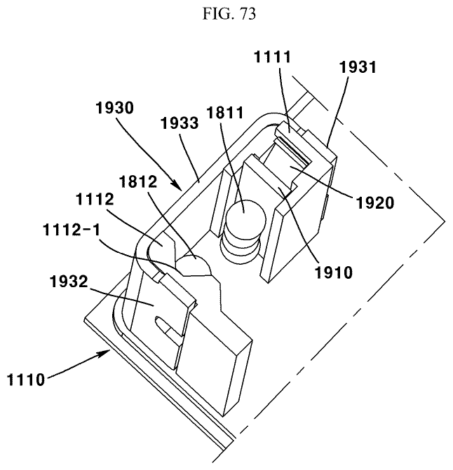

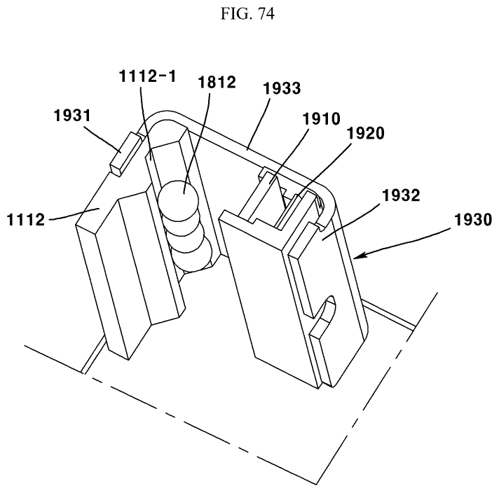

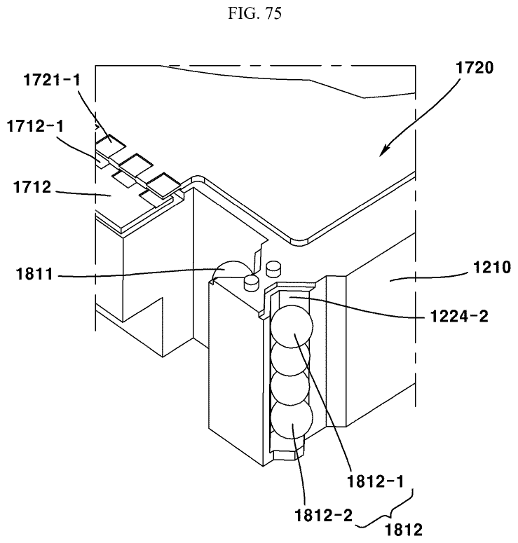

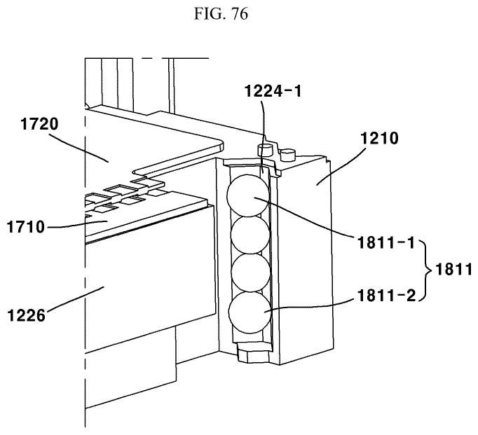

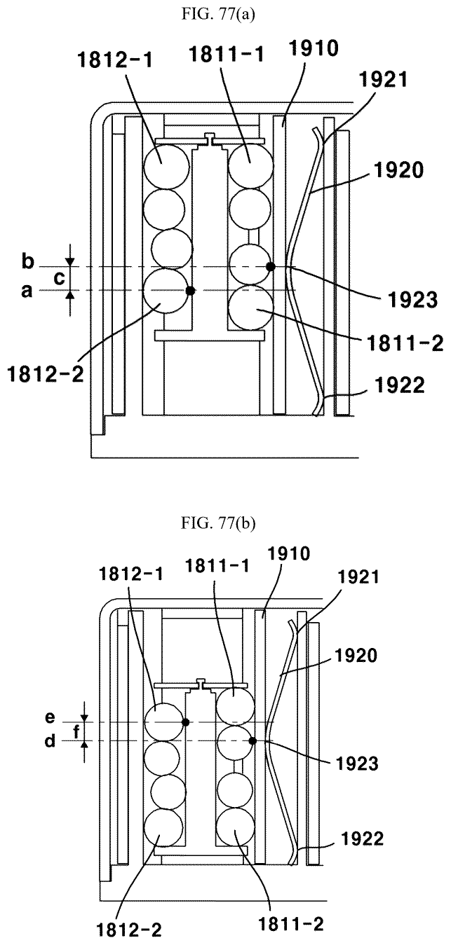

FIG. 45 is a conceptual diagram of a lens driving device according to a second embodiment of the present invention; FIG. 46 is a perspective view of a lens driving device according to a second embodiment of the present invention; FIG. 47 is a cross-sectional view viewed from A-A in FIG. 46; FIG. 48 is a cross-sectional view viewed from B-B in FIG. 46; FIG. 49 is an enlarged view of a partial region of FIG. 48; FIG. 50 is a cross-sectional view viewed from C-C in FIG. 46; FIG. 51 is a cross-sectional view viewed from D-D in FIG. 46; FIG. 52 is a cross-sectional view of a lens driving device according to a second embodiment of the present invention cut in a direction perpendicular to an optical axis and viewed from above; FIG. 53 is an exploded perspective view of a lens driving device according to a second embodiment of the present invention; FIG. 54 is an exploded perspective view of a lens driving device according to a second embodiment of the present invention, viewed from a direction different from that of FIG. 53; FIG. 55 is a perspective view of a lens driving device according to a second embodiment of the present invention in which a cover is omitted; FIG. 56 is a perspective view viewed from a direction different from that in FIG. 55; FIG. 57 is a perspective view illustrating a fixed part and related components of a lens driving device according to a second embodiment of the present invention; FIG. 58 is a perspective view illustrating a moving part and related components of a lens driving device according to a second embodiment of the present invention; FIG. 59 is a bottom perspective view viewed from a direction different from that in FIG. 58; FIG. 60 is a bottom perspective view of a state in which the cover of an AF moving part in FIG. 59 is removed; FIG. 61 is a bottom perspective view of a state in which an OIS moving part is removed in FIG. 60; FIG. 62 is an enlarged view of a partial region of FIG. 61; FIG. 63 is a bottom view of FIG. 61 viewed from below; FIG. 64 is a perspective view illustrating an OIS moving part and related components of a lens driving device according to a second embodiment of the present invention; FIG. 65 is an enlarged view of a partial region of FIG. 64; FIG. 66 is a bottom perspective view of FIG. 64 viewed from a different direction; FIG. 67 is a perspective view of an elastic member of a lens driving device according to a second embodiment of the present invention; FIG. 68 is a plan view of a lens driving device according to a second embodiment of the present invention with a cover removed; FIG. 69 is an enlarged plan view of a part of FIG. 68 in a state where a cover is omitted; FIG. 70 is a sectional perspective view illustrating a ball and a related structure of a lens driving device according to a second embodiment of the present invention; FIG. 71 is a perspective view illustrating a ball and a related structure of a lens driving device according to a second embodiment of the present invention; FIG. 72 is a perspective view illustrating a ball accommodation structure of a base of a lens driving device according to a second embodiment of the present invention; FIG. 73 is a perspective view illustrating a state in which a ball, a plate member, an elastic member, and a reinforcing member are disposed in FIG. 72; FIG. 74 is a perspective view of FIG. 73 viewed from another direction; FIG. 75 is a perspective view illustrating a moving part and a ball of a lens driving device according to a second embodiment of the present invention; FIG. 76 is a perspective view of FIG. 75 viewed from another direction; FIG. 77(a) is a view comparing the heights of a ball and a pressure point in a state in which a moving part moves upward; and FIG. 77(b) is a view comparing the heights of a ball and a pressure point in a state where a moving part moves downward.

The lens driving device 1010 may be a voice coil motor (VCM). The lens driving device 1010 may be a lens driving motor. The lens driving device 1010 may be a lens driving actuator. The lens driving device 1010 may comprise an AF module. The lens driving device 1010 may comprise an OIS module.

The lens driving device 1010 may comprise a fixed part 1100. The fixed part 1100 may be a relatively fixed part when the moving part moves. The moving part may move against the fixed part 1100.

The lens driving device 1010 may comprise a base 1110. The fixed part 1100 may comprise a base 1110. The base 1110 may be disposed below the AF carrier 1210. The base 1110 may be disposed below the OIS carrier 1310. The base 1110 may be coupled with cover 1120. The AF carrier 1210 and the OIS carrier 1310 may be disposed on the base 1110. The AF carrier 1210 and the OIS carrier 1310 may be disposed on a lower plate portion of the base 1110. The AF carrier 1210 and the OIS carrier 1310 may be disposed inside the base 1110. The AF carrier 1210 and the OIS carrier 1310 may be disposed inside the side wall part of the base 1110.

The base 1110 may comprise a lower plate portion. The lower plate portion of the base 1110 may support a lower surface of the AF moving part 1200. The lower plate portion of the base 1110 may support a lower surface of the AF carrier 1210.

The base 1110 may comprise a pillar part 1111. The base 1110 may comprise a pillar part 1111. The pillar part 1111 may be extended from an upper surface of the lower plate portion. The pillar part 1111 may be disposed inside the outer wall part 1112.

The base 1110 may comprise an inner groove 1111-1. The pillar part 1111 may comprise an inner groove 1111-1. The inner groove 1111-1 may be formed in the pillar part 1111. The inner groove 1111-1 may be an ‘AF guide ball accommodating groove’. An AF guide ball 1810 may be disposed in the inner groove 1111-1. An inner ball 1811 may be disposed in the inner groove 1111-1. The inner groove 1111-1 may be directly in contact with the AF guide ball 1810. The inner groove 1111-1 may be disposed in an optical axis direction. The inner groove 1111-1 may comprise a plurality of grooves. The inner groove 1111-1 may comprise two grooves. The two grooves may be disposed parallel to each other. The two grooves may be disposed in a diagonal direction from each other with respect to an optical axis.

The base 1110 may comprise a step 1111-2. The step 1111-2 may be formed in the pillar part 1111. A plate member 1910 may be disposed in the step 1111-2.

The fixed part 1100 may comprise an outer wall part 1112. The base 1110 may comprise an outer wall part 1112. The outer wall part 1112 may be a ‘side portion’. The outer wall part 1112 may be a ‘side plate’. The outer wall part 1112 may be a ‘side wall’. The outer wall part 1112 of the base 1110 may be extended from an upper surface of the lower plate portion. The fixed part 1100 may comprise a first protruding part and a second protruding part. At this time, the first protruding part may be the pillar part 1111 and the second protruding part may be the outer wall part 1112.

The base 1110 may comprise an outer groove 1112-1. The outer wall part 1112 may comprise an outer groove 1112-1. The outer groove 1112-1 may be formed to face the inner groove 1111-1. The outer groove 1112-1 may face the inner groove 1111-1. The outer groove 1112-1 may be an ‘AF guide ball accommodating groove’. An AF guide ball 1810 may be disposed in the outer groove 1112-1. An outer ball 1812 may be disposed in the outer groove 1112-1. The outer groove 1112-1 may directly in contact with the AF guide ball 1810. The outer groove 1112-1 may be disposed in an optical axis direction. The outer groove 1112-1 may comprise a plurality of grooves. The outer groove 1112-1 may comprise two grooves. The two grooves may be disposed parallel to each other. The two grooves may be disposed in a diagonal direction from each other with respect to an optical axis. The outer groove 1112-1 may be disposed at an opposite side of the inner groove 1111-1. The outer groove 1112-1 may have a shape corresponding to the inner groove 1111-1. The outer groove 1112-1 and the inner groove 1111-1 may have the same length in an optical axis direction.

The base 1110 may comprise a protruding part 1114. The protruding part 1114 may be protruded outward. A connection part 1712 of the outer substrate 1710 may be disposed above and below the protruding part 1114. A groove may be formed in the protruding part 1114 so as not to interfere even when the connecting part 1712 of the outer substrate 1710 moves.

The base 1110 may comprise a step. The step may be formed on a lower end portion of an outer side surface of the base 1110. The step may be protruded from an outer side surface of the base 1110. The side plate 1122 of the cover 1120 may be disposed in a step of the base 1110.

The lens driving device 1010 may comprise a cover 1120. The fixed part 1100 may comprise a cover 1120. The cover 1120 may be disposed in the base 1110. The cover 1120 may be disposed on the base 1110. The cover 1120 may be coupled to the base 1110. The cover 1120 may be fixed to the base 1110. The cover 1120 may accommodate the AF carrier 1210 therein. The cover 1120 may accommodate the OIS carrier 1310 therein. The cover 1120 may be a shield member. The cover 1120 may be a shield can.

The cover 1120 may comprise an upper plate 1121. The upper plate 1121 may be disposed on a moving part. The upward movement of the moving part may be limited by contacting of the moving part with the upper plate 1121. The upper plate 1121 may comprise a hole through which light passes.

The cover 1120 may comprise a side plate 1122. The side plate 1122 may be extended from the upper plate 1121. The side plate 1122 may be disposed in the base 1110. The side plate 1122 may be disposed on a step portion being protruded from a lower end portion of an outer side surface of the base 1110. The side plate 1122 may comprise a plurality of side plates. The side plate 1122 may comprise four side plates. The side plate 1122 may comprise a first side plate and a second side plate being disposed opposite to each other, and a third side plate and a fourth side plate being disposed opposite to each other.

The lens driving device 1010 may comprise a moving part. The moving part may be disposed in the fixed part 1100. The moving part may be disposed inside the fixed part 1100. The moving part may be disposed on the fixed part 1100. The moving part may be movably disposed in the fixed part 1100. The moving part may move based on the fixed part 1100 by the driving part. The moving part can move during AF driving. The moving part can move during OIS driving. A lens may be coupled to the moving part.

The lens driving device 1010 may comprise an AF moving part 1200. The AF moving part 1200 may be disposed in the fixed part 1100. The AF moving part 1200 may be disposed inside the fixed part 1100. The AF moving part 1200 may be disposed on the fixed part 1100. The AF moving part 1200 may be disposed between the fixed part 1100 and the OIS moving part 1300. The AF moving part 1200 may be movably disposed in the fixed part 1100. The AF moving part 1200 may move in an optical axis direction against the fixed part 1100 by the AF driving part 1400. The AF moving part 1200 may move during AF driving.

The lens driving device 1010 may comprise an AF carrier 1210. The AF moving part 1200 may comprise an AF carrier 1210. The AF carrier 1210 may be an ‘AF holder’. The AF carrier 1210 may be a ‘housing’. The AF carrier 1210 may be disposed inside the base 1110. AF carrier 1210 may be disposed on the base 1110. The AF carrier 1210 may be disposed inside the cover 1120. The AF carrier 1210 may be disposed between the base 1110 and the OIS carrier 1310. The AF carrier 1210 may be movably disposed in an optical axis direction.

The AF carrier 1210 may comprise a frame, a first upper plate, and a second upper plate. At this time, the frame may be a body part. The frame may be the holder member 1220. The first upper plate may be a metal member 1225. The second upper plate may be a pre-pressurizing member 1230. The AF carrier 1210 may be a housing. The housing may comprise a first housing and a second housing. At this time, the first housing may comprise the holder member 1220 and the second housing may comprise the pre-pressurizing member 1230. The OIS carrier 1310 may be a bobbin. The OIS guide member 1820 may be disposed between the housing and the bobbin. The AF guide ball 1810 may be disposed between a side surface of the housing and the cover 1120. The AF guide ball 1810 may be disposed between a side surface of the housing and a base or pillar of the base.

The AF carrier 1210 may comprise a protruding part. The protruding part may be protruded from the AF carrier 1210 in a first direction perpendicular to the optical axis direction. The protruding part of the AF carrier 1210 may be referred to as a ‘third protruding part’ to distinguish it from the two protruding parts of the base 1110, the pillar part 1111 and the outer wall part 1112. The protruding part of the AF carrier 1210 may be disposed between the pillar part 1111 and the outer wall part 1112 of the base 1110. The inner ball 1811 may be disposed between the plate member 1910 and the pillar part 1111 of the fixed part 1100. The inner ball 1812 may be disposed between the pillar part 1111 of the fixed part 1100 and the protruding part of the AF moving part 1200. The outer ball 1813 may be disposed between the outer wall part 1112 of the fixed part 1100 and the protruding part of the AF moving part 1200. The pillar part 1111 may comprise a pillar part being disposed in the same corner region as the outer wall part 1112. That is, the first pillar part and the first outer wall part may be disposed in the first corner region of the base 1110.

The lens driving device 1010 may comprise a holder member 1220. The AF carrier 1210 may comprise a holder member 1220. The holder member 1220 may be formed separately from the pre-pressurizing member 1230. A lower elastic member 1840 may be coupled to the holder member 1220.

The AF carrier 1210 may comprise an upper plate. The upper plate may be disposed on the OIS carrier 1310. The upper plate may be disposed between the OIS carrier 1310 and the upper plate 1121 of the cover 1120. The upper plate may be disposed on the OIS moving part 1300.

The AF carrier 1210 may comprise a hole. The holder member 1220 may comprise a hole. The upper plate of the holder member 1220 may comprise a hole. A hole may be formed in an upper plate of the holder member 1220. The hole can be opened inward. A pre-pressurizing member 1230 may be inserted into the hole. The protruding part 1231 of the pre-pressurizing member 1230 may be inserted into the hole. The hole may be formed as a groove. The hole can be replaced by a groove. That is, as a modified embodiment, the AF carrier 1210 may comprise a groove into which the protruding part 1231 of the pre-pressurizing member 1230 is inserted.

The AF carrier 1210 may comprise a side wall. The sidewall may be extended downward from an upper plate. An inner substrate 1720 may be disposed on a sidewall. An AF coil 1420 may be disposed on the sidewall. An OIS-x coil 1520 may be disposed on a side wall. An OIS-y coil 1620 may be disposed on a side wall. The sidewall may comprise a groove that avoids the coil. The sidewall may comprise a plurality of sidewalls. The sidewall may comprise four sidewalls. The sidewall may comprise a first sidewall and a second sidewall being disposed opposite to each other, and a third sidewall and a fourth sidewall being disposed opposite to each other.

The AF carrier 1210 may comprise an inner groove 1224-1. The holder member 1220 may comprise an inner groove 1224-1. The inner groove 1224-1 may be an ‘AF guide ball accommodating groove’. An AF guide ball 1810 may be disposed in the inner groove 1224-1. An inner ball 1811 may be disposed in the inner groove 1224-1. The inner groove 1224-1 may directly in contact with the AF guide ball 1810. The inner groove 1224-1 may be disposed in an optical axis direction. The inner groove 1224-1 may guide the AF guide ball 1810 to move in an optical axis direction. The inner groove 1224-1 may comprise a plurality of grooves. The inner groove 1224-1 may comprise two grooves. The two grooves may be disposed parallel to each other. The two grooves may be disposed at a diagonal direction from each other with respect to an optical axis.

The AF carrier 1210 may comprise an outer groove 1224-2. The holder member 1220 may comprise an outer groove 1224-2. The outer groove 1224-2 may be an ‘AF guide ball accommodating groove’. An AF guide ball 1810 may be disposed in the outer groove 1224-2. An outer ball 1812 may be disposed in the outer groove 1224-2. The outer groove 1224-2 may be directly in contact with the AF guide ball 1810. The outer groove 1224-2 may be disposed in an optical axis direction. The outer groove 1224-2 may guide the AF guide ball 1810 to move in an optical axis direction. The outer groove 1224-2 may comprise a plurality of grooves. The outer groove 1224-2 may comprise two grooves. The two grooves may be disposed parallel to each other. The two grooves may be disposed in a diagonal direction from each other with respect to an optical axis. The outer groove 1224-2 may be disposed at an opposite side of the inner groove 1224-1. The outer groove 1224-2 may have a shape corresponding to the inner groove 1224-1. The outer groove 1224-2 and the inner groove 1224-1 may have the same length in an optical axis direction.

The AF carrier 1210 may comprise a metal member 1225. The holder member 1220 may comprise a metal member 1225. The metal member 1225 may be insert-injected into the holder member 1220. At least a portion of the metal member 1225 may be disposed on an upper surface of the holder member 1220. The metal member 1225 may be disposed to reinforce the strength of the holder member 1220.

The AF carrier 1210 may comprise a protruding part 1226. The holder member 1220 may comprise a protruding part 1226. The protruding part 1226 may be formed on an outer side surface of the AF carrier 1210. The protruding part 1226 may be protruded outward from the AF carrier 1210. A connection part 1712 may be disposed on an upper surface and a lower surface of the protruding part 1226.

The lens driving device 1010 may comprise a pre-pressurizing member 1230. The AF carrier 1210 may comprise a pre-pressurizing member 1230. The pre-pressurizing member 1230 may be coupled to an upper surface of the holder member 1220. The pre-pressurizing member 1230 may be coupled with the holder member 1220. The pre-pressurizing member 1230 may be inserted and coupled to the holder member 1220 from above. The pre-pressurizing member 1230 may apply pressure to the OIS guide member 1820. The pre-pressurizing member 1230 may be in contact with the OIS guide member 1820. The pre-pressurizing member 1230 may be directly in contact with the OIS guide member 1820. The pre-pressurizing member 1230 may apply pressure to the OIS guide member 1820 by being coupled to the holder member 1220.

The AF carrier 1210 may comprise a protruding part 1231. The pre-pressurizing member 1230 may comprise a protruding part 1231. The protruding part 1231 may be coupled to the hole of the holder member 1220. The protruding part 1231 of the pre-pressurizing member 1230 may be inserted into a hole of the holder member 1220 from above. The protruding part 1231 of the pre-pressurizing member 1230 may be disposed in a hole of the holder member 1220. At least a part of the protruding part 1231 of the pre-pressurizing member 1230 may be disposed in a hole of the holder member 1220. The OIS guide member 1820 may be disposed on a lower end portion of the protruding part 1231 of the pre-pressurizing member 1230. The protruding part 1231 may comprise a plurality of protrusions. The protruding part 1231 may comprise four protrusions.

The AF carrier 1210 may comprise a groove 1232. The pre-pressurizing member 1230 may comprise a groove 1232. The groove 1232 may be an ‘OIS guide ball accommodating groove’. The groove 1232 may be formed in the protruding part 1231. The groove 1232 may be formed on a lower surface of the protruding part 1231. The groove 1232 may be formed at an end portion of the protruding part 1231. The groove 1232 may be concavely formed on a lower surface of the protruding part 1231. An OIS guide ball 1820 may be disposed in the groove 1232. The groove 1232 may be directly in contact with the OIS guide ball 1820. In one example, groove 1232 may comprise a flat bottom surface. At this time, the OIS guide ball 1820 may be in contact with the bottom surface of the groove 1232 at one point. In other words, the groove 1232 comprises a flat bottom surface, and the OIS guide ball 1820 may be in contact with the flat surface at one point. Or, the bottom surface of the groove 1232 may comprise at least three planes inclined to each other. In this case, the OIS guide ball 1820 may be in contact with the bottom surface of the groove 1232 at three points.

The lens driving device 1010 may comprise a cover 1240. The AF moving part 1200 may comprise a cover 1240. The cover 1240 may be coupled with the AF carrier 1210. The cover 1240 may be coupled to a lower surface of the AF carrier 1210. The cover 1240 may be coupled to the AF carrier 1210 at a lower side. The cover 1240 may comprise a hook. The hook of the cover 1240 may be coupled to the AF carrier 1210. The hook of the cover 1240 is protruded upward and may be coupled to a side surface of the AF carrier 1210.

The lens driving device 1010 may comprise an OIS moving part 1300. The OIS moving part 1300 may be disposed in the fixed part 1100. The OIS moving part 1300 may be disposed inside the fixed part 1100. The OIS moving part 1300 may be disposed on the fixed part 1100. The OIS moving part 1300 may be disposed inside the AF moving part 1200. The OIS moving part 1300 may be movably disposed. The OIS moving part 1300 may move in a direction perpendicular to the optical axis against the fixed part 1100 and the AF moving part 1200 by the OIS driving part. The OIS moving part 1300 may move in an x-axis direction by the OIS-x driving part 1500. The OIS moving part 1300 may move in a y-axis direction by the OIS-y driving part 1600. The OIS moving part 1300 may move during OIS driving.

The lens driving device 1010 may comprise an OIS carrier 1310. The OIS moving part 1300 may comprise an OIS carrier 1310. The OIS carrier 1310 may be an ‘OIS holder’. The OIS carrier 1310 may be a ‘bobbin’. The OIS carrier 1310 may be disposed inside the AF carrier 1210. The OIS carrier 1310 may be disposed inside the base 1110. The OIS carrier 1310 may be disposed on the base 1110. The OIS carrier 1310 may be disposed inside the cover 1120. The OIS carrier 1310 may be movably disposed in a direction perpendicular to the optical axis.

The OIS carrier 1310 may comprise an outer side surface. The OIS carrier 1310 may comprise a plurality of side surfaces. The OIS carrier 1310 may comprise a first side surface and a second side surface being disposed opposite to each other, and a third side surface and a fourth side surface being disposed opposite to each other. The AF coil 1420 may be disposed between a first side surface of the OIS carrier 1310 and the AF magnet 1410. The OIS-x magnet 1510 may be disposed on a third side surface of the OIS carrier 1310. The OIS-y magnet 1610 may be disposed on a second side surface of the OIS carrier 1310.

The OIS carrier 1310 may comprise a groove. The groove may be an ‘upper elastic member interference prevention groove’. A groove may be formed on an upper surface of the OIS carrier 1310. The groove may be concavely formed on an upper surface of the OIS carrier 1310. The groove may be disposed at a position corresponding to the upper elastic member 1830 to prevent interference between the OIS carrier 1310 and the upper elastic member 1830.

The OIS carrier 1310 may comprise a groove 1311. The groove 1311 may be an ‘OIS guide ball accommodating groove’. An OIS guide ball 1820 may be disposed in the groove 1311. The groove 1311 may be directly in contact with the OIS guide ball 1820. The groove 1311 may be disposed in a direction perpendicular to the optical axis. The groove 1311 may be recessed in an optical axis direction. The groove 1311 may comprise a plurality of grooves. The groove 1311 may comprise four grooves. The groove 1311 may be in contact with the OIS guide ball 1820 at one point. Or, the groove 1311 may be in contact with the OIS guide ball 1820 at two points. The number of contact points between the OIS carrier 1310 and the OIS guide ball 1820 may vary due to the movement of the OIS guide ball 1820. The groove 1311 may be formed on an upper surface of the OIS carrier 1310. The groove 1311 may open upward.

The OIS carrier 1310 may comprise a lateral stopper. The lateral stopper may limit the stroke of the OIS carrier 1310 in a lateral direction. That is, when the OIS carrier 1310 moves to the maximum, the lateral stopper of the OIS carrier 1310 may be in contact with one or more of the AF carrier 1210 and the base 1110. The lateral stopper may be formed on an outer side surface of the OIS carrier 1310. The lateral stopper may be protruded outward from a side surface of the OIS carrier 1310.

The OIS carrier 1310 may comprise a protrusion 1312. The protrusion 1312 may be coupled with the upper elastic member 1830. The protrusion 1312 may be a ‘coupling protrusion’. The upper elastic member 1830 may comprise a hole into which the protrusion 1312 of the OIS carrier 1310 is inserted. The protrusion 1312 may be formed on an upper surface of the OIS carrier 1310.

The OIS carrier 1310 may comprise a groove 1313. The groove 1313 may be a ‘lens adhesive accommodating groove’. The groove 1313 may be formed on an inner circumferential surface of the OIS carrier 1310. The groove 1313 may be concavely formed on an inner circumferential surface of the OIS carrier 1310. An adhesive may be injected between the lens and the OIS carrier 1310 through the groove 1313. An adhesive for bonding the lens and the OIS carrier 1310 may be disposed in the groove 1313.

The OIS carrier 1310 may comprise a groove 1314. The groove 1314 may be formed on a lower surface of the OIS carrier 1310. The groove 1314 may open outward.

The OIS carrier 1310 may comprise a mounting part 1315. The mounting part 1315 may be a ‘magnet mounting part’. The magnets 1510 and 1620 may be disposed on the mounting part 1315. The mounting part 1315 may be formed as a groove, for an example.

The OIS carrier 1310 may comprise a lower stopper 1316. The lower stopper 1316 may be formed on a lower surface of the OIS carrier 1310. The lower stopper 1316 may be protruded downward from a lower surface of the OIS carrier 1310. The lower stopper 1316 may limit the downward movement of the OIS carrier 1310 by being in contact with the AF carrier 1210 or the base 1110.

Hereinafter, one among the ‘groove 1311’, the ‘groove 1313’, and the ‘groove 1314’ of the OIS carrier 1310 is referred to as a ‘first groove’, the other is referred to as a ‘second groove’, and another one may be referred to as the ‘third groove’.

The lens driving device 1010 may comprise a driving part. The driving part may move the moving part against the fixed part 1100. The driving part may comprise the AF driving part 1400. The driving part may comprise an OIS driving part. The driving part may comprise an OIS-x driving part 1500. The driving part may comprise an OIS-y driving part 1600. The driving part may comprise a coil and a magnet.

The lens driving device 1010 may comprise an AF driving part 1400. The AF driving part 1400 may move the AF moving part 1200 in an optical axis direction. The AF driving part 1400 may move the AF carrier 1210 in an optical axis direction. The AF driving part 1400 may move the AF carrier 1210 in an optical axis direction through electromagnetic force. The AF driving part 1400 may comprise a coil and a magnet.

In a second embodiment of the present invention, the AF carrier 1210 and the OIS carrier 1310 can move in an optical axis direction by the interaction between the AF coil 1420 and the AF magnet 1410. The AF coil 1420, the AF carrier 1210, and the OIS carrier 1310 may move integrally in an optical axis direction.

The lens driving device 1010 may comprise an AF magnet 1410. The AF driving part 1400 may comprise an AF magnet 1410. The AF magnet 1410 may be an ‘AF magnet’. The AF magnet 1410 may be a permanent magnet. The AF magnet 1410 may be disposed in the fixed part 1100. The AF magnet 1410 may be disposed in the base 1110. The AF magnet 1410 may be disposed in the cover 1120. The AF magnet 1410 may be disposed in the side plate 1122 of the cover 1120. The AF magnet 1410 may be disposed on an outer side surface of the base 1110. The AF magnet 1410 may be disposed on an inner side surface of the base 1110. The AF magnet 1410 may be fixed to the base 1110. AF magnet 1410 may be coupled to the base 1110. The AF magnet 1410 may be attached to the base 1110 with an adhesive. The AF magnet 1410 may be disposed inside the cover 1120. The AF magnet 1410 may interact with the AF coil 1420. The AF magnet 1410 may interact with the AF coil 1420 electromagnetically. The AF magnet 1410 may be disposed at a position corresponding to the AF coil 1420. The AF magnet 1410 and the AF coil 1420 may face each other. The AF magnet 1410 may face the AF coil 1420. The AF magnet 1410 may be overlapped with the AF coil 1420 in a direction perpendicular to the optical axis.

The AF magnet 1410 may be a 4-pole magnet. The AF magnet 1410 may comprise a 4-pole magnetized magnet. The AF magnet 1410 may comprise a first magnet part comprising an N pole and an S pole, and a second magnet part comprising an N pole and an S pole. The first magnet part and the second magnet part may be disposed in a vertical direction. The first magnet part and the second magnet part are disposed spaced apart from each other in a vertical direction, and a neutral part may be disposed between the first magnet part and the second magnet part.

The lens driving device 1010 may comprise an AF coil 1420. The AF driving part 1400 may comprise an AF coil 1420. The AF coil 1420 may interact with the AF magnet 1410. The AF coil 1420 may face the AF magnet 1410. The AF coil 1420 and the AF magnet 1410 may face each other. The AF coil 1420 may be disposed at a position corresponding to the AF magnet 1410. The AF coil 1420 may be overlapped with the AF magnet 1410 in a direction perpendicular to the optical axis. The AF coil 1420 may be disposed on an inner substrate 1720. The AF coil 1420 may be disposed in the AF carrier 1210. The AF coil 1420 may be disposed in the AF moving part 1200.

In a second embodiment of the present invention, the AF coil 1420 can move in an optical axis direction. The AF coil 1420 may move in an optical axis direction through interaction with the AF magnet 1410. The AF coil 1420 may move together with the AF moving part 1200. The AF coil 1420 may move in an optical axis direction together with the AF moving part 1200. During the AF driving process, the AF coil 1420 may move along with the AF moving part 1200 in an optical axis direction. The AF coil 1420 may be disposed in the AF moving part 1200. The AF coil 1420 may be fixed to the AF moving part 1200. The AF coil 1420 may be coupled to the AF moving part 1200.

The lens driving device 1010 may comprise an AF sensor 1430. The AF driving part 1400 may comprise an AF sensor 1430. The AF sensor 1430 may be a Hall sensor. The AF sensor 1430 may be disposed in the inner substrate 1720. The AF sensor 1430 may detect the AF magnet 1410. The AF sensor 1430 may detect movement of the AF magnet 1410. The movement amount or position of the AF magnet 1410 detected by the AF sensor 1430 may be used for feedback of auto focus driving.

The AF sensor 1430 may be a driver IC. The driver IC may comprise a sensing unit. The sensing unit may comprise a Hall IC. The driver IC may be electrically connected to the AF coil 1420. The driver IC may supply current to the AF coil 1420.

The AF sensor 1430 may be disposed inside the AF coil 1420. The AF sensor 1430 may be overlapped with a neutral portion of the AF magnet 1410 in a direction perpendicular to the optical axis. As a modified embodiment, the AF sensor 1430 may be disposed outside the AF coil 1420. The AF sensor 1430 may be overlapped with the AF coil 1420 in an optical axis direction. The AF sensor 1430 may be overlapped with the AF coil 1420 in a direction perpendicular to the optical axis.

The lens driving device 1010 may comprise an AF yoke 1440. The AF yoke 1440 may be disposed at a position corresponding to the AF magnet 1410. An attractive force may act between the AF yoke 1440 and the AF magnet 1410. The contact between the AF guide ball 1810 and the base 1110 and the AF carrier 1210 can be maintained as it is by the attractive force between the AF yoke 1440 and the AF magnet 1410. The AF yoke 1440 may be disposed in the inner substrate 1720. The AF yoke 1440 may be disposed inside the AF coil 1420.

The lens driving device 1010 may comprise an OIS driving part. The OIS driving part may move the OIS moving part 1300 in a direction perpendicular to the optical axis direction. The OIS driving part may move the OIS carrier 1310 in a direction perpendicular to the optical axis. The OIS driving part may move the OIS carrier 1310 in a direction perpendicular to the optical axis through electromagnetic force.

The lens driving device 1010 may comprise an OIS-x driving part 1500. The OIS driving part may comprise an OIS-x driving part 1500. The OIS-x driving part 1500 may move the OIS carrier 1310 in an x-axis direction perpendicular to the optical axis. The OIS-x driving part 1500 may move the OIS carrier 1310 in an x-axis direction perpendicular to the optical axis through electromagnetic force. The OIS-x driving part 1500 may comprise a coil and a magnet.

In a second embodiment of the present invention, the OIS-x magnet 1510 and the OIS-x coil 1520 may move the OIS moving part 1300 in a first direction perpendicular to the optical axis direction. At this time, the first direction may be an x-axis direction. Due to the interaction between the OIS-x coil 1520 and the OIS-x magnet 1510, the OIS carrier 1310 can move in an x-axis direction perpendicular to the optical axis direction. The OIS-x magnet 1510 and the OIS carrier 1310 may integrally move in an x-axis direction.

The lens driving device 1010 may comprise an OIS-x magnet 1510. The OIS driving part may comprise an OIS-x magnet 1510. The OIS-x magnet 1510 may be ‘OIS-x magnet’. The OIS-x magnet 1510 may be a permanent magnet. The OIS-x magnet 1510 may be disposed in the OIS moving part 1300. The OIS-x magnet 1510 may be spaced apart from the AF magnet 1410. The OIS-x magnet 1510 may be disposed in the OIS carrier 1310. The OIS-x magnet 1510 may be disposed on an outer side surface of the OIS carrier 1310. The OIS-x magnet 1510 may be fixed to the OIS carrier 1310. The OIS-x magnet 1510 may be coupled to the OIS carrier 1310. The OIS-x magnet 1510 may be attached to the OIS carrier 1310 with an adhesive. The OIS-x magnet 1510 may be disposed inside the cover 1120. The OIS-x magnet 1510 may interact with the OIS-x coil 1520. The OIS-x magnet 1510 may interact electromagnetically with the OIS-x coil 1520. The OIS-x magnet 1510 may be disposed at a position corresponding to the OIS-x coil 1520. The OIS-x magnet 1510 and the OIS-x coil 1520 may face each other. The OIS-x magnet 1510 may face the OIS-x coil 1520. The OIS-x magnet 1510 may be overlapped with the OIS-x coil 1520 in a direction perpendicular to the optical axis. The OIS-x magnet 1510 may be overlapped with the OIS-x coil 1520 in an x-axis direction. The OIS-x magnet 1510 can move in an x-axis direction perpendicular to the optical axis.

The OIS-x magnet 1510 may be a two-pole magnet. The OIS-x magnet 1510 may comprise a two-pole magnetized magnet. The OIS-x magnet 1510 may comprise an N pole and an S pole.

The lens driving device 1010 may comprise an OIS-x coil 1520. The OIS driving part may comprise an OIS-x coil 1520. The OIS-x coil 1520 may interact with the OIS-x magnet 1510. The OIS-x coil 1520 may move the OIS-x magnet 1510 in an x-axis direction perpendicular to the optical axis. The OIS-x coil 1520 may move the OIS-x magnet 1510 in an x-axis direction through interaction with the OIS-x magnet 1510. The OIS-x coil 1520 may face the OIS-x magnet 1510. The OIS-x coil 1520 and the OIS-x magnet 1510 may face each other. The OIS-x coil 1520 may be disposed at a position corresponding to the OIS-x magnet 1510. The OIS-x coil 1520 may be overlapped with the OIS-x magnet 1510 in a direction perpendicular to the optical axis. The OIS-x coil 1520 may be disposed in the inner substrate 1720. The OIS-x coil 1520 may be disposed in the AF carrier 1210.

In a second embodiment of the present invention, the OIS-x coil 1520 may move together with the AF moving part 1200. The OIS-x coil 1520 may move in an optical axis direction together with the AF moving part 1200. During the AF driving process, the OIS-x coil 1520 may move along with the AF moving part 1200 in an optical axis direction. The OIS-x coil 1520 may be disposed in the AF moving part 1200. The OIS-x coil 1520 may be fixed to the AF moving part 1200. The OIS-x coil 1520 may be coupled to the AF moving part 1200.

The lens driving device 1010 may comprise an OIS-x sensor 1530. The OIS driving part may comprise an OIS-x sensor 1530. The OIS-x sensor 1530 may be disposed in the inner substrate 1720. The OIS-x sensor 1530 may comprise a Hall sensor. The OIS-x sensor 1530 may detect the OIS-x magnet 1510. The OIS-x sensor 1530 may detect the magnetic force of the OIS-x magnet 1510. The OIS-x sensor 1530 may be disposed above the OIS-x magnet 1520. The OIS-x sensor 1530 may be overlapped with the OIS-x magnet 1520 in an optical axis direction. In a modified embodiment, the OIS-x sensor 1530 may be disposed inside the OIS-x coil 1520. The OIS-x sensor 1530 may be overlapped with the OIS-x coil 1520 in an optical axis direction. The OIS-x sensor 1530 may be overlapped with the OIS-x coil 1520 in a direction perpendicular to the optical axis. The OIS-x sensor 1530 may face the OIS-x magnet 1510. The OIS-x sensor 1530 may be disposed at a position corresponding to the OIS-x magnet 1510. The OIS-x sensor 1530 may detect the movement of the OIS-x magnet 1510. The movement amount or position of the OIS-x magnet 1510 detected by the OIS-x sensor 1530 may be used for feedback of hand shake correction driving in an x-axis direction.

The lens driving device 1010 may comprise an OIS-x yoke 1540. The OIS-x yoke 1540 may be disposed in the OIS-x magnet 1510. The OIS-x yoke 1540 may be disposed between the OIS-x magnet 1510 and the OIS carrier 1310. The OIS-x yoke 1540 may enhance the interaction force with the OIS-x coil 1520 by preventing magnetic flux leakage of the OIS-x magnet 1510.

The lens driving device 1010 may comprise an OIS-y driving part 1600. The OIS driving part may comprise an OIS-y driving part 1600. The OIS-y driving part 1600 may move the OIS carrier 1310 in a y-axis direction perpendicular to both the optical axis and the x-axis direction. The OIS-y driving part 1600 may move the OIS carrier 1310 in a y-axis direction perpendicular to both the optical axis and the x-axis direction through electromagnetic force. The OIS-y driving part 1600 may comprise a coil and a magnet.

In a second embodiment of the present invention, the OIS-y magnet 1610 and the OIS-y coil 1620 may move the OIS moving part 1300 in a second direction perpendicular to the optical axis direction and the first direction. At this time, the second direction may be a y-axis direction. Due to the interaction between the OIS-y coil 1620 and the OIS-y magnet 1610, the OIS carrier 1310 can move in a y-axis direction perpendicular to both the optical-axis direction and the x-axis direction. The OIS-y magnet 1610 and the OIS carrier 1310 may move integrally in a y-axis direction. The OIS-y magnet 1610 may be overlapped with the AF magnet 1410 in a second direction. The OIS-y magnet 1610 may be overlapped with the AF magnet 1410 in a y-axis direction.

The lens driving device 1010 may comprise an OIS-y magnet 1610. The OIS-y driving part 1600 may comprise an OIS-y magnet 1610. The OIS-y magnet 1610 may be ‘OIS-y magnet’. The OIS-y magnet 1610 may be a permanent magnet. The OIS-y magnet 1520 may be disposed in the OIS moving part 1300. The OIS-y magnet 1610 may be spaced apart from the OIS-x magnet 1510. The OIS-y magnet 1610 may be spaced apart from the AF magnet 1410. The OIS-y magnet 1610 may be disposed in the OIS carrier 1310. The OIS-y magnet 1610 may be disposed on an outer side surface of the OIS carrier 1310. The OIS-y magnet 1610 may be fixed to the OIS carrier 1310. The OIS-y magnet 1610 may be coupled to the OIS carrier 1310. The OIS-y magnet 1610 may be attached to the OIS carrier 1310 with an adhesive. The OIS-y magnet 1610 may be disposed inside the cover 1120. The OIS-y magnet 1610 may interact with the OIS-y coil 1620. The OIS-y magnet 1610 may interact electromagnetically with the OIS-y coil 1620. The OIS-y magnet 1610 may be disposed at a position corresponding to the OIS-y coil 1620. The OIS-y magnet 1610 and the OIS-y coil 1620 may face each other. The OIS-y magnet 1610 may face the OIS-y coil 1620. The OIS-y magnet 1610 may be overlapped with the OIS-y coil 1620 in a direction perpendicular to the optical axis. The OIS-y magnet 1610 may be overlapped with the OIS-y coil 1620 in a y-axis direction. The OIS-y magnet 1610 may move in a y-axis direction.

The OIS-y magnet 1610 may be a two-pole magnet. The OIS-y magnet 1610 may comprise a two-pole magnetized magnet. The OIS-y magnet 1610 may comprise an N pole and an S pole.

The lens driving device 1010 may comprise an OIS-y coil 1620. The OIS-y driving part 1600 may comprise an OIS-y coil 1620. The OIS-y coil 1620 may interact with the OIS-y magnet 1610. The OIS-y coil 1620 may be disposed at an opposite side of the AF coil 1420 with respect to the optical axis. The OIS-y coil 1620 may move the OIS-y magnet 1610 in a y-axis direction perpendicular to both the optical axis and the x-axis. The OIS-y coil 1620 may move the OIS-y magnet 1610 in a y-axis direction through interaction with the OIS-y magnet 1610. The OIS-y coil 1620 may face the OIS-y magnet 1610. The OIS-y coil 1620 and the OIS-y magnet 1610 may face each other. The OIS-y coil 1620 may be disposed at a position corresponding to the OIS-y magnet 1610. The OIS-y coil 1620 may be overlapped with the OIS-y magnet 1610 in a direction perpendicular to the optical axis. The OIS-y coil 1620 may be disposed in the inner substrate 1720. The OIS-y coil 1620 may be disposed in the AF carrier 1200.

In a second embodiment of the present invention, the OIS-y coil 1620 may move together with the AF moving part 1200. The OIS-y coil 1620 may move in an optical axis direction together with the AF moving part 1200. During the AF driving process, the OIS-y coil 1620 may move along with the AF moving part 1200 in an optical axis direction. The OIS-y coil 1620 may be disposed in the AF moving part 1200. The OIS-y coil 1620 may be fixed to the AF moving part 1200. The OIS-y coil 1620 may be coupled to the AF moving part 1200.

The lens driving device 1010 may comprise an OIS-y sensor 1630. The OIS-y driving part 1600 may comprise an OIS-y sensor 1630. The OIS-y sensor 1630 may be disposed in the inner substrate 1720. The OIS-y sensor 1630 may comprise a Hall sensor. The OIS-y sensor 1630 may detect the OIS-y magnet 1610. The OIS-y sensor 1630 may detect the magnetic force of the OIS-y magnet 1610. The OIS-y sensor 1630 may be disposed above the OIS-y magnet 1620. The OIS-y sensor 1630 may be overlapped with the OIS-y magnet 1620 in an optical axis direction. The OIS-y sensor 1630 may be overlapped with the OIS-y magnet 1620 in a direction perpendicular to the optical axis. In a modified embodiment, the OIS-y sensor 1630 may be disposed inside the OIS-y coil 1620. The OIS-y sensor 1630 may be overlapped with the OIS-y coil 1620 in an optical axis direction. The OIS-y sensor 1630 may face the OIS-y magnet 1610. The OIS-y sensor 1630 may be disposed at a position corresponding to the OIS-y magnet 1610. The OIS-y sensor 1630 may detect the movement of the OIS-y magnet 1610. The movement amount or position of the OIS-y magnet 1610 detected by the OIS-y sensor 1630 may be used for feedback of hand shake correction driving in a y-axis direction.

The lens driving device 1010 may comprise an OIS-y yoke 1640. The OIS-y yoke 1640 may be disposed in the OIS-y magnet 1610. The OIS-y yoke 1640 may be disposed between the OIS-y magnet 1610 and the OIS carrier 1310. The OIS-y yoke 1640 may prevent magnetic flux leakage of the OIS-y magnet 1610 to enhance interaction force with the OIS-y coil 1620.

When viewed from above, the AF magnet 1410, the AF coil 1420, the OIS-y magnet 1610, and the OIS-y coil 1620 may be sequentially disposed on an imaginary straight line. When viewed from an upper surface, the AF magnet 1410, the AF coil 1420, the OIS-y magnet 1610, and the OIS-y coil 1620 may be sequentially disposed on an imaginary straight line. When viewed from above, the AF magnet 1410, the AF coil 1420, the OIS-y magnet 1610, and the OIS-y coil 1620 may be disposed in order. When viewed from above, the AF magnet 1410, the AF coil 1420, the OIS-y magnet 1610, and the OIS-y coil 1620 may be sequentially disposed in a y-axis direction. When viewed from above, the AF magnet 1410, the AF coil 1420, the OIS-y magnet 1610, and the OIS-y coil 1620 may be overlapped in a y-axis direction.

The lens driving device 1010 may comprise substrates 1710 and 1720. The substrates 1710 and 1720 may comprise a flexible printed circuit board (FPCB). The substrates 1710 and 1720 may be electrically connected to the coils 1420, 1520, and 1620. The substrates 1710 and 1720 may be electrically connected to the sensors 1430, 1530, and 1630.

The lens driving device 1010 may comprise an outer substrate 1710. An outer substrate 1710 may be disposed in the base 1110. The outer substrate 1710 may be electrically connected to the coils 1420, 1520, and 1620. The outer substrate 1710 may be electrically connected to the sensors 1430, 1530, and 1630. The outer substrate 1710 may connect the AF carrier 1210 and the base 1110. The outer substrate 1710 may elastically connect the AF carrier 1210 and the base 1110. The outer substrate 1710 may connect the fixed part 1100 and the inner substrate 1720. The outer substrate 1710 may movably support the AF carrier 1210 against the base 1110. The outer substrate 1710 may guide the AF carrier 1210 to move in an optical axis direction against the base 1110. The outer substrate 1710 may comprise a flexible substrate. The outer substrate 1710 may comprise a flexible printed circuit board (FPCB). The outer substrate 1710 may comprise an elastic portion. The outer substrate 1710 may comprise an elastic member. The outer substrate 1710 may comprise an outer side portion 1711 being disposed in the fixed part 1100 and a connection part 1712 being extended from the outer side portion 1711 and coupled to the inner substrate 1720.

The outer substrate 1710 may comprise an outer side portion 1711. The outer side portion 1711 may be disposed in the base 1110. The outer side portion 1711 may be formed to surround the side surface of the base 1110. The outer side portion 1711 may be disposed on three side surfaces of the base 1110. The outer side portion 1711 may comprise two terminal units. The two terminal units may be disposed opposite to each other with respect to the optical axis. The terminal unit may comprise a terminal 1711-1.

The outer substrate 1710 may comprise a terminal 1711-1. The outer side portion 1711 of the outer substrate 1710 may comprise a terminal 1711-1. The terminal 1711-1 may be electrically connected to the terminal 1712-1. The terminal 1711-1 may be disposed in a lower end portion of the base 1110. The terminal 1711-1 may be coupled to the printed circuit board 1050. The terminal 1711-1 may be coupled to a terminal of the printed circuit board 1050 through soldering. The terminal 1711-1 may be coupled to a terminal of the printed circuit board 1050 through a conductive member. The terminal 1711-1 may be connected to a terminal of the printed circuit board 1050. The terminal 1711-1 may be electrically connected to a terminal of the printed circuit board 1050.

The outer substrate 1710 may comprise a connection part 1712. The connection part 1712 may be an ‘extension part’. The connection part 1712 may be a ‘leg part’. The connection part 1712 may be extended from the outer side portion 1711. At least a portion of the connection part 1712 may move along with the AF carrier 1210. The extension part may be extended from the outer side portion 1711. At least a portion of the extension part may move together with the AF carrier 1210. At least a portion of the connection part 1712 may be disposed perpendicular to the optical axis direction. The connection part 1712 of the outer substrate 1710 may be coupled with the inner substrate 1720 so that the inner substrate 1720 can move in an optical axis direction. At least a portion of the connection part 1712 may be disposed parallel to an optical axis direction.

The connection part 1712 may comprise a plurality of connection parts. The connection part 1712 may comprise a first connection part and a second connection part. The second connection part may be disposed under the first connection part.

The outer substrate 1710 may comprise a terminal 1712-1. The connection part 1712 of the outer substrate 1710 may comprise a terminal 1712-1. The terminal 1712-1 may be coupled with the terminal 1721-1 of the inner substrate 1720. The terminal 1712-1 of the outer substrate 1710 may be coupled to the terminal 1721-1 of the inner substrate 1720 through soldering. The terminal 1712-1 of the outer substrate 1710 may be coupled to the terminal 1721-1 of the inner substrate 1720 through a conductive member. The terminal 1712-1 of the outer substrate 1710 may be connected to the terminal 1721-1 of the inner substrate 1720. The terminal 1712-1 of the outer substrate 1710 may be electrically connected to the terminal 1721-1 of the inner substrate 1720.

The outer substrate 1710 may comprise a bent part 1712-2. The bent part 1712-2 may be formed in the connection part 1712. The bent part 1712-2 may be formed in each of the first connection part and the second connection part. The bent part 1712-2 may comprise a shape bent at least twice. The bent part 1712-2 may comprise a shape bent in a U shape. The bent part 1712-2 may have a rounded shape. The bent part 1712-2 may comprise a part disposed parallel to an optical axis.

Hereinafter, one of the ‘terminal 1711-1’ and the ‘terminal 1712-1’ of the outer substrate 1710 may be referred to as a ‘first terminal’, and the other may be referred to as a ‘second terminal’.

The lens driving device 1010 may comprise an inner substrate 1720. The inner substrate 1720 may be electrically connected to the coils 1420, 1520, and 1620. The inner substrate 1720 may be electrically connected to the sensors 1430, 1530, and 1630. The inner substrate 1720 may be disposed in the AF moving part 1200. The inner substrate 1720 may be disposed in the AF carrier 1210. The inner substrate 1720 may be fixed to the AF carrier 1210. The inner substrate 1720 may be coupled to the AF carrier 1210. The inner substrate 1720 may be attached to the AF carrier 1210 with an adhesive. The inner substrate 1720 may comprise a flexible substrate. The inner substrate 1720 may comprise a flexible printed circuit board (FPCB). The inner substrate 1720 may comprise an elastic portion. The inner substrate 1720 may comprise an elastic member.

The inner substrate 1720 may comprise a side plate portion 1721. The side plate portion 1721 may be disposed on a side surface of the AF carrier 1210. The side plate portion 1721 may be disposed on an outer side surface of the AF carrier 1210. In another embodiment, the side plate portion 1721 may be disposed on an inner surface of the AF carrier 1210. The side plate portion 1721 of the inner substrate 1720 may comprise a plurality of portions. The side plate portion 1721 may comprise first to fourth portions.

The inner substrate 1720 may comprise a first portion. The first portion may be disposed in the AF carrier 1210. The AF coil 1420 may be disposed in a first portion of the inner substrate 1720. The AF sensor 1430 may be disposed in a first portion of the inner substrate 1720. The AF yoke 1440 may be disposed on a first portion of the inner substrate 1720.

The inner substrate 1720 may comprise a second portion. The second portion can be placed at an opposite side of the first portion. The second portion may be disposed in the AF carrier 1200. The second portion may be disposed on a second side surface of the AF carrier 1200. The OIS-y coil 1620 may be disposed in a second portion of the inner substrate 1720. The OIS-y sensor 1630 may be disposed in a second portion of the inner substrate 1720. More specifically, the OIS-y sensor 1630 may be disposed in the upper plate portion 1722 which is bent and disposed above a second portion of the inner substrate 1720. The OIS-y sensor 1630 may be disposed on a lower surface of the upper plate portion 1722.

The inner substrate 1720 may comprise a third portion. A third portion may be disposed in the AF carrier 1200. The third portion may be disposed on a third side surface of the AF carrier 1200. The OIS-x coil 1520 may be disposed in a third portion of the inner substrate 1720. The OIS-x sensor 1530 may be disposed in a third portion of the inner substrate 1720. In more detail, the OIS-x sensor 1530 may be disposed in the upper plate portion 1722 bent from an upper side of the third portion of the inner substrate 1720. The OIS-x sensor 1530 may be disposed on a lower surface of the upper plate portion 1722.

The inner substrate 1720 may comprise a fourth portion. The fourth portion may be disposed at an opposite side of the third portion. The fourth portion may be disposed in the AF carrier 1200. The fourth portion may be disposed on a fourth side surface of the AF carrier 1200.

The inner substrate 1720 may comprise a terminal 1721-1. The terminal 1721-1 may be disposed in the fourth portion of the inner substrate 1720. The terminal 1721-1 may be electrically connected to the coils 1420, 1520, and 1620. The terminal 1721-1 may be electrically connected to the sensors 1430, 1530, and 1630.

The lens driving device 1010 may comprise a guide member. The guide member may comprise a ball. The guide member may comprise a pin. The guide member may comprise a cylindrical member. The guide member may guide the movement of the moving part against the fixed part 1100 in a specific direction.

The lens driving device 1010 may comprise an AF guide ball 1810. The AF guide ball 1810 may guide the movement of the AF moving part 1200 against the fixed part 1100 in an optical axis direction. The AF guide ball 1810 may guide the movement of the AF carrier 1210 against the base 1110 in an optical axis direction. The AF guide ball 1810 may be disposed between the fixed part 1100 and the AF moving part 1200. The AF guide ball 1810 may be disposed between the base 1110 and the AF carrier 1210. The AF guide ball 1810 may be disposed between the base 1110 and the AF carrier 1210 in an x direction. Or, the AF guide ball 1810 may be disposed between the base 1110 and the AF carrier 1210 in a y direction. The AF guide ball 1810 may be disposed in a groove of the base 1110. The AF guide ball 1810 may be disposed in a groove of the AF carrier 1210. The AF guide ball 1810 may have a spherical shape. The AF guide ball 1810 may be formed of metal. Grease may be applied to the surface of the AF guide ball 1810.

The AF guide ball 1810 may be disposed at a first corner of the base 1110. The AF guide ball 1810 may be disposed at a second corner in a diagonal direction of the first corner of the base 1110. The AF guide ball 1810 may be disposed at each of the first corner and the second corner of the base 1110. The first corner region and the second corner region of the fixed part 1100 may be disposed in diagonal directions with respect to an optical axis. The AF guide balls 1810 may be disposed in the first corner region and the second corner region of the fixed part 1100. Two sets of AF guide balls 1810 may be disposed at each of the first corner and the second corner of the base 1110. At this time, one set may comprise 4 balls. The two sets may be disposed at an opposite side of the pillar part of the AF carrier 1210 from each other.

When viewed from above, the AF guide ball 1810 may comprise: a first unit ball being disposed in a first corner region of the fixed part 1100; and a second unit ball being disposed in a second corner region disposed in a diagonal direction of the first corner region of the fixed part 1100. At this time, the OIS guide ball 1820 may comprise a third unit ball and a fourth unit ball being spaced apart from each other when viewed from above and disposed between the first unit ball and the second unit ball of the AF guide ball 1810 in a diagonal direction.

When viewed from above, the AF guide ball 1810 may comprise: a first unit ball and a second unit ball being disposed in a first corner region of the fixed part 1100; and a third unit ball and a fourth unit ball being disposed in a second corner region being disposed in a diagonal direction of the first corner region of the fixed part 1100. The AF guide ball 1810 may be disposed in two sets at one corner.

The AF guide ball 1810 may comprise a ball being overlapped with the OIS guide member 1820 in a direction perpendicular to the optical axis direction. At least a portion of the AF guide ball 1810 may be overlapped with the OIS guide member 1820.

The AF guide ball 1810 may comprise an inner ball 1811. The inner ball 1811 may be disposed in the pillar part 1111 of the base 1110. The inner ball 1811 may be disposed in the inner groove 1111-1 of the base 1110. The inner ball 1811 may be disposed in the inner groove 1224-1 of the AF carrier 1210. The inner ball 1811 may be disposed in the inner groove 1224-1 of the AF moving part 1200. The inner ball 1811 may be disposed in the inner groove 1111-1 of the base 1110 and the inner groove 1224-1 of the AF carrier 1210. The inner ball 1811 may be disposed between the inner groove 1111-1 of the base 1110 and the inner groove 1224-1 of the AF carrier 1210. The inner ball 1811 may be disposed between the AF moving part 1200 and the pillar part 1111 of the fixed part 1100.

The AF guide ball 1810 may comprise an outer ball 1812. The outer ball 1812 may be disposed in the outer wall part 1112 of the base 1110. The outer ball 1812 may be disposed in the outer groove 1112-1 of the base 1110. The outer ball 1812 may be disposed in the outer groove 1224-2 of the AF carrier 1210. The outer ball 1812 may be disposed in the outer groove 1112-1 of the base 1110 and the outer groove 1224-2 of the AF carrier 1210. The outer ball 1812 may be disposed between the outer groove 1112-1 of the base 1110 and the outer groove 1224-2 of the AF carrier 1210. The outer ball 1812 may be disposed between the outer groove 1112-1 of the fixed part 1100 and the outer groove 1224-2 of the AF moving part 1200. The outer ball 1812 may be disposed between the AF moving part 1200 and the outer wall part 1112 of the fixed part 1100.

The inner ball 1811 may comprise a plurality of inner balls 1811. The plurality of inner balls 1811 may be disposed in an optical axis direction. The inner ball 1811 may comprise four inner balls 1811. The inner ball 1811 may comprise first to fourth inner balls. Two of the four inner balls 1811 may have a large diameter and the other two may have a small diameter. Two balls with a large diameter can be disposed at an uppermost place and at a lowermost place. That is, two balls with a small diameter may be disposed between the two balls with a large diameter.

The inner ball 1811 may comprise an uppermost inner ball 1811-1. The uppermost inner ball 1811-1 may be disposed at a highest point among the inner balls 1811. The uppermost inner ball 1811-1 may be disposed closest to the upper plate 1121 of the cover 1120 among the inner balls 1811. The inner ball 1811 may comprise a lowermost inner ball 1811-2. The lowermost inner ball 1811-2 may be disposed at a lowest point among the inner balls 1811. The lowermost inner ball 1811-2 may be disposed closest to the lower plate portion of the base 1110 among the inner balls 1811. The plurality of inner balls 1811 may comprise balls having a smaller diameter than each of the uppermost inner ball 1811-1 and the lowermost inner ball 1811-2. The plurality of inner balls 1811 may comprise balls being disposed between the uppermost inner ball 1811-1 and the lowermost inner ball 1811-2.

The outer ball 1812 may comprise a plurality of outer balls 1812. The plurality of outer balls 1812 may be disposed in an optical axis direction. The outer ball 1812 may comprise four outer balls 1812. The outer ball 1812 may comprise first to fourth outer balls. Two of the four outer balls 1812 may have a large diameter and the other two may have a small diameter. Two balls with a large diameter can be disposed at an uppermost place and at a lowermost place. That is, two balls with a small diameter may be disposed between the two balls with a large diameter.

The outer ball 1812 may comprise an uppermost outer ball 1812-1. The uppermost outer ball 1812-1 may be disposed at a highest point among the outer balls 1812. The uppermost outer ball 1812-1 may be disposed closest to the upper plate 1121 of the cover 1120 among the outer balls 1812. The outer ball 1812 may comprise a lowermost outer ball 1812-2. The lowermost outer ball 1812-2 may be disposed at a lowest point among the outer balls 1812. The lowermost outer ball 1812-2 may be disposed closest to a lower plate portion of the base 1110 among the outer balls 1812. The plurality of outer balls 1812 may comprise balls having a smaller diameter than each of the uppermost outer ball 1812-1 and the lowermost outer ball 1812-2. The plurality of outer balls 1812 may comprise balls being disposed between the uppermost outer ball 1812-1 and the lowermost outer ball 1812-2.

The AF guide ball 1810 may comprise a plurality of balls being disposed in an optical axis direction. At this time, the plurality of balls may comprise uppermost balls 1811-1 and 1812-1 being disposed at a highest point and lowermost balls 1811-2 and 1812-2 being disposed at a lowest point. The height of the point where the elastic member 1920 presses the plate member 1910 may be disposed between the heights of the uppermost balls 1811-1 and 1812-1 and the heights of the lowermost balls 1811-2 and 1812-2.

The lens driving device 1010 may comprise an OIS guide ball 1820. The OIS guide ball 1820 may guide the movement of the OIS carrier 1310 against the AF carrier 1210 in a direction perpendicular to the optical axis. The OIS guide ball 1820 may be disposed between the AF moving part 1200 and the OIS moving part 1300. The OIS guide ball 1820 may be disposed between the AF carrier 1210 and the OIS carrier 1310. The OIS guide ball 1820 may be disposed between the AF carrier 1210 and the OIS carrier 1310 in an optical axis direction.

The OIS guide ball 1820 may be disposed between the pre-pressurizing member 1230 of the AF carrier 1210 and the OIS carrier 1310. The OIS guide ball 1820 may be pressed between the AF carrier 1210 and the OIS carrier 1310 by the pressing force of the elastic members 1830, 1840, and 1850. The pre-pressurizing member 1230 may press the OIS guide ball 1820 downward while being coupled to the holder member 1220. The pre-pressurizing member 1230 may press the OIS guide ball 1820 in a direction of the OIS carrier 1310 while being coupled to the holder member 1220. At this time, the OIS carrier 1310 may press the OIS guide ball 1820 in a direction of the pre-pressurizing member 1230 by the restoring force of the elastic members 1830, 1840, and 1850. Accordingly, the OIS guide ball 1820 may be pressed between the pre-pressurizing member 1230 and the OIS carrier 1310.

The OIS guide ball 1820 may guide the movement of the OIS moving part 1300 in an x-axis direction and a y-axis direction. The OIS guide ball 1820 may guide the OIS carrier 1310 to move in an x-axis direction and a y-axis direction perpendicular to the optical axis direction against the AF carrier 1210. That is, the OIS guide ball 1820 may guide the OIS carrier 1310 to move in an x-axis direction and a y-axis direction. In other words, the OIS guide ball 1820 may guide movement in both the x-axis direction and the y-axis direction. For reference, compared to the comparative example in which a ball for guiding an x-axis direction and a ball for guiding a y-axis direction are separately provided, a ball for guiding an x-axis direction and a ball for guiding a y-axis direction are integrally provided. In a second embodiment, the size of the lens driving device 1010 can be minimized. In particular, the height of the lens driving device 1010 in an optical axis direction may be reduced. Through this, the height being protruded from the smartphone, that is, the shoulder height can be minimized. The OIS guide ball 1820 may comprise a plurality of balls. The OIS guide ball 1820 may comprise four balls.

As a modified embodiment, the OIS guide ball 1820 may separately provide a ball for guiding driving in an x-axis direction and a ball for guiding driving in a y-axis direction.

The lens driving device 1010 may comprise an elastic member. The elastic member may be formed to support the OIS driving. The elastic member may support the movement of the OIS moving part 1300. The elastic member may be formed to press the OIS guide member 1820. The elastic member may be formed to guide both the OIS-x-axis driving and the OIS-y-axis driving only with the OIS guide member 1820. The elastic member may comprise a leaf spring. The elastic member may comprise a wire. The elastic member may have elasticity. The elastic member may be formed of metal.

The first support member may be disposed between the fixed part 1100 and the AF moving part 1200. The first support member may guide the AF moving part 1200 to move in an optical axis direction. The second support member may be disposed between the AF moving part 1200 and the OIS moving part 1300. The second support member may guide the OIS moving part 1300 to move in a direction perpendicular to the optical axis direction. One side of the third support member may be coupled to the AF moving part 1200 and the other side may be coupled to the OIS moving part 1300.

The AF moving part 1200 may comprise a first elastic member. The OIS moving part 1300 may comprise a second elastic member. The third support member may couple the first elastic member and the second elastic member. The third support member may comprise a wire 1850.

The lens driving device 1010 may comprise an upper elastic member 1830. The upper elastic member 1830 may be an ‘upper spring’. The upper elastic member 1830 may be a leaf spring. The upper elastic member 1830 may have elasticity. The upper elastic member 1830 may be disposed in the OIS moving part 1300. The upper elastic member 1830 may be coupled to the OIS moving part 1300. The upper elastic member 1830 may be connected to the OIS moving part 1300. The upper elastic member 1830 may be disposed on an upper surface of the OIS moving part 1300. The upper elastic member 1830 may be disposed on an upper surface of the OIS carrier 1310. The upper elastic member 1830 may be disposed in the OIS carrier 1310. The upper elastic member 1830 may be disposed at an upper portion of the OIS carrier 1310. The upper elastic member 1830 may be disposed above the OIS carrier 1310. The upper elastic member 1830 may be disposed perpendicular to the optical axis.

The upper elastic member 1830 may comprise an inner side portion 1831. The inner side portion 1831 may be coupled to the OIS moving part 1300. The upper elastic member 1830 may comprise an outer side portion 1832. The outer side portion 1832 may be coupled to the wire 1850. The upper elastic member 1830 may comprise a connection part 1833. The connection part 1833 may connect the inner side portion 1831 and the outer side portion 1832. The connection part 1833 may elastically connect the inner side portion 1831 and the outer side portion 1832. The connection part 1833 may comprise elasticity. The connection part 1833 may be an elastic part.

An inner side portion 1831 of the upper elastic member 1830 may be disposed lower than an outer side portion 1832. The inner side portion 1831 of the upper elastic member 1830 may be disposed lower than the outer side portion 1832 by a first distance. The reason why the inner side portion 1831 of the upper elastic member 1830 is lower than the outer side portion 1832 may be due to the pressing force of the pre-pressurizing member 1230. Through this structure, the OIS guide member 1820 can be maintained as it is in contact with the pre-pressurizing member 1230 of the AF carrier 1210 and the OIS carrier 1310.

The lens driving device 1010 may comprise a lower elastic member 1840. The lower elastic member 1840 may be a ‘terminal on a lower surface of the housing’ or a ‘plate on a lower surface of the housing’. The lower elastic member 1840 may be a leaf spring. The lower elastic member 1840 may have elasticity. The lower elastic member 1840 may be disposed in the AF moving part 1200. The lower elastic member 1840 may be coupled to the AF moving part 1200. The lower elastic member 1840 may be connected to the AF moving part 1200. The lower elastic member 1840 may be disposed on a lower surface of the AF moving part 1200. The lower elastic member 1840 may be disposed on a lower surface of the AF carrier 1210. The lower elastic member 1840 may be disposed in the AF carrier 1210. The lower elastic member 1840 may be disposed at a lower portion of the AF carrier 1210. The lower elastic member 1840 may be disposed below the AF carrier 1210. The lower elastic member 1840 may be disposed perpendicular to the optical axis.

The lower elastic member 1840 may comprise an outer side portion 1841. The outer side portion 1841 may be coupled with the AF moving part 1200. The lower elastic member 1840 may comprise an inner side portion 1842. The inner side portion 1842 may be coupled to the wire 1850. The lower elastic member 1840 may comprise a connection part 1843. The connection part 1843 may connect the outer side portion 1841 and the inner side portion 1842. The connection part 1843 may elastically connect the outer side portion 1841 and the inner side portion 1842. The connection part 1843 may comprise elasticity. The connection part 1843 may be an elastic part.

The lens driving device 1010 may comprise a wire 1850. The wire 1850 may be a ‘side elastic member’. The wire 1850 may be a wire. The wire 1850 may be a wire spring. The wire 1850 may be a suspension wire. The wire 1850 may have elasticity. The wire 1850 may connect the upper elastic member 1830 and the lower elastic member 1840. The wire 1850 may elastically connect the upper elastic member 1830 and the lower elastic member 1840. The wire 1850 may be disposed parallel to an optical axis. The wire 1850 may be disposed in an optical axis direction.

The height of the point where the elastic member 1920 presses the plate member 1910 is lower than the height of the ball being disposed lower among the uppermost inner ball 1811-1 and the uppermost outer ball 1812-1, and may be higher than the height of the ball being disposed higher among the lowermost inner ball 1811-1 and the lowermost outer ball 1812-2. More specifically, as shown in FIG. 77(a), when the AF moving part 1200 moves upward, the height b of the point where the elastic member 1920 presses the plate member 910 may be higher than the height a of the ball being disposed higher among the lowermost inner ball 1422 and the lowermost outer ball 1412. A gap c may exist at a height between the two points. In addition, as shown in FIG. 77(b), when the AF moving part 1200 moves downward, the height e of the point where the elastic member 1920 presses the plate member 1910 may be lower than the height d of the ball being disposed lower among the uppermost inner ball 1421 and the uppermost outer ball 1411. A gap f may exist at a height between the two points. Through this, generation of a moment generated when the elastic member 1920 presses the plate member 1910 may be prevented or minimized. That is, a phenomenon in which the plate member 1910 is tilted or separated may be prevented.

The lens driving device 1010 may comprise a pressing member. The pressing member may be an ‘AF guide ball pressing member’. The pressing member may press the AF guide ball 1810. The pressing member may be formed to press a ball. The AF guide ball 1810 pressed by the pressing member may be held between the fixed part 1100 and the AF moving part 1200. The AF guide ball 1810 pressed by the pressing member may be held between the base 1110 and the AF carrier 1210. The pressing member may maintain the AF guide ball 1810 as it is in contact with the fixed part 1100 and the AF moving part 1200. The pressing member may maintain the AF guide ball 1810 as it is in contact with the base 1110 and the AF carrier 1210.

The lens driving device 1010 may comprise a plate member 1910. The pressing member may comprise a plate member 1910. The plate member 1910 may be disposed in the AF guide ball 1810. The plate member 1910 may be in contact with the AF guide ball 1810. The plate member 1910 may be disposed in the elastic member 1920. The plate member 1910 may be disposed in the base 1110. The plate member 1910 may be disposed between the elastic member 1920 and the AF guide ball 1810. The plate member 1910 may press the AF guide ball 1810 toward the AF carrier 1210 by the elastic member 1920. The plate member 1910 may be disposed between the AF guide ball 1810 and the fixed part 1100. The plate member 1910 may be disposed between the inner ball 1811 and the pillar part 1111 of the fixed part 1100.

The lens driving device 1010 may comprise an elastic member 1920. The pressing member may comprise an elastic member 1920. The elastic member 1920 may be a spring. The elastic member 1920 may be a tapered spring. The elastic member 1920 may be disposed in the fixed part 1100. The elastic member 1920 may press the AF guide ball 1810 toward the AF moving part 1200. The elastic member 1920 may press the plate member 1910 toward the AF guide ball 1810. The elastic member 1920 may be disposed between the plate member 1910 and the fixed part 1100. The elastic member 1920 may push the plate member 1910 against the fixed part 1100. The elastic member 1920 may press the plate member 1910 in an opposite direction to the fixed part 1100. The elastic member 1920 may be disposed between the plate member 1910 and the pillar part 1111 of the fixed part 1100. The elastic member 1920 may be disposed in the inner groove 1111-1 of the fixed part 1100.

The elastic member 1920 may press the AF guide ball 1810 to be supported by the fixed part 1100. The elastic member 1920 may press the inner ball 1811 to be supported by the fixed part 1100. The elastic member 1920 may press the outer ball 1812 to be supported by the fixed part 1100.

As a modified embodiment, the elastic member 1920 may be disposed in the AF moving part 1200. At this time, the elastic member 1920 may press the AF guide ball 1810 toward the fixed part 1100. The elastic member 1920 may be disposed in one of the fixed part 1100 and the AF moving part 1200 to press the AF guide ball 1810 toward the other one of the fixed part 1100 and the AF moving part 1200. The elastic member 1920 may press the plate member 1910. The elastic member 1920 may be disposed between the plate member 1910 and the base 1110. The elastic member 1920 may be disposed between the AF guide ball 1810 and the base 1110. The elastic member 1920 may be disposed in the base 1110. The elastic member 1920 may be disposed in the inner groove 1111-1 of the base 1110. The elastic member 1920 may press the AF guide ball 1810 toward the AF carrier 1210. Through this, the AF guide ball 1810 can maintain a contact state between the plate member 1910 and the AF carrier 1210.

The elastic member 1920 may comprise a bent part. The bent part may comprise a bent shape. The bent part may comprise a plurality of bent parts. The bent part may comprise three bent parts. The elastic member 1920 may be bent at least three times. The elastic member 1920 may comprise an upper bent part 1921. The elastic member 1920 may comprise a lower bent part 1922. The elastic member 1920 may comprise a connection bent part 1923. The connection bent part 1923 may be disposed between the upper bent part 1921 and the lower bent part 1922. The upper bent part 1921 may form an obtuse angle. The lower bent part 1922 may form an obtuse angle. The connection bent part 1923 may form an obtuse angle. The upper bent part 1921 may be disposed in the fixed part 1100. The lower bent part 1922 may be disposed in the fixed part 1100. The connection bent part 1923 may be disposed in the plate member 1910. Through this structure, the elastic member 1920 may push the plate member 1910 against the fixed part 1100. The connection bent part 1923 may be in contact with the plate member 1910 and press the plate member 1910 toward the AF guide ball 1810.

The lens driving device 1010 may comprise a reinforcing member 1930. The reinforcing member 1930 may be disposed in the base 1110. The reinforcing member 1930 may be disposed to reinforce the strength of the base 1110. The reinforcing member 1930 may prevent damage to the base 1110. The reinforcing member 1930 can prevent the pillar part 1111 of the base 1110 from damages. The reinforcing member 1930 may prevent the outer wall part 1112 of the base 1110 from damages. The reinforcing member 1930 may have elasticity. The reinforcing member 1930 may be formed of metal. The reinforcing member 1930 may comprise a shape bent at least twice. The reinforcing member 1930 may be formed in the shape of a symbol ‘⊂’ when viewed from above. The reinforcing member 1930 may be opened inward.

The reinforcing member 1930 may comprise an inner side portion 1931. The inner side portion 1931 may be disposed at an opposite surface of the inner groove 1111-1 of the pillar part 1111 of the fixed part 1100. The reinforcing member 1930 may comprise an outer side portion 1932. The outer side portion 1932 may be disposed at an opposite surface of the outer groove 1112-1 of the outer wall part 1112 of the fixed part 1100. The reinforcing member 1930 may comprise a connection part 1933. The connection part 1933 may connect the inner side portion 1931 and the outer side portion 1932.

The lens driving device 1010 may comprise a cover 1940. The cover 1940 may be disposed above the AF guide ball 1810. The cover 1940 may be overlapped with the AF guide ball 1810 in an optical axis direction. The cover 1940 may be overlapped with the inner ball 1811 in an optical axis direction. The cover 1940 may be overlapped with the outer ball 1812 in an optical axis direction. The cover 1940 may be disposed on the inner groove 1224-1 and the outer groove 1224-2 of the AF carrier 1210 to prevent the AF guide ball 1810 from escaping upward.

Hereinafter, a component of a lens driving device according to a modified embodiment will be described with reference to drawings.

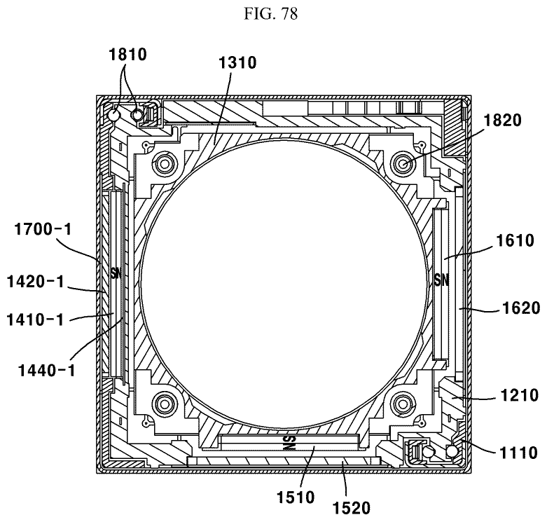

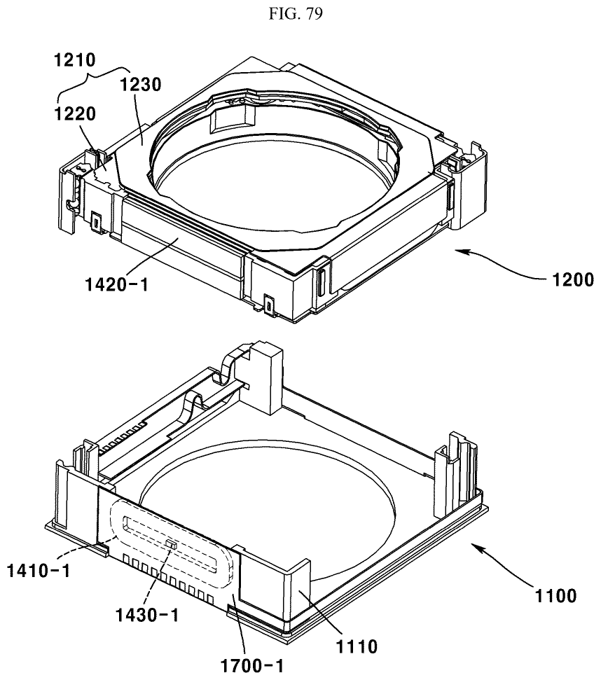

FIG. 78 is a cross-sectional view of a lens driving device according to a modified embodiment cut in a direction perpendicular to an optical axis and viewed from above; and FIG. 79 is an exploded perspective view of some components of a lens driving device according to a modified embodiment.

A lens driving device according to a modified embodiment may comprise an AF driving part 1400. In a modified embodiment, compared to a second embodiment of the present invention, the positions of the AF coil 1420-1 and the AF magnet 1410-1 may be reversed. That is, in a modified embodiment, the AF coil 1420-1 may be disposed on the fixed part 1100 and the magnet 1410-1 may be disposed on the AF moving part 1200.

The lens driving device may comprise an AF magnet 1410-1. The AF driving part 1400 may comprise an AF magnet 1410-1. The AF magnet 1410-1 may be disposed in the AF moving part 1200. The AF magnet 1410-1 may be disposed in the AF carrier 1210. The AF magnet 1410-1 may be disposed between the AF coil 1420-1 and the AF carrier 1210. The AF magnet 1410-1 may be disposed inside the AF coil 1420-1. The AF magnet 1410-1 may be overlapped with the AF coil 1420-1 in a direction perpendicular to the optical axis. The AF magnet 1410-1 may face the AF coil 1420-1. The AF magnet 1410-1 and the AF coil 1420-1 may face each other. The AF magnet 1410-1 may be disposed at a position corresponding to the AF coil 1420-1. The AF magnet 1410-1 may interact with the AF coil 1420-1. The AF magnet 1410-1 may interact electromagnetically with the AF coil 1420-1. The AF magnet 1410-1 may be movable. The AF magnet 1410-1 may be movably disposed. The AF magnet 1410-1 may move during AF operation. The AF magnet 1410-1 may move together with the AF carrier 1210. The AF magnet 1410-1 can move in an optical axis direction.

The lens driving device may comprise an AF coil 1420-1. The AF driving part 1400 may comprise an AF coil 1420-1. The AF coil 1420-1 may be disposed in the substrate 1700-1. The AF coil 1420-1 may be disposed in the fixed part 1100. The AF coil 1420-1 may be disposed in the base 1110. The AF coil 1420-1 may be disposed in the cover 1120. The AF coil 1420-1 may be disposed outside the AF magnet 1410-1. The AF coil 1420-1 may be disposed between the side plate 1122 of the cover 1120 and the AF magnet 1410-1. The AF coil 1420-1 may be fixed. The AF coil 1420-1 can be maintained in a fixed state even during AF driving.

The lens driving device may comprise an AF sensor 1430-1. The AF driving part 1400 may comprise an AF sensor 1430-1. The AF sensor 1430-1 may detect the AF magnet 1410-1. The AF sensor 1430-1 may be disposed in the substrate 1700-1. The AF sensor 1430-1 may be disposed inside the AF coil 1420-1. The AF sensor 1430-1 may be a Hall sensor. The movement amount or position of the AF magnet 1410-1 detected by the AF sensor 1430-1 may be used for feedback of auto focus driving.

The lens driving device may comprise an AF yoke 1440-1. The AF driving part 1400 may comprise an AF yoke 1440-1. The AF yoke 1440-1 may be disposed at a position corresponding to the AF magnet 1410-1. The AF yoke 1440-1 may be disposed in the AF magnet 1410-1. The AF yoke 1440-1 may be disposed between the magnet 1320 and the AF carrier 1210. The AF yoke 1440-1 may be disposed on an inner surface of the AF magnet 1410-1. An outer surface of the AF magnet 1410-1 may face the AF coil 1420-1. Through this, the AF yoke 1440-1 can increase electromagnetic interaction force between the AF magnet 1410-1 and the AF coil 1420-1 by minimizing leakage flux of the AF magnet 1410-1.

The lens driving device may comprise a substrate 1700-1. The substrate 1700-1 may be disposed in the fixed part 1100. The substrate 1700-1 may be disposed in the base 1110. The substrate 1700-1 may be disposed in the cover 1120. The substrate 1700-1 may be disposed in the side plate 1122 of the cover 1120. The substrate 1700-1 may be disposed on an inner surface of the side plate 1122 of the cover 1120. The substrate 1700-1 may be disposed on an outer surface of the side plate 1122 of the cover 1120. The substrate 1700-1 may be disposed parallel to an optical axis. An AF coil 1420-1 and an AF sensor 1430-1 may be disposed in the substrate 1700-1. The substrate 1700-1 may comprise a printed circuit board. The substrate 1700-1 may comprise a flexible printed circuit board (FPCB).

A lens driving device according to a modified embodiment may comprise any one or more among: a fixed part 1100; an AF moving part 1200; an OIS moving part 1300; an OIS-x driving part 1500; an OIS-y driving part 1600; substrates 1710 and 1720; balls 1810 and 1820; elastic members 1830, 1840, and 1850; a plate member 1910; an elastic member 1920; a reinforcing member 1930; and a cover 1940. At this time, for the descriptions on: the fixed part 1100; the AF moving part 1200; the OIS moving part 1300; the OIS-x driving part 1500; the OIS-y driving part 1600; the substrates 1710 and 1720; the balls 1810 and 1820; the elastic members 1830, 1840, and 1850; the plate member 1910; the elastic member 1920; the reinforcing member 1930; and the cover 1940, the descriptions on the corresponding components in the second embodiment of the present invention may be applied by analogy.

There are advantages in that the second embodiment and the modified embodiment of the present invention have no centering force in an optical axis direction of the yoke compared to the comparative example in which the ball is pressed through the attractive force between the yoke and the magnet using a tapered spring. In addition, by arranging the AF guide balls 1810 diagonally, it is possible to prevent the AF moving part 1200 from rotating or tilting and to secure necessary adhesion. However, as a modified embodiment, both two sets of AF guide balls 1810 may be disposed on one side of the fixed part 1100, not in a diagonal direction. As another modified embodiment, the AF guide ball 1810 may be used as a shaft structure to minimize the tilt of the module, that is, the AF moving part 1200.

Hereinafter, auto focus (AF) driving of the lens driving device according to a second embodiment of the present invention will be described with reference to the drawings.

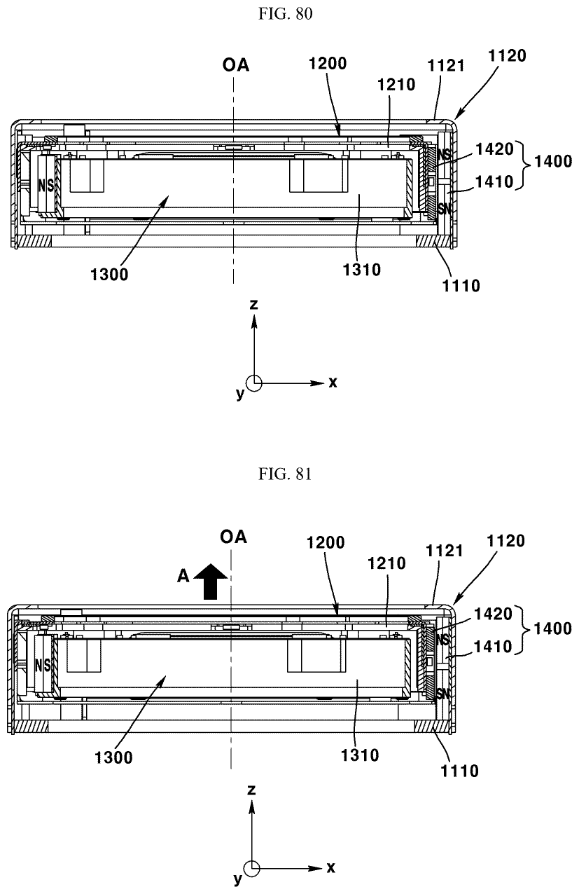

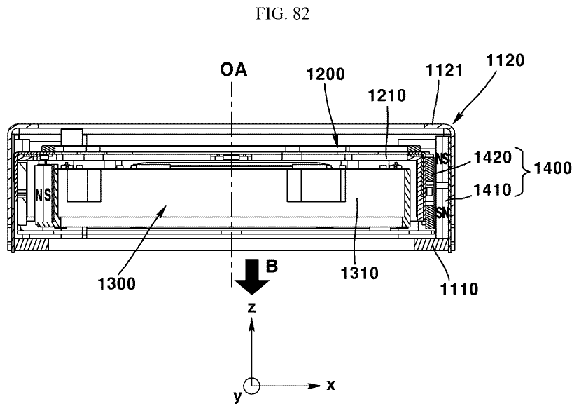

FIGS. 80 to 82 are views for explaining auto focus driving of a lens driving device according to a second embodiment of the present invention. FIG. 80 is a cross-sectional view illustrating the appearance of a moving part in an initial state in which no current is applied to an AF coil. FIG. 81 is a cross-sectional view illustrating a state in which a moving part moves upward in an optical axis direction when a forward current is applied to an AF coil. FIG. 82 is a cross-sectional view illustrating how a moving part moves downward in an optical axis direction when a reverse current is applied to an AF coil.

As illustrated in FIG. 80, the moving part may be disposed at a position spaced apart from both the upper plate 1121 of the cover 1120 and the base 1110 in an initial position where no current is applied to the AF coil 1420. At this time, the moving part may be the AF moving part 1200. In addition, the moving part may comprise an AF moving part 1200 and an OIS moving part 1300.

When a forward current is applied to the AF coil 1420, the AF coil 1420 may move upward in an optical axis direction due to electromagnetic interaction between the AF coil 1420 and the AF magnet 1410 (see A in FIG. 81). At this time, the AF carrier 1210 together with the AF coil 1420 may move upward in an optical axis direction. Furthermore, the OIS carrier 1310 and the lens together with the AF carrier 1210 may move upward in an optical axis direction. Accordingly, the distance between the lens and the image sensor is changed so that the focus of an image formed on the image sensor through the lens can be adjusted.

When a reverse current is applied to the AF coil 1420, the AF coil 1420 may move downward in an optical axis direction due to electromagnetic interaction between the AF coil 1420 and the AF magnet 1410 (see B in FIG. 82). At this time, the AF carrier 1210 together with the AF coil 1420 may move downward in an optical axis direction. Furthermore, the OIS carrier 1310 and the lens together with the AF carrier 1210 may move downward in an optical axis direction. Accordingly, the distance between the lens and the image sensor is changed so that the focus of an image formed on the image sensor through the lens can be adjusted.

Meanwhile, during the movement of the AF coil 1420, the AF sensor 1430 moves together with the AF coil 1420 and detects the strength of the magnetic field of the AF magnet 1410 to detect the amount or position of the lens in an optical axis direction. The movement amount or position of the lens in an optical axis direction detected by the AF sensor 1430 may be used for autofocus feedback control.

Hereinafter, optical image stabilization (OIS) driving of the lens driving device according to a second embodiment of the present invention will be described with reference to the drawings.

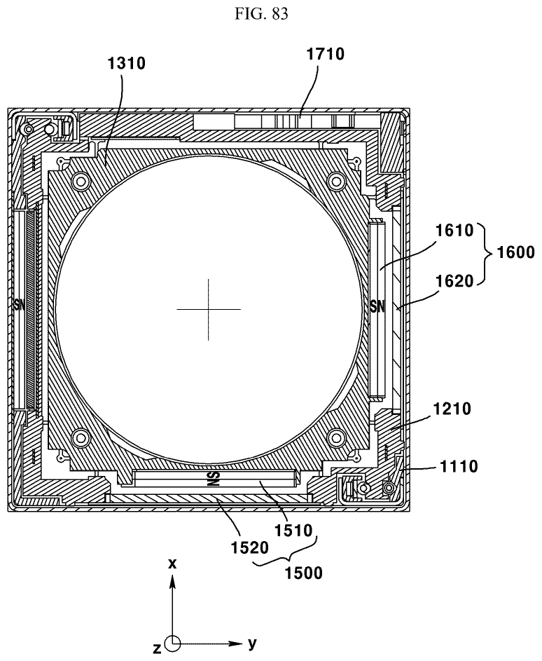

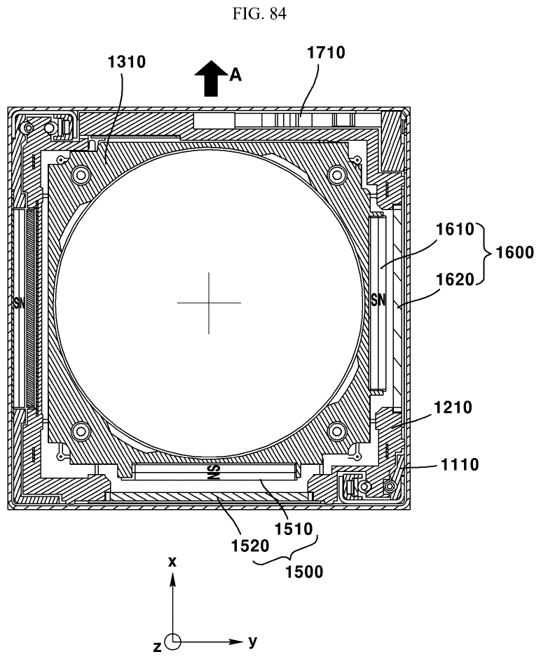

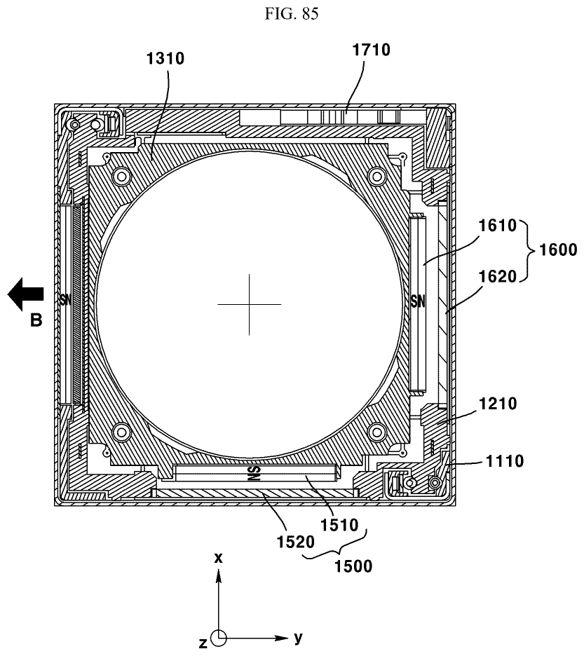

FIGS. 83 to 85 are views for explaining hand shake compensation driving of the lens driving device according to a second embodiment of the present invention. FIG. 83 is a cross-sectional view illustrating the appearance of the OIS moving part in an initial state in which no current is applied to an OIS-x coil and an OIS-y coil. FIG. 84 is a cross-sectional view illustrating a state in which an OIS moving part moves in an x-axis direction perpendicular to an optical axis as current is applied to an OIS-x coil. FIG. 85 is a cross-sectional view illustrating a state in which a current is applied to an OIS-y coil so that an OIS moving part moves in a y-axis direction perpendicular to both the optical axis and the x-axis.

As illustrated in FIG. 83, the moving part may be disposed at an initial position in a state in which no current is applied to an OIS-x coil 1520 and an OIS-y coil 1620. At this time, the moving part may be the OIS moving part 1300.

When a current is applied to the OIS-x coil 1520, the OIS-x magnet 1510 may move in an x-axis direction perpendicular to the optical axis due to electromagnetic interaction between the OIS-x coil 1520 and the OIS-x magnet 1510 (see A in FIG. 84). At this time, the OIS carrier 1310 together with the OIS-x magnet 1510 may move in an x-axis direction. Furthermore, the lens may move in an x-axis direction together with the OIS carrier 1310. More specifically, when a forward current is applied to the OIS-x coil 1520, the OIS-x magnet 1510, the OIS carrier 1310, and the lens may move in one direction on the x-axis. In addition, when a reverse current is applied to the OIS-x coil 1520, the OIS-x magnet 1510, the OIS carrier 1310, and the lens may move in another direction on the x-axis.

When current is applied to the OIS-y coil 1620, due to the electromagnetic interaction between the OIS-y coil 1620 and the OIS-y magnet 1610, the OIS-y magnet 1610 can move in a y-axis direction perpendicular to the optical axis (see B in FIG. 85). At this time, the OIS carrier 1310 together with the OIS-y magnet 1610 may move in a y-axis direction. Furthermore, the lens may move in a y-axis direction together with the OIS carrier 1310. More specifically, when a forward current is applied to the OIS-y coil 1620, the OIS-y magnet 1610, the OIS carrier 1310, and the lens may move in one direction on the y-axis. In addition, when a reverse current is applied to the OIS-y coil 1620, the OIS-y magnet 1610, the OIS carrier 1310, and the lens may move in another direction on the y-axis.

Meanwhile, the OIS-x sensor 1530 may detect the amount or position of the OIS-x magnet 1510 by detecting the strength of the magnetic field of the OIS-x magnet 1510. The movement amount or position detected by the OIS-x sensor 1530 may be used for feedback control for hand shake compensation in an x-axis direction. The OIS-y sensor 1630 may detect the movement amount or position of the OIS-y magnet 1610 by detecting the strength of the magnetic field of the OIS-y magnet 1610. The movement amount or position detected by the OIS-y sensor 1630 may be used for hand shake compensation feedback control in a y-axis direction.

Hereinafter, a camera device according to a second embodiment of the present invention will be described with reference to the drawings.

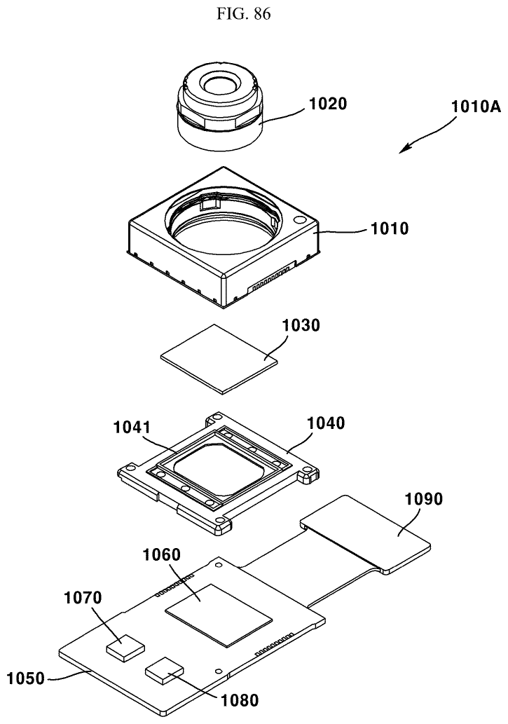

FIG. 86 is an exploded perspective view of a camera device according to a second embodiment of the present invention.

The camera device 1010A may comprise a camera module.

The camera device 1010A may comprise a lens module 1020. The lens module 20 may comprise at least one lens. The lens may be disposed at a position corresponding to the image sensor 1060. The lens module 1020 may comprise a lens and a barrel. The lens module 1020 may be coupled to the OIS carrier 1310 of the lens driving device 1010. The lens module 1020 may be coupled to the OIS carrier 1310 by screw-coupling and/or adhesive. The lens module 1020 may move integrally with the OIS carrier 1310.

The camera device 1010A may comprise a filter 1030. The filter 1030 may serve to block light of a specific frequency band from entering the image sensor 1060 from light passing through the lens module 1020. The filter 1030 may be disposed parallel to an x-y plane. The filter 1030 may be disposed between the lens module 1020 and the image sensor 1060. The filter 1030 may be disposed in the sensor base 1040. In a modified embodiment, the filter 1030 may be disposed in base 1110. The filter 1030 may comprise an infrared filter. The infrared filter may block light of an infrared region from being incident on the image sensor 1060.

The camera device 1010A may comprise a sensor base 1040. The sensor base 1040 may be disposed between the lens driving device 1010 and the printed circuit board 1050. The sensor base 1040 may comprise a protruding part 1041 in which the filter 1030 is disposed. An opening may be formed in a portion of the sensor base 1040 where the filter 1030 is disposed so that light passing through the filter 1030 may be incident to the image sensor 1060. The adhesive member may couple or attach the base 1110 of the lens driving device 1010 to the sensor base 1040. The adhesive member may additionally serve to prevent foreign substances from entering the lens driving device 1010. The adhesive member may comprise any one or more of an epoxy, a thermosetting adhesive, and an ultraviolet curable adhesive.

The camera device 1010A may comprise a printed circuit board (PCB) 1050. The printed circuit board 1050 may be a substrate or a circuit board. The lens driving device 1010 may be disposed on the printed circuit board 1050. A sensor base 1040 may be disposed between the printed circuit board 1050 and the lens driving device 1010. The printed circuit board 1050 may be electrically connected to the lens driving device 1010. An image sensor 1060 may be disposed on the printed circuit board 1050. The printed circuit board 1050 may comprise various circuits, elements, and control units to convert an image formed by the image sensor 1060 into an electrical signal and transmit the converted electrical signal to an external device.

The camera device 1010A may comprise an image sensor 1060. The image sensor 1060 may be a component in which the light passing through the lens and the filter 1030 is incident to form an image. The image sensor 60 may be mounted on the printed circuit board 50. The image sensor 60 may be electrically connected to the printed circuit board 50. For an example, the image sensor 60 may be coupled to the printed circuit board 50 by a surface mounting technology (SMT). As another example, the image sensor 60 may be coupled to the printed circuit board 50 using a flip chip technology. The image sensor 60 may be disposed such that an optical axis coincides with a lens. That is, the optical axis of the image sensor 60 and the optical axis of the lens may be aligned. The image sensor 60 may convert light being irradiated onto an effective image region of the image sensor 60 into an electrical signal. The image sensor 60 may be any one among a charge coupled device (CCD), a metal oxide semi-conductor (MOS), a CPD, and a CID.

The camera device 1010A may comprise a motion sensor 1070. The motion sensor 1070 may be mounted on a printed circuit board 1050. The motion sensor 1070 may be electrically connected to a control unit 1080 through a circuit pattern provided on the printed circuit board 1050. The motion sensor 1070 may output rotational angular velocity information due to the movement of the camera module. The motion sensor 1070 may comprise a 2-axis or 3-axis gyro sensor or an angular velocity sensor.

The camera device 1010A may comprise a control unit 1080. The control unit 1080 may be disposed in the printed circuit board 1050. The control unit 1080 may be electrically connected to the coil 1130 of the lens driving device 1010. The control unit 1080 may individually control the direction, intensity, and amplitude of current supplied to the coil 1130. The control unit 1080 may perform an auto focus function and/or a hand shake correction function by controlling the lens driving device 1010. Furthermore, the control unit 1080 may perform autofocus feedback control and/or hand shake correction feedback control for the lens driving device 1010.

The camera device 1010A may comprise a connector 1090. The connector 1090 may be electrically connected to the printed circuit board 1050. The connector 1090 may comprise a port for being electrically connected to an external device.

Hereinafter, an optical apparatus according to a second embodiment of the present invention will be described with reference to the drawings.

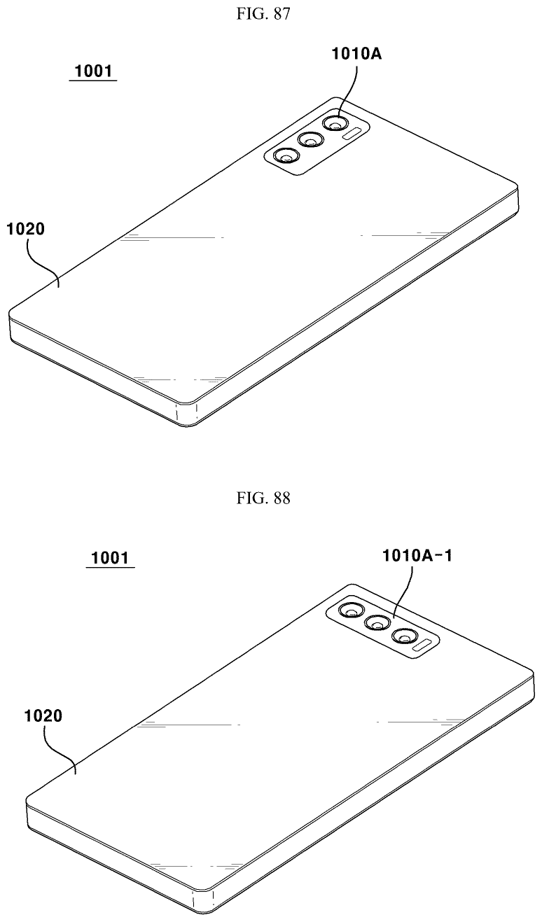

FIG. 87 is a perspective view of an optical apparatus according to a second embodiment of the present invention; and FIG. 88 is a perspective view of an optical apparatus according to a modified embodiment.

The optical apparatus 1001 is a mobile phone, mobile phone, portable terminal, mobile terminal, smart phone, smart pad, portable smart device, digital camera, laptop computer, digital broadcasting terminal, personal digital assistants (PDAs), portable multimedia player (PMP), and navigation. The optical apparatus 1001 may comprise any device for photographing images or photos.

The optical apparatus 1001 may comprise a main body 1020. The optical apparatus 1001 may comprise a camera device 1010A. The camera device 1010A may be disposed on the main body 1020. The camera device 1010A may photograph a subject. The optical apparatus 1001 may comprise a display. The display may be disposed on the main body 1020. The display may output at least one of a video and an image photographed by the camera device 1010A. The display may be disposed on a first surface of the main body 1020. The camera device 1010A may be disposed on at least one of a first surface of the main body 1020 and a second surface opposite to the first surface. As illustrated in FIG. 87, in the camera device 1010A, triple cameras may be disposed in a vertical direction. As illustrated in FIG. 88, in the camera device 1010A-1, triple cameras may be disposed in a horizontal direction.

Although the first embodiment and the second embodiment have been separately described above, some components of the first embodiment and some components of the second embodiment may be used interchangeably. That is, some components of the first embodiment may be replaced with corresponding components of the second embodiment. In addition, some components of the second embodiment may be replaced with corresponding components of the first embodiment. In addition, the third embodiment of the present invention may comprise some components of the first embodiment and some components of the second embodiment together.

Although the embodiment of the present invention has been described above with reference to the accompanying drawings, those of ordinary skill in the art to which the present invention belongs will understand that the present invention may be embodied in other specific forms without changing the technical spirit or essential features thereof. Therefore, it should be understood that the embodiments described above are illustrative in all respects and not restrictive.

1. A lens driving device comprising:
a fixed part;
a first moving part disposed in the fixed part;
a second moving part disposed in the first moving part;
a first driving part configured to move the first moving part in an optical axis direction;
a second driving part configured to move the second moving part in a direction perpendicular to the optical axis direction;
a plate member disposed between the fixed part and the first moving part;
a first ball part disposed between the plate member and the first moving part;
an elastic member disposed between the fixed part and the plate member; and
a second ball part disposed between the fixed part and the first moving part,
wherein the elastic member presses the second ball part to be supported by the fixed part.

2. The lens driving device of claim 1, wherein the fixed part comprises a base, and a first protruding part and a second protruding part protruding from the base in the optical axis direction,
wherein the first moving part comprises a first carrier and a third protruding part protruding from the first carrier in a first direction perpendicular to the optical axis direction,
wherein the first ball part is disposed between the plate member and the third protruding part, and
wherein the second ball part is disposed between the second protruding part and the third protruding part.

3. The lens driving device of claim 2, wherein the first protruding part and the second protruding part are disposed on a first corner region of the base.

4. The lens driving device of claim 1, comprising a second ball disposed between the first moving part and the second moving part.

5. The lens driving device of claim 4, comprising a first ball comprising the first ball part and the second ball part,
wherein, when viewed from above, the first ball comprises a first unit ball disposed on a first corner region of the fixed part, and a second unit ball disposed on a second corner region disposed in a diagonal direction of the first corner region of the fixed part.

6. The lens driving device of claim 5, wherein, when viewed from above, the second ball comprises a third unit ball and a fourth unit ball spaced apart from each other and disposed between the first unit ball and the second unit ball in the diagonal direction.

7. The lens driving device of claim 5, wherein the first ball comprises a ball overlapped with the second ball in a direction perpendicular to the optical axis direction.

8. The lens driving device of claim 1, wherein the first driving part comprises a first magnet disposed on the fixed part and a first coil disposed on the first moving part.

9. The lens driving device of claim 8, comprising:
a first substrate disposed on the first moving part; and
a second substrate connecting the fixed part and the first substrate,
wherein the first coil is disposed on the first substrate.

10. The lens driving device of claim 9, wherein the second driving part comprises a second magnet and a second coil configured to move the second moving part in a first direction perpendicular to the optical axis direction, and a third magnet and a third coil configured to move the second moving part in a second direction perpendicular to the optical axis direction and the first direction, and
wherein the second coil and the third coil are disposed on the first substrate.

11. The lens driving device of claim 1, wherein the first driving part comprises a substrate disposed on the fixed part, a first coil disposed on the substrate, and a first magnet disposed on the first moving part.

12. The lens driving device of claim 1, wherein the plate member is disposed between the first ball part and the fixed part, and
wherein the elastic member is disposed between the plate member and the fixed part so that the plate member is pressed in a direction opposite to the fixed part.

13. The lens driving device of claim 1, wherein the first ball part comprises a plurality of balls disposed in the optical axis direction,
wherein the plurality of balls comprise a first uppermost ball disposed highest and a first lowermost ball disposed lowest, and
wherein a height of a point at which the elastic member presses the plate member is disposed between the height of the first uppermost ball and the height of the first lowermost ball.

14. A camera device comprising:
a printed circuit board;
an image sensor disposed on the printed circuit board;
the lens driving device of claim 1 disposed on the printed circuit board; and
a lens coupled with the lens driving device.

15. An optical apparatus comprising:
a main body;
the camera device of claim 14 disposed on the main body; and
a display disposed on the main body and configured to output at least one of a video and an image photographed by the camera device.

16. A lens driving device comprising:
a base;
an autofocus (AF) carrier disposed on the base;
a first magnet and a first coil configured to move the AF carrier in an optical axis direction;
a plate member disposed between the base and the AF carrier;
a first ball part disposed between the plate member and the AF carrier;
an elastic member disposed between the base and the plate member; and
a second ball part disposed between the base and the AF carrier,
wherein the elastic member presses the second ball part to be supported by the base.

17. The lens driving device of claim 16, wherein the base comprises a first protruding part and a second protruding part protruding in the optical axis direction,
wherein the AF carrier comprises a third protruding part disposed between the first protruding part and the second protruding part,
wherein the first ball part is disposed between the plate member and the third protruding part, and
wherein the second ball part is disposed between the second protruding part and the third protruding part.

18. The lens driving device of claim 16, wherein the first magnet is disposed on the base, and
wherein the first coil is disposed on the AF carrier.

19. A lens driving device comprising:
a base;
an AF carrier disposed on the base;
an optical image stabilizer (OIS) carrier disposed in the AF carrier;
a first magnet and a first coil configured to move the AF carrier in an optical axis direction;
a second magnet and a second coil configured to move the OIS carrier in a first direction perpendicular to the optical axis direction;
a third magnet and a third coil configured to move the OIS carrier in a second direction perpendicular to each of the optical axis direction and the first direction;
a plate member disposed between the base and the AF carrier;
a first ball part disposed between the plate member and the AF carrier;
an elastic member disposed between the base and the plate member; and
a second ball part disposed between the base and the AF carrier,
wherein the elastic member presses the second ball part to be supported by the base.

20. The lens driving device of claim 19, comprising a first substrate disposed on the AF carrier,
wherein the second coil and the third coil are disposed on the first substrate.
